(19) United States
(12) Patent Application Publication
(10) Pub. No.: US 2025/0376063 A1
(43) Pub. Date: Dec. 11, 2025

(54) ELECTRIC VEHICLE SMART CHARGING ALGORITHMS AND HARDWARE

(71) Applicant: GEORGIA TECH RESEARCH CORPORATION, Atlanta, GA (US)

(72) Inventors: Michael J. LEAMY, Atlanta, GA (US); Kartik SASTRY, Atlanta, GA (US); David G. TAYLOR, Atlanta, GA (US); Shashank HOLLA, Atlanta, GA (US); Shreyas TATER, Atlanta, GA (US)

(21) Appl. No.: 18/878,522

(22) PCT Filed: Jun. 26, 2023
(86) PCT No.: PCT/US2023/026248

§ 371 Date: Dec. 23, 2024

Related U.S. Application Data
(60) Provisional application No. 63/355,245, filed on Jun. 24, 2022.

(51) Int. Cl. B60L 53/62; B60L 53/16; B60L 53/51; B60L 53/53; B60L 53/63; B60L 53/64; B60L 53/66; B60L 53/68; B60L 58/12

(52) U.S. Cl. CPC B60L 53/62; B60L 53/16; B60L 53/51; B60L 53/53; B60L 53/63; B60L 53/64; B60L 53/66; B60L 53/68; B60L 58/12; B60L 2240/72; B60L 2240/80; B60L 2260/44

(57) ABSTRACT

An exemplary system and method thereof are disclosed that employs a networked relay device that operates with an optimizer algorithm to optimally enable or disable power flow to any installed electric-vehicle charging-system, without the need for a control interface to the charging system and do so while maximizing or maintaining grid stability, site stability, or managing the site based on user-provided preferences. The operation can be performed without any interface or communication with the electric-vehicle charger and is deployable in a large scale for any manufacturer equipment or utility deployment.

### RELATED APPLICATION

This PCT application claims priority to, and the benefit of, U.S. Provisional Patent Application No. 63/355,245, filed Jun. 24, 2022, entitled “ELECTRIC VEHICLE SMART CHARGING ALGORITHMS AND HARDWARE PROTOTYPE,” which is hereby incorporated by reference herein in its entirety.

### BACKGROUND

Rapid charging of electric vehicles (EVs) can create demand spikes that can stress the power grid if a large number of vehicles simultaneously perform charging in an uncoordinated manner. Electric vehicle manufacturers and utilities have devised demand response programs to curtail energy use during times of peak power usage. The solutions are sporadic in their implementation and can differ among electric power providers.

Manufacturers are providing commercial solutions that can allow their electric vehicle chargers or charging stations to coordinate in some manner. Still, the solutions can be sporadic across multiple product lines and are inconsistent among the multiple manufacturers. There is a benefit to improving and coordinating the charging of electric vehicles.

### SUMMARY

An exemplary system and method thereof are disclosed that employs a networked relay device that operates with an optimizer algorithm to optimally enable or disable power flow to any installed electric-vehicle charging-system, without the need for a control interface to the charging system and do so while maximizing or maintaining grid stability, site stability, or managing the site based on user-provided preferences.

Notably, the exemplary device can be installed upstream to the electric-vehicle charger, or implemented therein, or charging station, (collectively referred to as electric vehicle charger unit) to cut power flow to the electric-vehicle charger unit via a network actuatable relay at the input power cable to the electric vehicle charger unit and thus is implementable to any onboard electric-vehicle charger or charging stations. The operation can be performed without any interface or communication with the electric-vehicle charger and is deployable in a large scale for any manufacturer equipment or utility deployment. As used herein, the term “electric vehicle charger unit” refers to on-board charging system for an electric vehicle or a charging station to interface to the charging system or batteries of the electric vehicle. The term “electric vehicle” refers to any vehicle that uses one or more electric motors or engines for propulsion.

To regulate the charging for the “on/off” operation of the networked relay, the optimizer algorithm determines an optimal “on/off” operation profile for the networked relay device that would regulate the usage of electricity at a user's premise or site based on (i) the user-specifiable operating preferences (e.g., to minimize cost, maximize carbon-free energy usage, minimize charging time, or minimize battery degradation) in view of (ii) utility-published electricity cost rates, grid's mix signal (ratio of different grid sources), and grid's stability and (iii) vehicle charging status and storage capacity. At sites with local power generation or energy storage (e.g., local PV, wind, etc.), the optimizer algorithm can determine the optimal “on/off” operation profile, also using the local power generation and/or energy storage constraints and operations.

As used herein, the term “user's premise or site” refers to residential, commercial, or industrial buildings or locations. The term can also refer to charging stations and charging network locations to which electric-vehicle charging systems are available.

In some embodiments, the networked relay device can interface with cloud-based infrastructure to execute an optimization engine executing the optimizer algorithm. In other embodiments, the networked relay device is configured as an edge controller that can execute the optimization engine. In yet other embodiments, the optimization engine may be executed in the electric vehicle charger unit.

The cloud-based infrastructure or edge controller can interface and access vehicle information published or curated by the utility or manufacturers to retrieve vehicle charging status and storage capacity information to use in the optimization operation.

In an aspect, a system is disclosed comprising a networked relay device comprising: a relay having (i) an input connected to a power source and (ii) an output connection to an electric vehicle charger unit; a first terminal to couple to the power source; a second terminal to couple to the electric vehicle charger unit; and a controller having a processor and a memory having instructions stored thereon, wherein execution of the instructions by the processor, causes the processor to: direct the relay to disengage electrical connection between the input connection and the output connection based on an optimized profile to provide power flow to the electric vehicle charger unit to charge an electric vehicle, wherein the optimized profile is determined from (i) one or more user-controllable inputs (e.g., minimize cost, maximize carbon-free energy usage, minimize charging time, or minimize battery degradation), (ii) price of electricity data, and (iii) electric vehicle state of charge.

In some embodiments, the networked relay device has no direct communication interface to communicate with the electric vehicle charger unit, and wherein the electric vehicle charger unit is configured to operate charging operation without any control signal from the networked relay device.

In some embodiments, the execution of the instructions by the processor further causes the processor of the networked relay device to execute an optimization engine to determine the optimized profile.

In some embodiments, the networked relay device further includes a web-service interface configured to communicate to external cloud infrastructure through a third-party API to receive the electric vehicle's state of charge.

In some embodiments, the networked relay device further includes a power-line communication (PLC) module configured to receive, via PLC communication, the electric vehicle state of charge from the electric vehicle charger unit.

In some embodiments, the optimization engine of the networked relay device is configured to determine the estimated power flow to the electric vehicle charger unit using (i) the one or more user-controllable inputs, (ii) the price of electricity data, and (iii) the electric vehicle state of charge, wherein the determined power flow to the electric vehicle charger unit is employed in determining the optimized profile.

In some embodiments, the optimization engine of the networked relay device is configured to determine estimated power flow, as the optimized profile, to local battery storage operatively connected to the networked relay device using (i) the one or more user controllable inputs, (ii) the price of electricity data, and (iii) the electric vehicle state of charge.

In some embodiments, the optimization engine of the networked relay device is configured to determine an estimated power flow, as the optimized profile, generated by local power generation system (e.g., rooftop photovoltaic) operatively connected to the networked relay device using (i) the one or more user controllable inputs, (ii) the price of electricity data, and (iii) the electric vehicle state of charge.

In some embodiments, the optimization engine of the networked relay device is configured to determine estimated power flow from the input connection (e.g., grid) using (i) the one or more user controllable inputs, (ii) the price of electricity data, and (iii) the electric vehicle state of charge, wherein the estimated power flow from the input connection is employed in determining the optimized profile.

In some embodiments, the system further includes cloud infrastructure configured to execute a cloud optimization engine to determine the optimized profile, the cloud infrastructure including a first interface to transmit (e.g., via messages) the optimized profile to the networked relay device.

In some embodiments, the cloud infrastructure includes a second interface configured to communicate to an external cloud infrastructure through a third-party API to receive the electric vehicle state of charge, wherein the external cloud infrastructure is operatively connected to the electric vehicle charger unit to receive the electric vehicle state of charge.

In some embodiments, the cloud infrastructure is configured to receive the electric vehicle state of charge from the networked relay device through the first interface, wherein the networked relay device includes a power-line communication (PLC) module configured to receive, via PLC communication, the electric vehicle state of charge from the electric vehicle charger unit.

In some embodiments, the cloud optimization engine is configured to determine estimated power flow, as the optimized profile, to the electric vehicle charger unit using (i) the one or more user controllable inputs, (ii) the price of electricity data, and (iii) the electric vehicle state of charge.

In some embodiments, the cloud optimization engine is configured to determine estimated power flow, as the optimized profile, to local battery storage operatively connected to the networked relay device using (i) the one or more user controllable inputs, (ii) the price of electricity data, and (iii) the electric vehicle state of charge.

In some embodiments, the cloud optimization engine is configured to determine estimated power flow generated by local power generation system (e.g., rooftop photovoltaic) operatively connected to the networked relay device using (i) the one or more user controllable inputs, (ii) the price of electricity data, and (iii) the electric vehicle state of charge, wherein the estimated power flow generated by the local power generation system is employed in determining the optimized profile.

In some embodiments, the cloud optimization engine is configured to determine estimated power flow from the input connection (e.g., grid) using (i) the one or more user controllable inputs, (ii) the price of electricity data, and (iii) the electric vehicle state of charge, wherein the estimated power flow from the input connection is employed in determining the optimized profile.

In some embodiments, the one or more user inputs includes at least one: input to receive parameter associated with user's preference to minimize payment selection for the charging operation (e.g., J₁); input to receive parameter associated with user's preference to minimize use of grid-derived non-renewable energy (e.g., J₂); input to receive parameter associated with user's preference to charge aggressively (e.g., minimize J₃); or input to receive parameter associated with user's preference to a combination thereof.

In some embodiments, the system includes a web hosting module (e.g., in the networked relay device or cloud infrastructure) configured to generate, via a user portal at a user device, graphical user interface to receive the one or more user inputs.

In some embodiments, the networked relay device further includes one or more sensors configured to, at least, measure power flow (e.g., current) at the input connection (V must be constant).

In some embodiments, the networked relay device further includes a communication interface configured to (i) connect to a power converter of photovoltaic system or local battery storage system and (ii) receive at least one of measurement data or messages from the power converter, wherein the at least one of measurement data or messages are employed to determine the optimized profile.

In some embodiments, the networked relay device further includes a second communication interface configured to (i) connect to a utility meter and (ii) receive at least one of utility usage data or messages from the utility meter, wherein the at least one of the utility usage data or messages are employed to determine the optimized profile.

In some embodiments, the networked relay device further includes a third terminal to couple to the power converter of photovoltaic system of the photovoltaic system.

In some embodiments, the networked relay device further includes a fourth terminal to couple to the power converter of the photovoltaic system of the local battery storage system.

In some embodiments, the networked relay device further includes a network interface or a wireless network interface.

In another aspect, a system is disclosed comprising a remote computing device (e.g., cloud infrastructure) having a network interface, one or more processors, and memory having instructions stored thereon, wherein execution of the instructions by the one or more processors causes the one or more processors to: determine an optimized profile to control power flow to an electric vehicle charger unit, wherein the optimized profile is determined from (i) one or more user-controllable inputs (e.g., minimize cost, maximize carbon-free energy usage, minimize charging time, or minimize battery degradation), (ii) price of electricity data, and (iii) electric vehicle state of charge; and direct, through the network interface or a computing device operatively connected to the remote computing device, a networked relay device to disengage the electrical connection between the electric vehicle charger unit and a power source of the electric vehicle charger unit using the optimized profile.

In some embodiments, the networked relay device includes the features of any one of the above-discussed system.

In some embodiments, the networked relay device has no direct communication interface to communicate with the electric vehicle charger unit, and wherein the electric vehicle charger unit is configured to operate charging operation without any control signal from the networked relay device.

In some embodiments, the remote computing device is configured to execute a cloud optimization engine to determine the optimized profile, the cloud infrastructure including a first interface to transmit (e.g., via messages) the optimized profile to the networked relay device.

In some embodiments, the remote computing device includes a second interface configured to communicate to an external cloud infrastructure through a third-party API to receive the electric vehicle state of charge, wherein the external cloud infrastructure is operatively connected to at least one of the electric vehicle charger unit or the electric vehicle to receive the electric vehicle state of charge.

In some embodiments, the remote computing device is configured to receive the electric vehicle state of charge from the networked relay device through a first interface, wherein the networked relay device includes a power-line communication (PLC) module configured to receive, via PLC communication, the electric vehicle state of charge from the electric vehicle charger unit.

In some embodiments, the remote computing device is configured to determine estimated power flow, as the optimized profile, to the electric vehicle charger unit using (i) the one or more user controllable inputs, (ii) the price of electricity data, and (iii) the electric vehicle state of charge.

In some embodiments, the remote computing device is configured to determine estimated power flow, as the optimized profile, to local battery storage operatively connected to the networked relay device using (i) the one or more user controllable inputs, (ii) the price of electricity data, and (iii) the electric vehicle state of charge.

In some embodiments, the remote computing device is configured to determine estimated power flow generated by local power generation system (e.g., rooftop photovoltaic) operatively connected to the networked relay device using (i) the one or more user controllable inputs, (ii) the price of electricity data, and (iii) the electric vehicle state of charge, wherein the estimated power flow generated by the local power generation system is employed in determining the optimized profile.

In some embodiments, the remote computing device is configured to determine estimated power flow from the input connection (e.g., grid) using (i) the one or more user controllable inputs, (ii) the price of electricity data, and (iii) the electric vehicle state of charge, wherein the estimated power flow from the input connection is employed in determining the optimized profile.

In some embodiments, the remote computing device is configured to determine the optimized profile using the one or more user inputs that includes at least one: input to receive parameter associated with user's preference to minimize payment selection for the charging operation (e.g., J₁); input to receive parameter associated with user's preference to minimize use of grid-derived non-renewable energy (e.g., J₂); input to receive parameter associated with user's preference to charge aggressively (e.g., minimize J₃); or input to receive parameter associated with user's preference to a combination thereof.

In some embodiments, the remote computing device includes a web hosting module (e.g., in the networked relay device or cloud infrastructure) configured to generate, via a user portal at a user device, graphical user interface to receive the one or more user inputs.

In another aspect, a system is disclosed comprising: a networked electrical-vehicle-charger controller device comprising: a communication module having a connection to an electric vehicle charger unit; a first terminal to couple to a power source; a second terminal to couple to the electric vehicle charger unit; and a controller having a processor and a memory having instructions stored thereon, wherein execution of the instructions by the processor, causes the processor to direct the communication module to transmit at least one of (i) a charging command derived from an optimized profile or (ii) the optimized profile to the electric vehicle charger unit, wherein the optimized profile is determined from (i) one or more user-controllable inputs (e.g., minimize cost, maximize carbon-free energy usage, minimize charging time, or minimize battery degradation), (ii) price of electricity data, and (iii) electric vehicle state of charge.

In some embodiments, the optimized profile can be provided as a command sequence determined using optimization, optimizer-determined command sequence, or an optimized/optimal command sequence to the networked relay device.

In some embodiments, the execution of the instructions by the processor further causes the processor of the networked electric vehicle charger unit controller device to execute an optimization engine to determine the optimized profile.

In some embodiments, the networked electrical-vehicle-charger controller device includes a web-service interface configured to communicate to external cloud infrastructure through a third-party API to receive the electric vehicle's state of charge.

In some embodiments, the networked electric vehicle charger unit controller device includes a power-line communication (PLC) module configured to receive, via PLC communication, the electric vehicle state of charge from at least one of the electric vehicle or electric vehicle charger unit.

In some embodiments, the optimization engine of the networked electrical-vehicle-charger controller device is configured to determine estimated power flow, as the optimized profile, to the electric vehicle charger unit using (i) the one or more user-controllable inputs, (ii) the price of electricity data, and (iii) the electric vehicle state of charge.

In some embodiments, the optimization engine of the networked electrical-vehicle-charger controller device is configured to determine estimated power flow, as the optimized profile, to local battery storage operatively connected to the networked electrical-vehicle-charger controller device using (i) the one or more user-controllable inputs, (ii) the price of electricity data, and (iii) the electric vehicle state of charge.

In some embodiments, the optimization engine of the networked electrical-vehicle-charger controller device is configured to determine estimated power flow generated by local power generation system (e.g., rooftop photovoltaic) operatively connected to the networked electrical-vehicle-charger controller device using (i) the one or more user-controllable inputs, (ii) the price of electricity data, and (iii) the electric vehicle state of charge, wherein the estimated power flow generated by the local power generation system is employed in determining the optimized profile.

In some embodiments, the optimization engine of the networked electrical-vehicle-charger controller device is configured to determine estimated power flow from the input connection (e.g., grid) using (i) the one or more user-controllable inputs, (ii) the price of electricity data, and (iii) the electric vehicle state of charge, wherein the estimated power flow from the input connection is employed in determining the optimized profile.

In some embodiments, the system further includes cloud infrastructure configured to execute a cloud optimization engine to determine the optimized profile, the cloud infrastructure including a first interface to transmit (e.g., via messages) the optimized profile to the networked electrical-vehicle-charger controller device.

In some embodiments, the cloud infrastructure includes a second interface configured to communicate to an external cloud infrastructure through a third-party API to receive the electric vehicle state of charge, wherein the external cloud infrastructure is operatively connected to the electric vehicle charger unit to receive the electric vehicle state of charge.

In some embodiments, the cloud infrastructure is configured to receive the electric vehicle state of charge from the networked relay device through the first interface, wherein the networked relay device includes a power-line communication (PLC) module configured to receive, via PLC communication, the electric vehicle state of charge from the electric vehicle charger unit.

In some embodiments, the cloud optimization engine is configured to determine estimated power flow, as the optimized profile, to the electric vehicle charger unit using (i) the one or more user-controllable inputs, (ii) the price of electricity data, and (iii) the electric vehicle state of charge.

In some embodiments, the cloud optimization engine is configured to determine estimated power flow, as the optimized profile, to local battery storage operatively connected to the networked electrical-vehicle-charger controller device using (i) the one or more user-controllable inputs, (ii) the price of electricity data, and (iii) the electric vehicle state of charge.

In some embodiments, the cloud optimization engine is configured to determine estimated power flow generated by local power generation system (e.g., rooftop photovoltaic) operatively connected to the networked electrical-vehicle-charger controller device using (i) the one or more user-controllable inputs, (ii) the price of electricity data, and (iii) the electric vehicle state of charge, wherein the estimated power flow generated by the local power generation system is employed in determining the optimized profile.

In some embodiments, the cloud optimization engine is configured to determine estimated power flow from the input connection (e.g., grid) using (i) the one or more user controllable inputs, (ii) the price of electricity data, and (iii) the electric vehicle state of charge, wherein the estimated power flow from the input connection is employed in determining the optimized profile.

In some embodiments, the one or more user inputs include at least one: input to receive parameter associated with user's preference to minimize payment selection for the charging operation (e.g., J₁); input to receive parameter associated with user's preference to minimize the use of grid-derived non-renewable energy (e.g., J₂); input to receive parameter associated with user's preference to charge aggressively (e.g., minimize J₃); or input to receive parameter associated with user's preference to a combination thereof.

In some embodiments, the system further includes a web hosting module (e.g., in the networked relay device or cloud infrastructure) configured to generate, via a user portal at a user device, a graphical user interface to receive the one or more user inputs.

In some embodiments, the networked relay device further includes
one or more sensors configured to, at least, measure power flow (e.g., current) at the input connection.

In some embodiments, the networked electrical-vehicle-charger controller device includes: a communication interface configured to (i) connect to a power converter of photovoltaic system or local battery storage system and (ii) receive at least one of measurement data or messages from the power converter, wherein the at least one of measurement data or messages are employed to determine the optimized profile.

In some embodiments, the networked electrical-vehicle-charger controller device further includes: a second communication interface configured to (i) connect to a utility meter and (ii) receive at least one of utility usage data or messages from the utility meter, wherein the at least one of the utility usage data or messages are employed to determine the optimized profile.

In some embodiments, the networked electrical-vehicle-charger controller device further includes a third terminal to couple to the power converter of the photovoltaic system or a fourth terminal to couple to the power converter of the local battery storage system.

In another aspect, a system is disclosed comprising a remote computing device (e.g., cloud infrastructure) having one or more processors and memory having instructions stored thereon, wherein execution of the instructions by the one or more processors causes the one or more processors to: determine an optimized profile to control power flow to an electric vehicle charger unit, wherein the optimized profile is determined from (i) one or more user-controllable inputs (e.g., minimize cost, maximize carbon-free energy usage, minimize charging time, or minimize battery degradation), (ii) price of electricity data, and (iii) electric vehicle state of charge; and direct, though an interface of the remote computing device or a computing device operatively connected to the remote computing device, a networked electrical-vehicle-charger controller device to control power flow between the electric vehicle charger unit and a power source of the electric vehicle charger unit using the optimized profile.

In some embodiments, the networked electrical-vehicle-charger controller device includes any one of the features of the above-discussed systems.

In some embodiments, the remote computing device is configured to execute a cloud optimization engine to determine the optimized profile, the cloud infrastructure including a first interface to transmit (e.g., via messages) the optimized profile to the networked electrical-vehicle-charger controller device.

In some embodiments, the remote computing device includes a second interface configured to communicate to an external cloud infrastructure through a third-party API to receive the electric vehicle state of charge, wherein the external cloud infrastructure is operatively connected to the electric vehicle charger unit to receive the electric vehicle state of charge.

In some embodiments, the remote computing device is configured to receive the electric vehicle state of charge from the networked electrical-vehicle-charger controller device through the first interface, wherein the networked relay device includes a power-line communication (PLC) module configured to receive, via PLC communication, the electric vehicle state of charge from the electric vehicle charger unit.

In some embodiments, the remote computing device is configured to determine estimated power flow, as the optimized profile, to the electric vehicle charger unit using (i) the one or more user-controllable inputs, (ii) the price of electricity data, and (iii) the electric vehicle state of charge.

In some embodiments, the remote computing device is configured to determine estimated power flow, as the optimized profile, to local battery storage operatively connected to the networked electrical-vehicle-charger controller device using (i) the one or more user-controllable inputs, (ii) the price of electricity data, and (iii) the electric vehicle state of charge.

In another aspect, a method is disclosed comprising directing, based on an optimized profile, a relay of a networked relay device to disengage electrical connection to an electric vehicle charger unit to control power flow to the electric vehicle charger unit, wherein the optimized profile is determined from (i) one or more user-controllable inputs (e.g., minimize cost, maximize carbon-free energy usage, minimize charging time, or minimize battery degradation), (ii) price of electricity data, and (iii) electric vehicle state of charge.

In some embodiments, the networked relay device has no direct communication interface to communicate with the electric vehicle charger unit, and wherein the electric vehicle charger unit is configured to operate charging operation without any control signal from the networked relay device.

In another aspect, a method is disclosed comprising directing, based on an optimized profile, a networked electrical-vehicle-charger controller device to control power flow to an electric vehicle charger unit, wherein the optimized profile is determined from (i) one or more user-controllable inputs (e.g., minimize cost, maximize carbon-free energy usage, minimize charging time, or minimize battery degradation), (ii) price of electricity data, and (iii) electric vehicle state of charge.

In some embodiments, the optimized profile is determined locally by an optimization engine executing at, at least one of, the networked relay device or networked electrical-vehicle-charger controller.

In some embodiments, the optimized profile is determined at a cloud infrastructure executing an optimizer engine.

In some embodiments, the method further includes receiving, via a web-service interface, the electric vehicle state of charge from an external cloud infrastructure through a third-party API.

In some embodiments, the optimization engine is configured to determine the estimated power flow to the electric vehicle charger unit using (i) the one or more user-controllable inputs, (ii) the price of electricity data, and (iii) the electric vehicle state of charge, wherein the determined power flow to the electric vehicle charger unit is employed in determining the optimized profile.

In some embodiments, the optimization engine is configured to determine the estimated power flow to local battery storage operatively connected to the networked relay device using (i) the one or more user-controllable inputs, (ii) the price of electricity data, and (iii) the electric vehicle state of charge, wherein the estimated power flow to the local battery storage is employed in determining the optimized profile.

In some embodiments, the optimization engine is configured to determine the estimated power flow generated by the local power generation system (e.g., rooftop photovoltaic) operatively connected to the networked relay device using (i) the one or more user-controllable inputs, (ii) the price of electricity data, and (iii) the electric vehicle state of charge, wherein the estimated power flow generated by the local power generation system is employed in determining the optimized profile.

In some embodiments, at least one of the optimization engine is configured to determine estimated power flow from the input connection (e.g., grid) using (i) the one or more user controllable inputs, (ii) the price of electricity data, and (iii) the electric vehicle state of charge, wherein the estimated power flow from the input connection is employed in determining the optimized profile.

In some embodiments, the method further includes generating, via a user portal at a user device, a graphical user interface to receive the one or more user inputs.

In another aspect, a non-transitory computer-readable medium is disclosed having instructions stored thereon, wherein execution of the instructions by a processor causes the processor to: direct, based on an optimized profile, a relay of a networked relay device to disengage electrical connection to an electric vehicle charger unit to control power flow to the electric vehicle charger unit, wherein the optimized profile is determined from (i) one or more user-controllable inputs (e.g., minimize cost, maximize carbon-free energy usage, minimize charging time, or minimize battery degradation), (ii) price of electricity data, and (iii) electric vehicle state of charge.

In some embodiments, the networked relay device has no direct communication interface to communicate with the electric vehicle charger unit, and wherein the electric vehicle charger unit is configured to operate charging operation without any control signal from the networked relay device.

In another aspect, a non-transitory computer-readable medium is disclosed having instructions stored thereon, wherein execution of the instructions by a processor causes the processor to: direct, based on an optimized profile, a networked electrical-vehicle-charger controller device to control power flow to an electric vehicle charger unit, wherein the optimized profile is determined from (i) one or more user-controllable inputs (e.g., minimize cost, maximize carbon-free energy usage, minimize charging time, or minimize battery degradation), (ii) price of electricity data, and (iii) electric vehicle state of charge.

In some embodiments, the optimized profile is determined locally by an optimization engine executing at, at least one of, the networked relay device or the networked electrical-vehicle-charger controller.

In some embodiments, the optimized profile is determined at a cloud infrastructure executing an optimizer engine.

In some embodiments, execution of the instructions by the processor further causes the processor to execute a web-service interface to receive the electric vehicle's state of charge from an external cloud infrastructure through a third-party API.

In some embodiments, execution of the instructions by the processor further causes the processor to determine the estimated power flow to the electric vehicle charger unit using (i) the one or more user-controllable inputs, (ii) the price of electricity data, and (iii) the electric vehicle state of charge, wherein the determined power flow to the electric vehicle charger unit is employed in determining the optimized profile.

In some embodiments, execution of the instructions by the processor further causes the processor to determine the estimated power flow to local battery storage operatively connected to the networked relay device using (i) the one or more user-controllable inputs, (ii) the price of electricity data, and (iii) the electric vehicle state of charge, wherein the estimated power flow to the local battery storage is employed in determining the optimized profile.

In some embodiments, execution of the instructions by the processor further causes the processor to determine the estimated power flow generated by the local power generation system (e.g., rooftop photovoltaic) operatively connected to the networked relay device using (i) the one or more user-controllable inputs, (ii) the price of electricity data, and (iii) the electric vehicle state of charge, wherein the estimated power flow generated by the local power generation system is employed in determining the optimized profile.

In some embodiments, execution of the instructions by the processor further causes the processor to determine the estimated power flow from the input connection (e.g., grid) using (i) the one or more user-controllable inputs, (ii) the price of electricity data, and (iii) the electric vehicle state of charge, wherein the estimated power flow from the input connection is employed in determining the optimized profile.

In some embodiments, execution of the instructions by the processor further causes the processor to generate, via a user portal at a user device, a graphical user interface to receive the one or more user inputs.

### BRIEF DESCRIPTION OF THE DRAWINGS

The skilled person in the art will understand that the drawings described below are for illustration purposes only.

FIGS. 1A, 1B, and 1C each show an exemplary system comprising a networked relay device that control on/off power flow to an electric vehicle charger unit according to a smart charging algorithm in accordance with an illustrative embodiment.

FIG. 1D shows an exemplary system comprising a networked device that control continuous power flow to an electric vehicle charger unit according to a smart charging algorithm in accordance with an illustrative embodiment.

FIGS. 2A-2C show an example optimizer engine for a networked relay device in accordance with an illustrative embodiment.

FIG. 3A shows an example of the networked relay device in accordance with an illustrative embodiment.

FIG. 3B shows examples of the user interfaces to manage operations of the networked relay device in accordance with an illustrative embodiment.

FIG. 3C shows an example method of operation of the networked relay device in accordance with an illustrative embodiment.

FIGS. 4A-4E show example smart charging algorithms configured to control on/off power flow or continuous power flow to the electric vehicle charger unit in accordance with various illustrative embodiments.

FIGS. 5A-5I show a prototype design for smart charging system developed in a study and performance results thereof.

FIGS. 6A-6C shows another aspect to the study to evaluate impact of the smart charging algorithms to the utility grid.

FIGS. 7A-7F shows another aspect of the study to evaluate impact of decentralized smart charging algorithms for a residence scenario.

FIGS. 8A-8D shows another aspect of the study to evaluate smart charging algorithms to the maximize renewable energy usage at a premise.

### DETAILED SPECIFICATION

Some references, which may include various patents, patent applications, and publications, are cited in a reference list and discussed in the disclosure provided herein. The citation and/or discussion of such references is provided merely to clarify the description of the present disclosure described herein. In terms of notation, “[n]” corresponds to the n^{th} reference in the list. All references cited and discussed in this specification are incorporated herein by reference in their entireties and to the same extent as if each reference was individually incorporated by reference.

### Example Systems

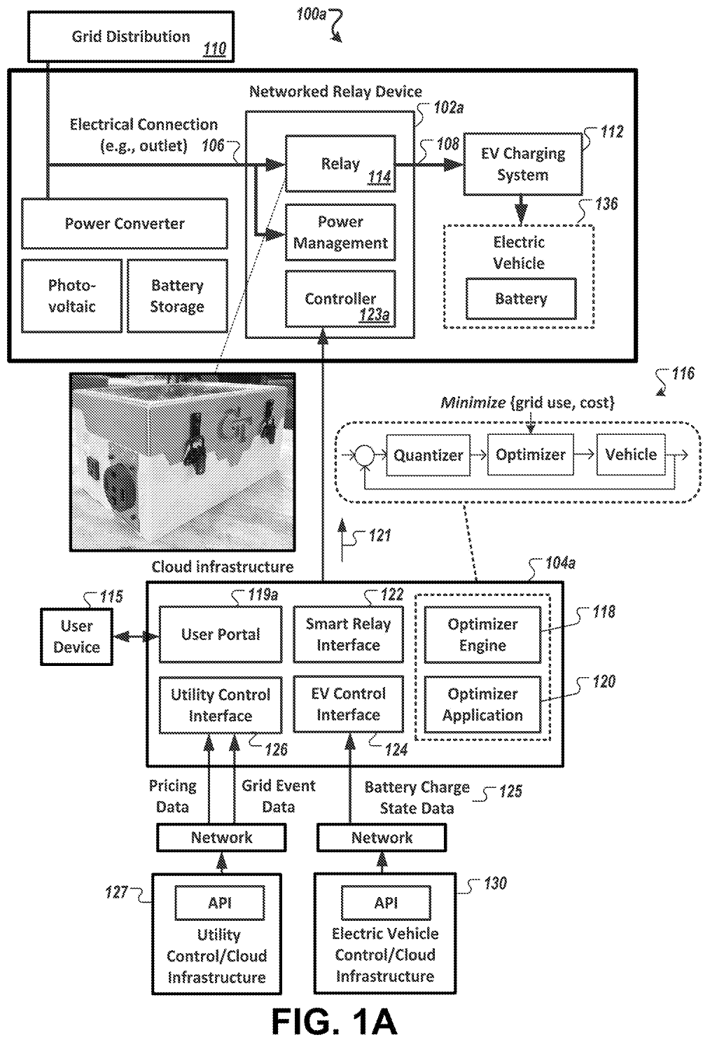

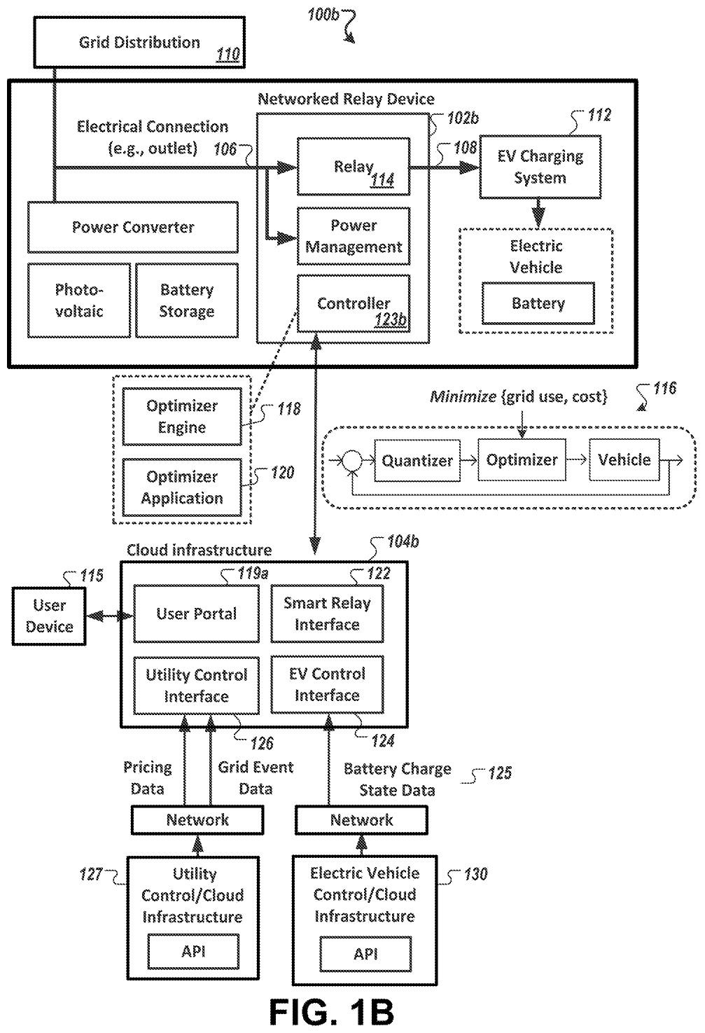

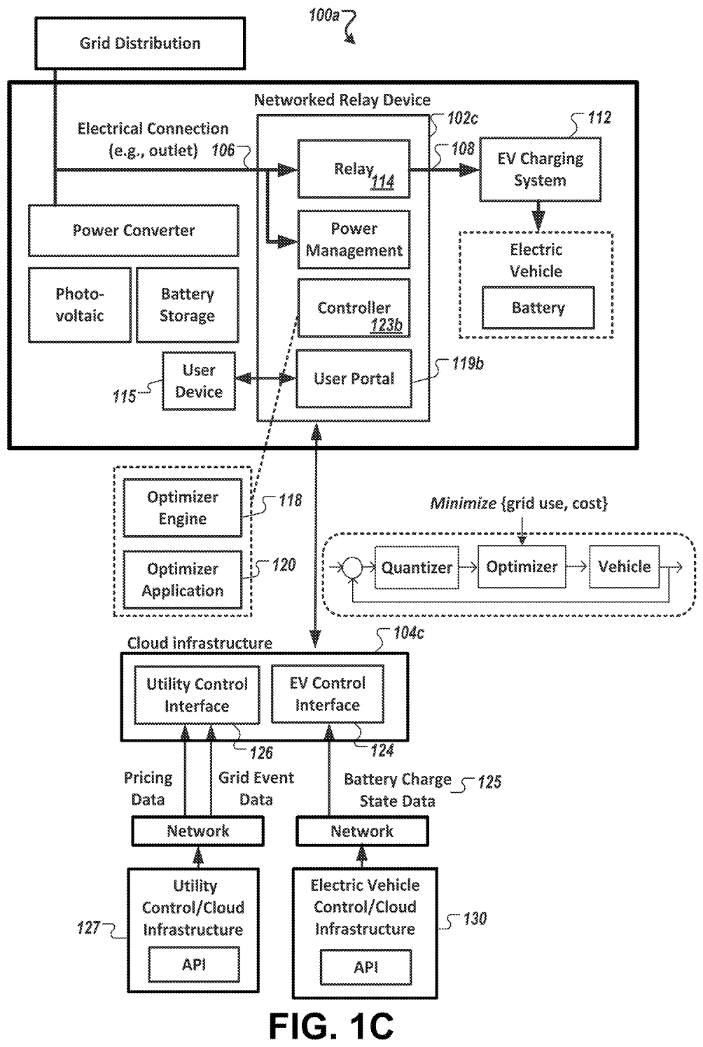

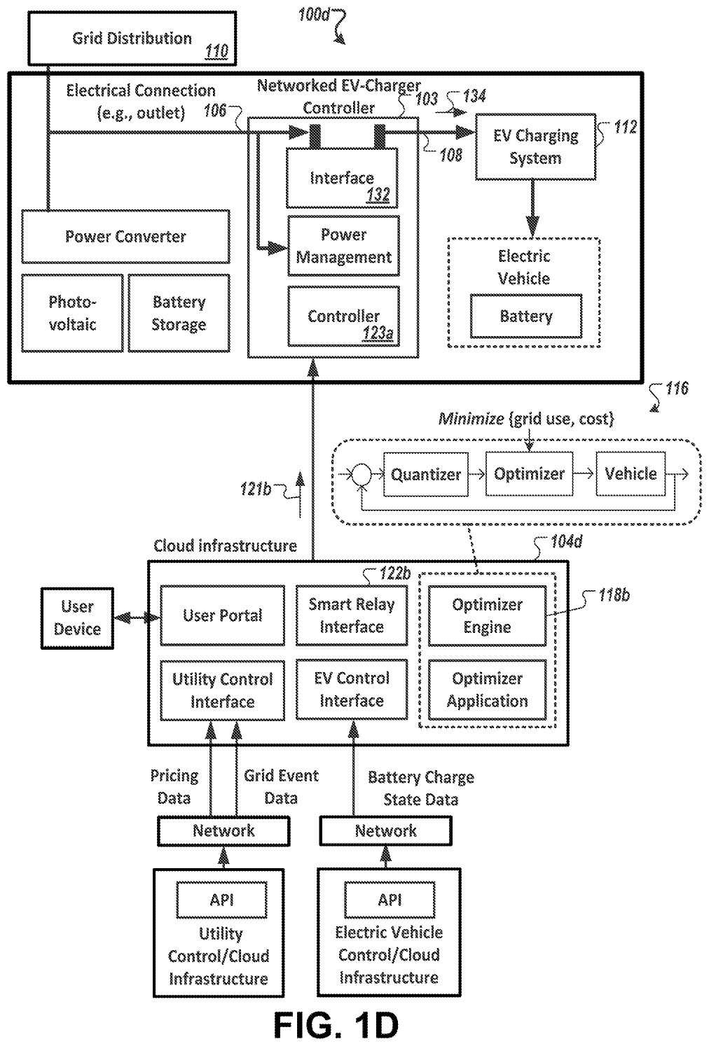

FIGS. 1A, 1B, and 1C each show an exemplary system 100 (shown as 100a, 100b, 100c, 100d, respectively) comprising a networked relay device 102 (shown as 102a, 102b, 102c) that operates with a cloud infrastructure 104 to control power flow through electrical connections 106, 108 between a grid distribution 110 and a smart or controllable load 112 (shown as an “EV Charging System” 112). FIG. 1D shows an example system 100 (shown as 100d) comprising a networked electric-vehicle-charger controller (as an edge device) that operates with the cloud infrastructure 104. The networked relay device having a controllable relay and controller to control power flow according to an optimized profile through communication with an external device.

In the example shown in FIGS. 1A-1C, the networked relay device 102a, 102b, 102c includes a relay 114 configured to switch power connections between the electric vehicle charging system 112 and the power source for the charging provided by the grid distribution 110 to optimize charging operations by the electric vehicle charging system 112. By controlling the power flow, in an “on/off” manner, to the electric vehicle charging system 112 via a relay (e.g., 114) that simply cuts power to the electric vehicle charging system, the networked relay device (e.g., 102a, 102b, 102c) can interoperate with any electric vehicle charging system (e.g., 112) of any manufacturer or product lines while effecting optimized controls, e.g., an optimizer algorithm 116, that collectively account for grid conditions and user inputs (e.g., grid mix, power pricing, and time-to-charge) that may not be natively available in the electric vehicle charging system.

### Example #1—Networked Relayed Device with Cloud Infrastructure Optimization

In FIG. 1A, cloud infrastructure 104 (shown as 104a) executes the optimizer engine 118 that executes the optimizer algorithm 116 to transmit (e.g., via messages) an optimized profile 121 to the controller 123 (shown as 123a) of the networked relay device 102a. In FIG. 1A, cloud infrastructure 104a also includes an interface 119 (shown as “User Portal” 119) for a user device 115 to provide the user's input for the optimizer algorithm 116. Cloud infrastructure 104a includes the optimizer engine 118 and an optimizer application 120. The optimizer application 120 includes the main program to execute the optimizer operation at the cloud. The application 120 can interface with the optimizer engine 118, a smart relay interface 122, an electric vehicle control interface 124, a utility control interface 126, and the user portal 119.

The optimizer algorithm 116 is configured to optimize charging for a plug-in electric vehicle (EV) 136, e.g., Level 1 and 2 defined in the SAE J1772 standard, based on electric vehicle charging requirements and user's provided preferences. The output of the optimizer algorithm 116 is the optimized profile 121. User preferences (e.g., from device 115) can inform an optimization objective function that captures multiple interests of the EV owner via a user-weighted sum of three performance metrics: cost of electricity, usage of renewable energy, and time-to-charge. The optimizer algorithm 116, as an optimization-based feedback control algorithm, can determine an optimal set of time intervals during which to charge the electric vehicle at a pre-defined, constant power level. In some embodiments, the optimized profile 121 is an on-off profile (e.g., to run the relay 114) to be executed for a pre-defined time window. The time window may be a fixed window, e.g., over the next 15 minutes, 30 minutes, 1 hr, 2 hr, 4 hr, 8 hr, 24 hr. In another embodiment, the time window may be variable-window and the optimized profile includes one or more time parameters to define the time window.

The optimizer algorithm 116 may be configured to leverage the existence of multiple optimal (near-optimal) solutions to the optimization problem to reduce the grid impact of EV charging at no (negligible) cost to the electric vehicle owner. In some embodiments, the optimizer algorithm 116 is configured with a quadratic program in which the objective function includes a weighted sum of cost of electricity from the utility, usage of renewable energy, charging urgency, and battery degradation, e.g., as described or referenced herein. The renewable energy metric can consider both local and remote sources of renewable energy.

The smart relay interface 122, in some embodiments, includes web services to transmit relay operational profiles as commands or messages to the networked replay smart charger 102. The smart relay interface 122 may include in the message: the relay operational profile as a time series profile for the “on” and/or “off” state of the relay in a pre-defined time increment (e.g., 1 minute). In some embodiments, the time increment can be in 10- or 15-minute increments. The message may include the relay device identifier and associated security information for message authentication. In some embodiments, the smart relay interface 122 (shown as 122b in FIG. 1D) may provide the optimized profile 121 (shown as 121b in FIG. 1D) as a float, integer value corresponding to the degree of charging or power flow allowed or allocated to the electric vehicle charging system 112.

The electric vehicle control interface 124 is configured to interface through electric vehicle control API 130, e.g., “SmartCar” to third-party or electric vehicle services. Smartcar® vehicle API is a web service that curates vehicle information, including battery state of charge 125 (shown as “Battery Charge State Data” 125).

The utility control interface 126 is configured to communicate with a utility infrastructure 127, e.g., via web services, to receive pricing data (time-of-use rates or prices) or grid event data from the utility or an Internet site hosting the information.

The electric vehicle charging system 112 is a commercially available charger that is located at the site (e.g., residential, commercial, or industrial). The electric vehicle charging system 112 can be configured to interface with a wall outlet (e.g., single phase or three phases) and may include data exchange mechanisms, including data exchange protocols and hardware to communicate through its connection to the wall outlet. In some embodiments, the electric vehicle charging system 112 is configured to communicate wirelessly within a network. An example list of the electric vehicle chargers is provided in Table 3 described herein.

### Example #2—Networked Relayed Device with Local Optimization

In FIG. 1B, the networked relay device 102b, as an edge controller, executes the optimizer engine 118 executing the optimizer algorithm 116. The cloud infrastructure 104 (shown as 104b), in the example, still provides the interface 119 (shown as “User Portal” 119a) for the user device 115 to receive the user's input for the optimizer algorithm 116. In FIG. 1B, the optimizer engine 118 executing the optimizer algorithm 116 are executed in the controller 123 (shown as 123b) of the networked relay smart charger 102b. Cloud infrastructure 104b includes the smart relay interface 122, the electric vehicle control interface 124, and the utility control interface 126.

### Example #3—Networked Relayed Device with Local Optimization and Local Web Services

In FIG. 1C, the networked relay device 102c, as an edge controller, executes the optimizer engine 118, executing the optimizer algorithm 116. The networked relay device 102c also executes the interface 119 (shown as “User Portal” 119b) for the user device 115 to receive the user's input for the optimizer algorithm 116.

In other embodiments (not shown), the networked relay device (e.g., 102) can be configured to implement all the needed web services (e.g., interfaces 119, 124, 126) without needing cloud infrastructure.

### Example #4—Networked Non-Relayed Device with Cloud Infrastructure Optimization

In FIG. 1D, the exemplary system 100d includes a networked electric-vehicle-charger controller 103 (as an edge device) that operates with the cloud infrastructure 104 (shown as 104a, as described in relation to FIG. 1A). The networked electric-vehicle-charger controller 103 includes an interface 132, e.g., communication module, configured to provide charging command 134 derived from the optimized profile 121 (shown as 121b) to the electric vehicle charging system 112. In some embodiments, the interface 132 includes a power-line communication module to interface with the electric vehicle charging system. In other embodiments, the interface 132 is configured to provide (i) a digital signal or (ii) an analog signal (having amplitude, frequency, and/or a modulated signal) to the interface with the electric vehicle charging system 112 to indicate or set the power flow or charging setpoint to be performed by the electric vehicle charging system 112.

As discussed above, the optimized profile 121b may be included in the transmitted message as a float or integer value corresponding to the degree of charging or power flow allowed or allocated to the electric vehicle charging system 112.

While FIG. 1D shows the optimizer engine 118 (shown as 118b) executing in the cloud infrastructure 104 (shown as 104d), the engine 118b may be implemented in other devices and equipment, e.g., as described in relation to FIGS. 1B and 1C.

### Example Optimizer Engine and Smart Charging Algorithms for the Networked Relay Device

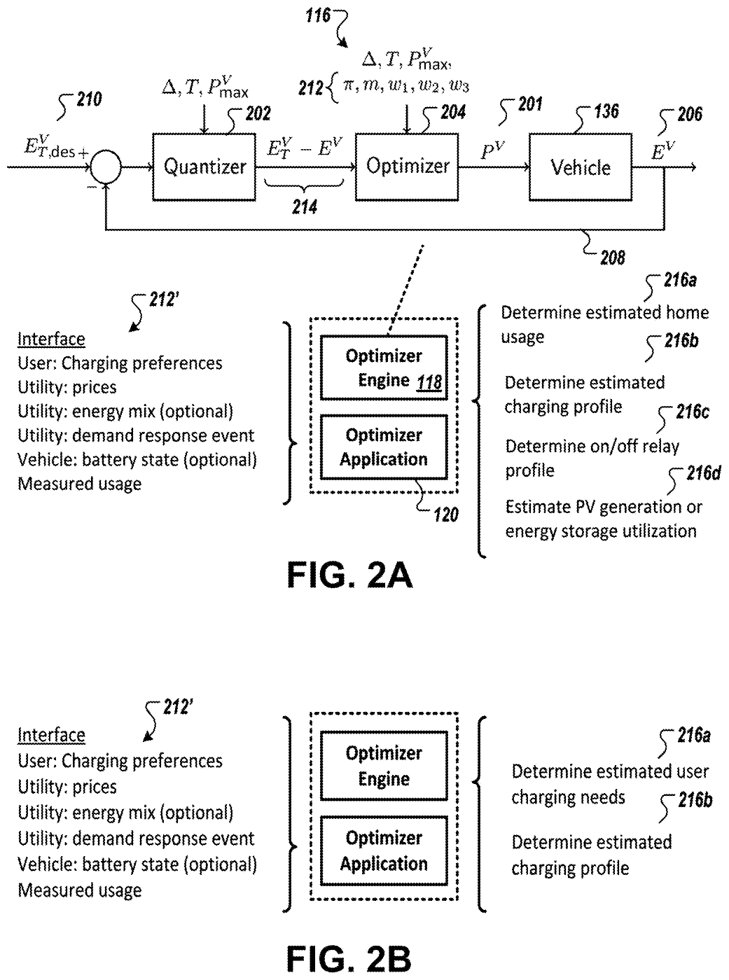

FIGS. 2A-2C show an example optimizer engine (e.g., 118) for a networked relay device (e.g., 102a, 102b, 102c, etc.) and its associated smart charging algorithm (e.g., 116). The networked relay device (e.g., 102) can optimize the charging of an electric vehicle by considering the best or optimal time to charge based on grid mix, power pricing and time to charge, a smart charger prototype has been developed.

On off Optimization. In the example shown in FIG. 2A, the optimizer engine (e.g., 118) is configured to output an on/off optimized profile. The engine (e.g., 118) is configured to determine the desired power flow P^{V}[t] (201) (in kW) for the electric vehicle (e.g., 136) in two steps (202, 204) (shown via a “Quantizer” module 202 and “Optimizer” module 204) per Equation 1A and Equation 1B, respectively, as a function of the energy storage in the electric vehicle E^{V}[t] (206) via a feedback operation 208.

$${E}_{T}^{V} [ t ] - {E}^{V} [ t ] = N \cdot Δ \cdot {P}_{m ax}^{V} , \qquad ( Eq . 1 A )$$

$$where N = \{ \begin{matrix}0 & if {N}^{′} < 0 \\ T - t , & if {N}^{′} > T - t , \\ {N}^{′} & otherwise\end{matrix}$$

$$where {N}^{′} = floor ( \frac{{E}_{T , des}^{V} - {E}^{V} [ t ]}{Δ \cdot {P}_{m ax}^{V}} )$$

In Equation 1A, E^{V}[t] (206) is the energy stored in the electric vehicle (136) at time t, and

$${E}_{T , des}^{V}$$

(210) is the desired value of the energy stored in the electric vehicle (136), T is the length of the time horizon, t is the time index, and Δ is the time step (e.g., in hours).

$$minimize {\sum }_{\tilde{t} = t}^{T - 1} ( {ω}_{1} Δ π [ \tilde{t} ] + {ω}_{2} Δ ( 1 - m [ \tilde{t} ] ) + {ω}_{3} \tilde{t} ) {\tilde{P}}^{V} [ \tilde{t} ] , \qquad ( Eq . 1 B )$$

$$subject to : \{ \begin{matrix}{\tilde{P}}^{V} [ t ] ∈ \{ 0 , {P}_{m ax}^{V} \} for \tilde{t} = t , … , T - 1 \\ Δ {\sum }_{\tilde{t} = t}^{T - 1} {\tilde{P}}^{V} [ \tilde{t} ] = {E}_{T}^{V} [ t ] - {E}^{V} [ t ]\end{matrix}$$

In Equation 1B, ω₁, ω₂, ω₃ (212) are weights that can be pre-defined or user-definable for priority of the optimization, e.g., weight for cost, weight for the use of renewable energy, and weight for time of charge, m[\tilde{t}] (212) is the grid mix at a time \tilde{t}, π[\tilde{t}] (212) is the price of electricity at time \tilde{t}, \tilde{P}^{V}[\tilde{t}] (201) is the desired power flow into the electric vehicle at a desired time \tilde{t}. The parameters 212 can be provided to the algorithm 116 though the optimizer application (e.g., 120).

The quantizer (202) can ensure the feasibility of the optimization problem solved by the optimizer. At each time instant t=1 to T−1, the smart charging algorithm 116 can determine the power flow P^{V}[t] (201) into the electric vehicle (136) at time t for a subsequent duration of Δ hours, where

$${P}^{V} [ t ] ∈ \{ 0 , {P}_{ma x}^{V} \} .$$

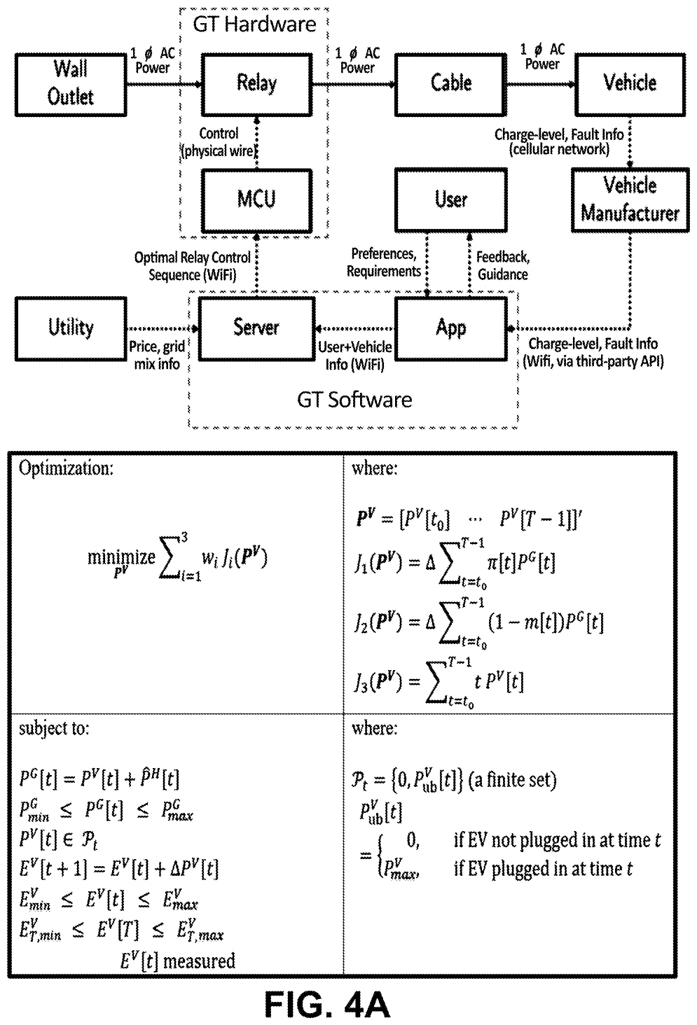

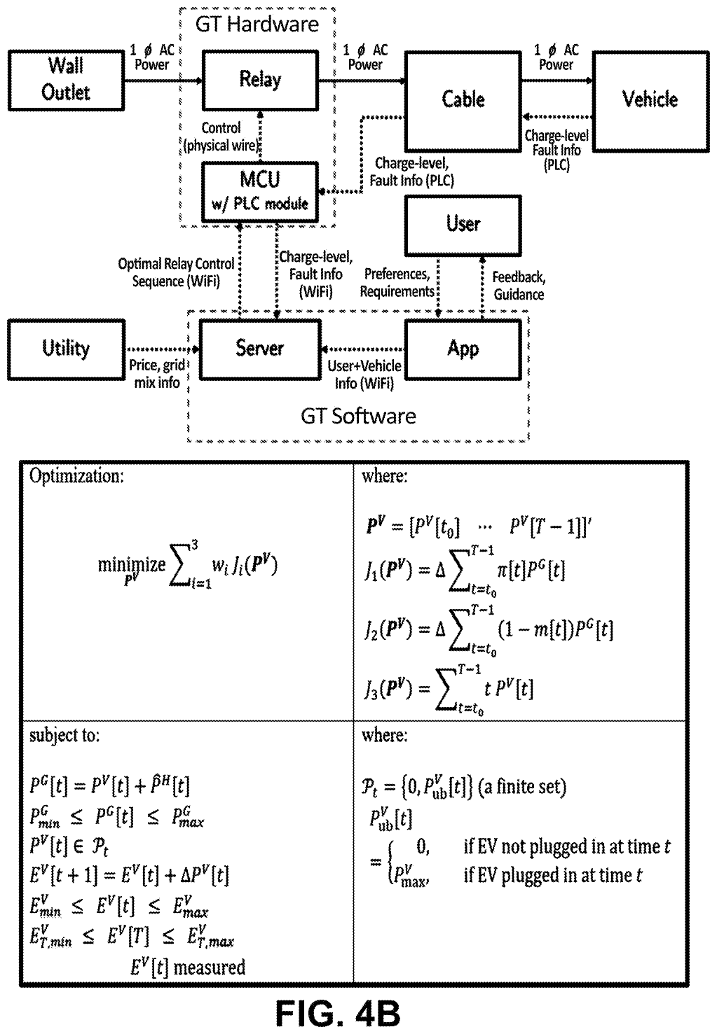

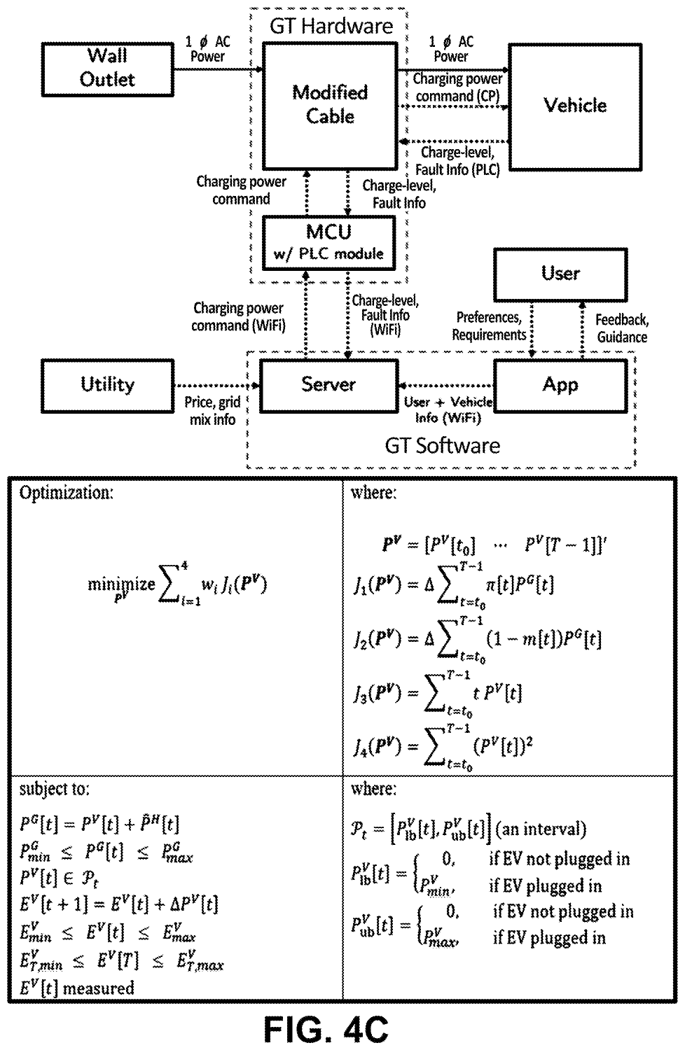

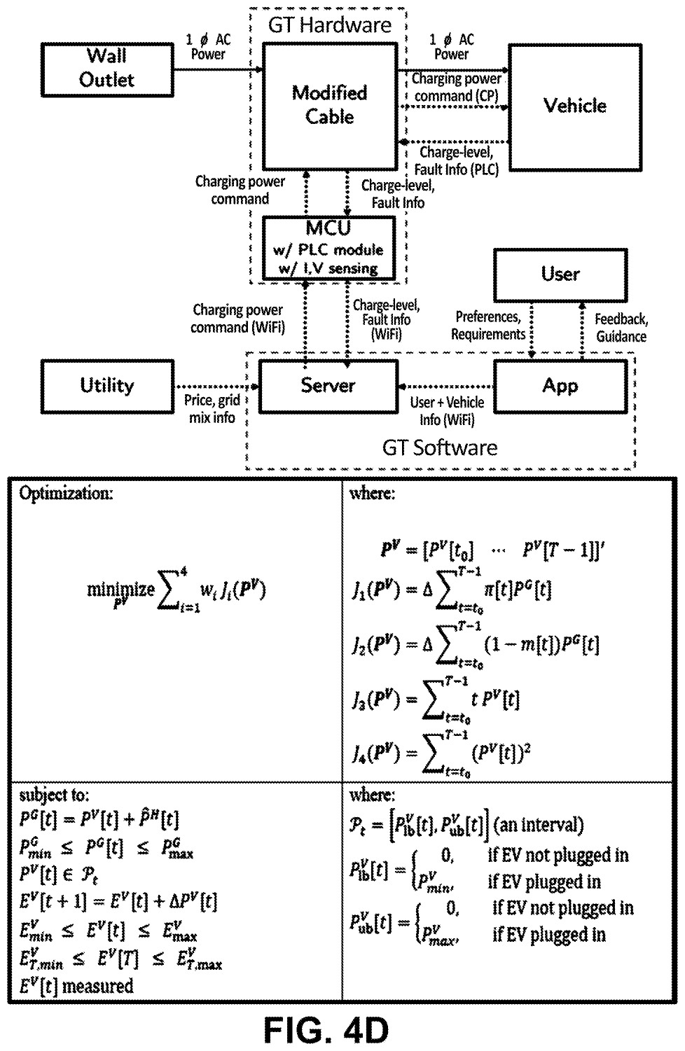

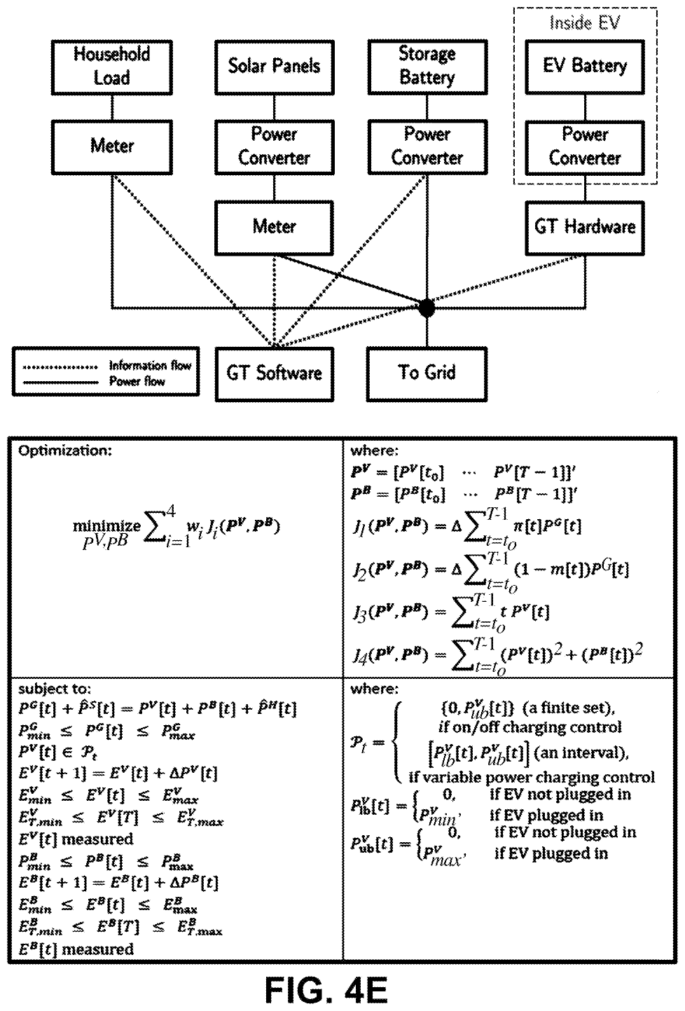

The smart charging optimization operation for EV charging can be optimized for simultaneous operation with local energy storage and/or solar panels, e.g., as described in relation to FIGS. 4A-4E, and/or optimized to simultaneously reduce grid impact as described in relation to FIGS. 4A-4C. In [11], it was shown that the peak power drawn by a neighborhood while optimizing using TOU pricing for a home each having an electric vehicle can reduce the peak by about 1.2× to 2× of the peak household load. The operation can be performed without compromising on charging cost or the amount of charge transferred.

### Example Grid-Favorable Smart Charging Algorithm

The exemplary smart charging algorithm (e.g., 116) can be configured to be grid-favorable by (i) allowing EV owners to obtain a multitude of benefits by performing smart charging while (ii) allowing the power utility to simultaneously obtain benefits that may serve to delay/eliminate infrastructure upgrades. The grid-favorable smart charging algorithm can also be configured as a two-stage optimization operation, e.g., as described in relation to FIG. 2A.

In some embodiments, the charging algorithm is configured to use user-provided charging requirements (i.e., how much energy is needed, and how long the vehicle will be plugged-in to charge), grid energy mix data (e.g., m[t]), household demand data (if the EV is plugged in at a home), solar panel generation data (if a solar panel is present), power flow into/out of local battery storage (if that device is present), and numerous physical limits that constrain the problem including (i) power flow limits associated with circuit breakers, wiring, the EV's onboard charger, and (ii) limits on the amount of energy that can be stored in the EV's battery and local storage battery (if present) due to their finite capacity

Example Operation. At each of the T−1 sampling instants, t=1, 2, . . . , T−1, the smart charging algorithm (e.g., 116) determines the power flow P^{V}[t] (201) into the EV battery 136. The smart charging algorithm's decision variables include P^{V}:=[P^{V}[1] . . . P^{V}[T−1]]′∈ [symbol] ^{T-1}.

The power flow P^{V} (201) into the EV battery (136) may be constant (for Δ units of time) between successive sampling instants. Time instant t=1 may mark the beginning of a smart charging session, at which time the electric vehicle is plugged in. Time instant t=T may mark the end of a smart charging session, at which time the energy stored (206) in the EV battery (136) must reach a pre-specified level.

The system may receive, from the electric power utility, a broadcasted time-of-use (TOU) price signal π[t] (referenced as 212a) (as several utilities in the United States currently do), as well as a grid mix signal, m[t] (212b) (see, e.g., references [39], [40], [41]). Utilities may track the power output from each generator in their portfolio over time. Using this data, the grid mix signal m (212b) can be calculated by Equation 2.

$$m [ t ] : = \frac{Power from renewable sources at time t}{Power from all sources at time t} ∈ [ 0 , 1 ] \qquad ( Eq . 2 )$$

The utility may broadcast (in certain embodiments) an averaged grid mix signal (e.g., 212b) once every few months instead of a new projection every day. Both TOU price and grid mix signals (e.g., 212a, 212b) may be broadcast using the same or different communication infrastructure.

The EV owner's input may be captured and converted to weights,

$${\{ {w}_{i} \}}_{i = 1}^{3}$$

(or w₁, w₂, w₃) (referenced as 212c) for use in the exemplary operation. The weights (e.g., 212c) may thus capture the user's preferences towards various smart charging objectives and a scalar,

$${E}_{T , des}^{V}$$

(e.g., 210) may specify the charging needs. The energy stored in the EV battery E^{V}[t] (referenced as 214a) may be measured, and an estimator (not shown) may forecast the power draw of the house PH [t] for the charging (referenced as 216a). An estimator (not shown) may forecast the power generation or power draw from photovoltaic sources or local energy storage (referenced as 216e).

$${E}_{m i n}^{V} and {E}_{ma x}^{V}$$

(referenced as 218a) may define limits on the energy levels in the EV battery and can be retrieved, in some embodiments, from datasheets.

$${P}_{ma x}^{V}$$

(referenced as 218b) is the maximum power available for the EV charging and depends on power flow limits associated with i) household wiring, ii) the electric vehicle supply equipment, and iii) the vehicle's on-board battery charger.

$${P}_{ma x}^{G}$$

(referenced as 218c) is the maximum power that can be drawn from the grid by the home and EV together and can be set in accordance with the household's main circuit breaker rating.

In some embodiments, the estimator is a module implemented within the optimization engine. In other embodiments, the estimator is an external function (internal or remote to the system) that provides the estimated values to the optimization engine.

The system may employ three terms,

$${\{ {J}_{i} \}}_{i = 1}^{3}$$

(referenced as 220) and three weights

$${\{ {w}_{i} \}}_{i = 1}^{3}$$

(212c) to capture various smart charging preferences and their relative importance, respectively.

The first stage of the smart charging operation may be established, as a minimize operator, per Equation 3, that is subject to equations 5-10 where J₁(P^{V}), J₂(P^{V}), J₃(P^{V}) (220) are defined per Equations 4a, 4b, 4c.

$${minimize}_{{P}^{v}} {\sum }_{i = 1}^{3} {w}_{i} {J}_{i} ( {P}^{V} ) \qquad ( Eq . 3 )$$

$${J}_{1} ( {P}^{V} ) = Δ {\sum }_{t = 1}^{T - 1} π [ t ] {P}^{V} [ t ] \qquad ( Eq . 4 a )$$

$${J}_{2} ( {P}^{V} ) = Δ {\sum }_{t = 1}^{T - 1} ( 1 - m [ t ] ) {P}^{V} [ t ] \qquad ( Eq . 4 b )$$

$${J}_{3} ( {P}^{V} ) = Δ {\sum }_{t = 1}^{T - 1} {tP}^{V} [ t ] \qquad ( Eq . 4 c )$$

In Equation 4a, J₁ (referenced as 220a) has the units of dollars and captures a user's desire to minimize their payment to the power utility, given a TOU price signal π[t] (212a). The utility has complete authority to determine π[t] (212a). Environmentally conscious users may desire to maximize their use of grid-derived renewable energy. Equivalently, such users can minimize their use of grid-derived non-renewable energy, as measured by J₂ (Eq. 4b) (referenced as 220b), which has units of kilowatt-hours (kWh). Users who wish to charge their vehicles aggressively can minimize, J₃ (Eq. 4c) (referenced as 220c).

Stage 1: Optimization. Table 1 shows a set of optimization constraints for a grid-favorable smart charging optimizer.

TABLE 1

| Optimization Constraints | Description |
|---|---|
| Power Balance (224a) | P^{G}[t] = P^{V}[t] + \hat{P}^{H}[t] |
| Battery Dynamics (224b) | E^{V}[t + 1] = E^{V}[t] + Δ·P^{V}[t] |
| | E^{V}[1] is measured |
| Physical Limits (224c) | ${E}_{min}^{V} \leq {E}^{V} [ t ] \leq {E}_{max}^{V} ;$ |
| | $0 \leq {P}^{G} [ t ] \leq {P}_{max}^{G}$ |
| Charging Requirements | ${E}^{V} [ t ] = {E}_{T , des}^{V}$ |
| (224d) | |

Power Balance (224a): The optimizer (e.g., 116) may constrain charging, e.g., the power drawn from the grid, to favor power balance. The power drawn from the grid P^{G}[t] (referenced as 222a) may be determined per Equation 5.

$${P}^{G} [ t ] = {P}^{V} [ t ] + {\hat{P}}^{H} [ t ] \qquad ( Eq . 5 )$$

Equation 5 may be satisfied for t=1, . . . , T−1. The power balance (222a) in Equation 5 implicitly assumes that all interconnecting lines in the home and electric vehicle system are lossless and that the EVs battery charger perfectly sources or sinks the commanded power. Losses may be expressly modeled or measured in certain embodiments.

Battery Dynamics (224b): The optimizer (e.g., 116) may constrain the charging to optimize battery dynamics. In the optimization, the optimizer (e.g., 116) can use the Thevenin model of the battery to determine the continuous-time ordinary differential equation (ODE) by letting V and R be considered as an open-circuit voltage and the internal resistance of the electric vehicle battery, respectively, per Equation 5a.

$$\frac{d}{d τ} {E}^{V} ( τ ) = f ( {P}^{V} ( τ ) ) : = - V ( \frac{V - \sqrt{{V}^{2} + 4 R {P}^{V} ( τ )}}{2 R} ) \qquad ( Eq . 5 a )$$

Due to the Thevenin resistance, power would necessarily satisfy

$${P}^{V} ( τ ) \geq - \frac{{V}^{2}}{4 R} .$$

And by assuming a small internal resistance R, the ODE can be simplified using

$${lim}_{R \to 0} f ( {P}^{V} ( τ ) ) = {P}^{V} ( τ ) .$$

A zero-order-hold discretization (with time step Δ) can then yield Equation 6.

$${E}^{V} [ t + 1 ] = {E}^{V} [ t ] + Δ \cdot {P}^{V} [ t ] \qquad ( Eq . 6 )$$

In Equation 6, for any signal s, s[t]:=s(t·Δ). The initial conditions E^{V}[1] can be obtained from battery sensors, as expressed in Equation 7.

$${E}^{V} [ 1 ] is measured \qquad ( Eq . 7 )$$

Physical Limits (224c): The optimizer (e.g., 116) may constrain the charging based on the physical limits of the battery. For t=1 to T−1, the constraint may be applied per Equation Set 8 where

$${P}_{max}^{G} > 0 ,$$

and the “on/off” charging may be enforced by requiring that for t=1 to T−1 per Equation 9.

$$\begin{matrix}{E}_{min}^{V} \leq {E}^{V} [ t ] \leq {E}_{max}^{V} , and \\ 0 \leq {P}^{G} [ t ] \leq {P}_{max}^{G}\end{matrix} \qquad ( Eq . Set 8 )$$

$${P}^{V} [ t ] ∈ \{ 0 , {P}_{max}^{V} \} ( where {P}_{max}^{V} > 0 ) \qquad ( Eq . 9 )$$

Charging Requirements (224d): The optimizer (e.g., 116) may constrain the charging based on electric vehicle charging requirements at t=T through Equation 10.

$${E}^{V} [ t ] = {E}_{T , des}^{V} \qquad ( Eq . 10 )$$

In Equation 10, the user-defined scalar E_{T,des}^{V} (210) may be satisfied by:

$$0 \leq {E}_{min}^{V} \leq {E}_{T , des}^{V} \leq {E}_{max}^{V} and \frac{{E}_{T , des}^{V} - {E}^{V} [ 1 ]}{Δ {P}_{max}^{V}} ∈ {ℤ}_{+}$$

Per Equation 10, at each time interval that

$${P}^{V} [ t ] = {P}_{max}^{V} , Δ {P}_{max}^{V} kWh$$

of energy is transferred into the EV battery. Consequently, the total energy transferred during the charging session,

$${E}_{T , des}^{V} - {E}^{V} [ 1 ] ,$$

may be determined to be an integer multiple of

$$Δ {P}_{max}^{V} .$$

The parameters Δ and T may be set to limit any discrepancies between the electric vehicle's owner's actual desires, and the closest, valid setting of

$${E}_{T , des}^{V} . ( 210 ) .$$

Stage 2: Optimization. The objective function in (Eq. 3) favors the EV owner alone. This second stage optimization may be performed to additionally consider the utility's perspective on electric vehicle charging, e.g., maintaining stability and reducing/averaging peaks. In some embodiments, (Eq. 3) may be an integer linear program that can produce multiple optimal solutions. For example, when w₁>0 and w₂=w₃=0, the characteristic ‘flatness’ of TOU price signals can give rise to multiple optimal solutions. In cases where multiple optimal solutions do not exist, a multitude of near-optimal solutions may exist, which can be explored by the optimizer to obtain an EV charging profile (referenced as 216b), which can simultaneously satisfy (or almost satisfy) EV owner and utility objectives.

To prepare for the second stage of optimization, the optimizer (e.g., 1160 may solve Eq. 3 to determine the on/off relay profile (referenced as 216c) and record the minimum objective value J* and the

$${\{ {w}_{i} \}}_{i = 1}^{3} .$$

Then, a relaxation parameter ε may be chosen per 0≤ε<<1, and the second stage problem may be solved per Equation Set 11.

$$\begin{matrix}{minimize}_{{P}^{V}} g ( {P}^{V} ) \\ subject to : \{ \begin{matrix}Eqs . 2 , 6 , 7 , 9 , 10 , Eq . Set 8 , and \\ {\sum }_{i = 1}^{3} {w}_{i} {J}_{i} ( {P}^{V} ) \leq ( 1 + ε ) {J}^{*}\end{matrix}\end{matrix} \qquad ( Eq . Set 11 )$$

In Equation Set 11, g: [symbol] ^{T-1}→ [symbol] is a grid-favorable objective function. For example,

$$g ( {P}^{V} ) = {\sum }_{t = 1}^{T - 1} {( {P}^{V} [ t ] + {\hat{P}}^{H} [ t ] )}^{2}$$

constraints in (Eq. Set 11) can be inherited from (Eq. 3), any feasible PV in (Eq. Set 11) may necessarily satisfy

$${\sum }_{i = 1}^{3} {w}_{i} {J}_{i} ( {P}^{V} ) \geq {J}^{*} .$$

Thus, the relaxation parameter ε may be interpreted as the fractional increase in the initial objective value (i.e., the objective of Eq. 3) that is accepted in order to achieve grid-favorable behavior. The setting the relaxation parameter ε=0 can restrict the feasible set of Eq. Set 11) to optimal solutions of (Eq. 3).

Continuous-Varying Optimization. In the example shown in FIG. 2B, the optimizer engine (e.g., 118b) is configured to also perform the two-stage optimization to determine the estimated charging profile 216b. Rather than outputting an on/off profile, the estimated charging profile 216b may be output as setpoints for continuous charging profile.

### Example Networked Relay Device System

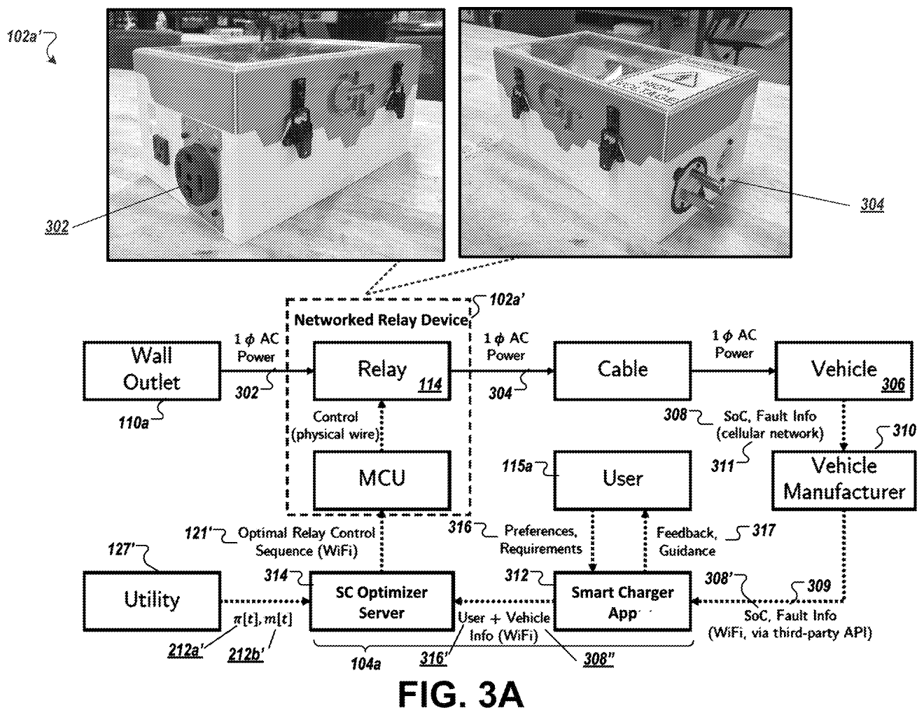

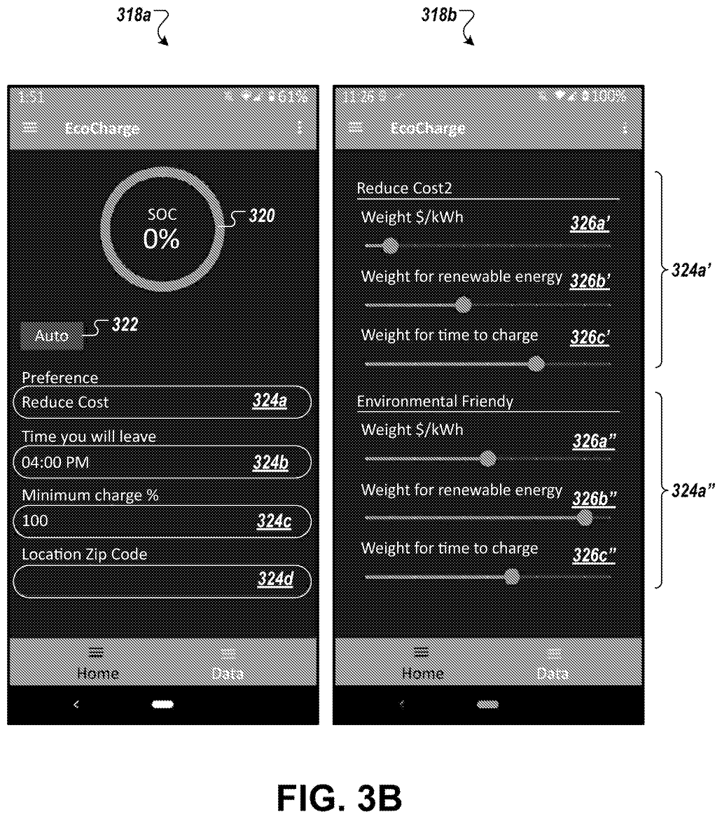

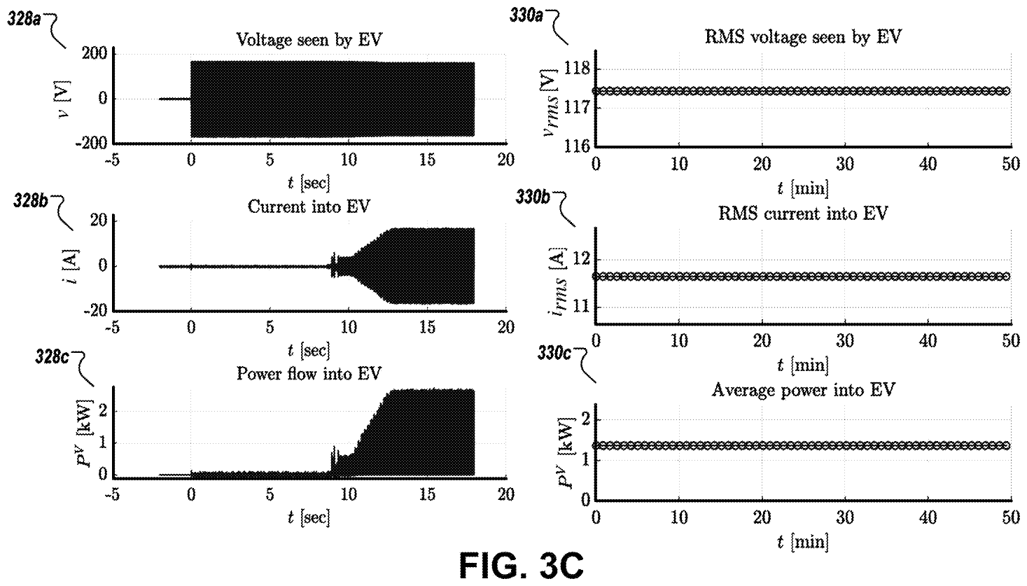

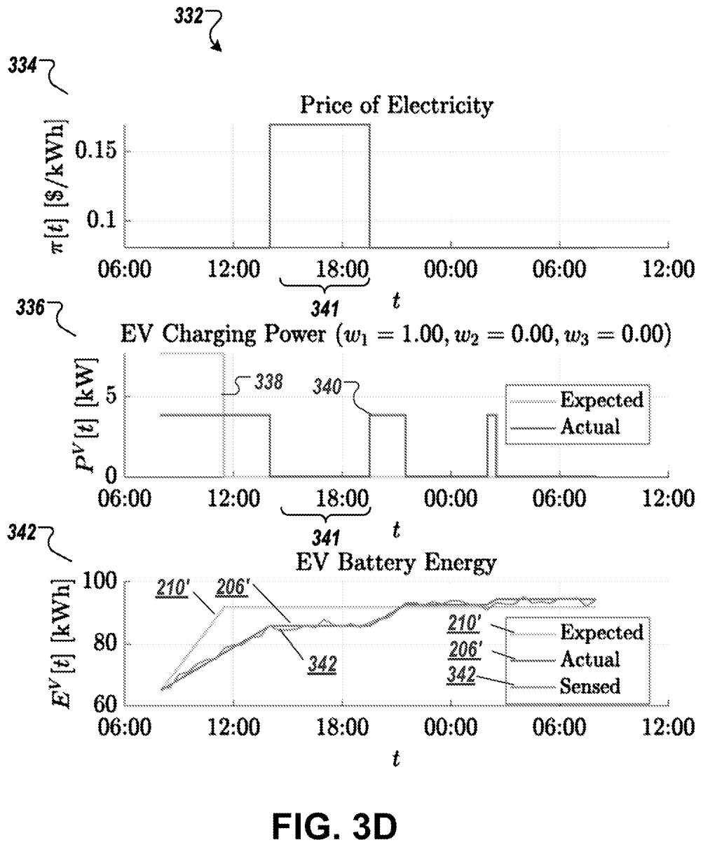

FIG. 3A shows an example of the networked relay device 102a (shown as 102a′) configured to operate with cloud infrastructure 104a.

In FIG. 3A, the relay (e.g., 114) in the networked relay device 102a′ as a smart charging system includes an input connector 302 to a 1-phase AC power wall outlet 110 (shown as 110a) and an output connector 304 to the 1-phase AC power that couples to an electric vehicle 136 and electric vehicle charger unit (collectively shown as 306). The electric vehicle 136 of the electric vehicle system 306 is configured to transmit state-of-charge information or measurements 308 (shown as “SoC, Fault Info (cellular network)” 308) to a server of the electric vehicle manufacturer (shown as “Vehicle Manufacturer”) 310 through a wireless cellular network. The electric vehicle manufacturer server 310 then provides the state-of-charge information or measurements 308 (shown as 308′) or other fault information 309 to the cloud infrastructure 104a. In this example, the cloud infrastructure 104a includes two servers (shown as “Smart Charger App” server 312 and “SC Optimizer” 314). The Smart Charger App server 312 executes, e.g., as shown in FIG. 1A, an embodiment of the EV control interface 124 and the user portal (e.g., 119), and the SC Optimizer server 314 executes an embodiment of the smart relay interface 122, utility control interface 126, optimizer engine 118, and optimizer application 120.

A user-associated computing device 115 (shown as “User” 115a) executes a mobile APP that receives and transmits the user's preference requirements 316 to the user portal (e.g., 119) of the Smart Charger App 312. The Smart Charger App server 312 serves as a point of data aggregation for the state-of-charge information or measurements 308′, 309 from the vehicle manufacturer server 530, as well as user preferences 316 from the user. The Smart Charger App server 312 can also provide web services to relay the measurements and operational information 317 (shown as “Feedback Guidance” 317), monitored and maintained at the Smart Charger App server 312, to the user app 115a.

The SC Optimizer Server 314 receives the user preference information 316 (shown as 316′) and vehicle information 308 (shown as 308″) from the Smart Charger App server 312, via a wireless connection. The SC Optimizer Server 314 also receives the (TOU) price signal (shown as “π[t]” 212a′) and grid mix signal (shown as “m[t]” 212b′) from a utility server 127 (shown as 127′). The SC Optimizer Server 314 executes the optimizer algorithm (e.g., 116) and provides the optimized profile 121 (shown as “Optimal Relay Control Sequence” 121′) to the networked relay device 102a′. In the diagram of FIG. 3A, power flow is indicated by solid arrows and data flow is indicated by dotted arrows.

Example Smart Charger User Interface. FIG. 3B shows examples of the user interfaces 318 (shown as 318a, 318b) of the mobile APP executing on the user's device 115a. In the example shown in FIG. 3B, the user interface 318a shows the visualization 320 of the vehicle's state of charge information (e.g., 308). The user interface 318a includes a widget 322 (shown as “auto” 322) to trigger an update/refresh of the SOC information. The user interface 318a presents a user preference input 324a to receive the user's preference for the smart charging operation, a user's time input 324b for when the premise would not have an occupant, a user charge input 324c that indicates the user's required minimum charge, and user's premise location 324d.

The user interface 318b includes the user's customizable inputs for the weights wᵢ (212c) or the optimizer algorithm (e.g., 116). The user preference input 324a provides a set of selectable options (e.g., minimize cost, maximize carbon-free energy usage, minimize charging time, or minimize battery degradation). In the example, the user interface 318a includes a cost-reduction preference weight 326a, a renewable energy preference weight 326b, a time-to-charge preference weight 326c for each of the selectable options in 324a (shown as 324a′, 324a″, and 324′″ (note: 324′″ not shown in the example)). The user interface 318b presents defaults weight values for the preference weights 326a, 326b, 326c for each of the options (shown as 326a′, 326b′, 326c′ for the reduced cost option; 326a″, 326b″, 326c″ for the maximizing carbon-free energy usage/environmentally friendly option). In this example, the inputs 326a′, 326b′, 326c′ (for the reduced cost option) and inputs 326a″, 326b″, 326c″ (for the environmentally friendly option) are adjustable to vary the value for w₁, w₂, and w₃ (212c) to be employed in the optimization algorithm (e.g., 116).

The user's time input 324b for when the premise would not have an occupant provides an initialization time point t=1 for the calculation of the length of the optimization time horizon T. The user charge input 324c indicates the user's required minimum charge provides the desired value of the energy stored in the electric vehicle E_{T,des}^{V} (210). The user's premise location 324d can be used to retrieve the price signal π[t] 212a′ and the grid mix signal m[t] 212b′ from the utility server (e.g., 127) for the specific premise location.

Example Method of Operation. FIG. 3C shows the measurement of the smart charging operation (the example shows a response time validation test). In FIG. 3C, plots 328a, 328b, 328c show sustained charging of the networked relay system 102a′. Specifically, plot 328a shows the measured voltage at the electric vehicle in volts (e.g., at connector 304), plot 328b shows the measured current in Amp (also at connector 304), and plot 328c shows the measured power flow in kW (corresponding to the P^{V} (201)). The waveforms oscillate at 60 Hz; the relay closure is observed to occur at t=0 s. Plots 330a, 330b, 330c show the same measured voltage, current, and power flow in RMS. In this example, the average power flow has a maximum level of about 1.37 kW at t≈13 s. Plots 328a-328c show a sustained charging of about 1.37 kW average power for about 50 min, resulting in a 10% increase in state-of-charge.

FIG. 3D show plots of the optimized operating profile 332. Plot 334 shows a price of the electricity profile; plot 336 shows the expected charging profile 338, and the measured charging profile 340; plot 342 shows the battery charge level in kWh (344). It is contemplated that the mismatch between expected charging profile 340 and measured charging profile 342 is attributable to (i) measurement noise, (ii) unaccounted battery dynamics, and (iii) inaccurate charging parameter P^{V}_{MAX}. It can be observed that use of the system employed feedback data nevertheless avoided charging during expensive times 341 while satisfactorily charging to the desired charge level by the terminal time. Plot 342 shows the expected battery state E_{T,des}^{V} (shown as 210′), the actual battery charge state E^{V}[t] (shown as 206′), and the measured charge state.

### Example Smart Charger Optimization Algorithm

FIGS. 4A-4E show example system configurations and corresponding algorithms configured to control power flow to the electric vehicle charger unit.

### Example System Configuration #1 and Associated Algorithm #1

FIG. 4A shows an example system and corresponding algorithm (per Equation Sets 12a and 12B) configured to control power flow to the electric vehicle charger unit in an “on/off” manner, using a relay as described in relation to FIGS. 1A, 1B, and 1C. In FIG. 4A, the data exchange between the smart charging system and the EV is implemented using a wireless communication channel.

$$( Eq . Set 12 A )$$

$${minimize}_{{P}^{V}} {\sum }_{i = 1}^{3} {w}_{i} {J}_{i} ( {P}^{V} ) , where \{ \begin{matrix}{P}^{V} = {[ \begin{matrix}{P}^{V} [ {t}_{0} ] & ⋯ & {P}^{V} [ T - 1 ]\end{matrix} ]}^{′} \\ {J}_{1} ( {P}^{V} ) = Δ {\sum }_{t = {t}_{0}}^{T - 1} π [ t ] {P}^{G} [ t ] \\ {J}_{2} ( {P}^{V} ) = Δ {\sum }_{t = {t}_{0}}^{T - 1} ( 1 - m [ t ] ) {P}^{G} [ t ] \\ {J}_{3} ( {P}^{V} ) = {\sum }_{t = {t}_{0}}^{T - 1} t {P}^{V} [ t ]\end{matrix}$$

$$subject to \text{:} \{ \begin{matrix}{P}^{G} [ t ] = {P}^{V} [ t ] + {\hat{P}}^{H} [ t ] \\ {P}_{min}^{G} \leq {P}^{G} [ t ] \leq {P}_{max}^{G} \\ {P}^{V} [ t ] ∈ {𝒫}_{t} \\ {E}^{V} [ t + 1 ] = {E}^{V} [ t ] + Δ {P}^{V} [ t ] \\ {E}_{min}^{V} \leq {E}^{V} [ t ] \leq {E}_{max}^{V} \\ {E}_{T , min}^{V} \leq {E}^{V} [ T ] \leq {E}_{T , max}^{V} \\ {E}^{V} [ t ] measured\end{matrix} , where \{ \begin{matrix}{𝒫}_{t} = [ 0 , {P}_{ub}^{V} [ t ] \} ( a finite set ) \\ {P}_{ub}^{V} [ t ] = \{ \begin{matrix}0 , & if EV not plugged in at time t \\ {P}_{max}^{V} , & if EV plugged in at time t\end{matrix}\end{matrix} \qquad ( Eq . Set 12 B )$$

In Equation Set 12A, wᵢ is a pre-defined or user-definable weights. P^{V} is the power flow into electric vehicle charger unit at time t, J₁ is the objective function for minimizing the customer's payments to the utility; J₂ is the objective function for minimizing the customer's use of grid-derived non-renewable energy; and J₃ is the objective function for minimizing the customer's time-to-charge. Table 2 provides the description for the other variables in Equation Set 12B.

TABLE 2

| Symbol(s) | Units | Description |
|---|---|---|
| T | — | end of time horizon (integer) |
| t₀ | — | start of time horizon (integer) |
| t | — | time index: t = t₀, t₀ + 1, ... , T |
| Δ | hr | time step |
| π[t] | $/kWh | price of electricity at time t |
| m[t] | — | grid energy mix at time t |
| P^{V}[t] | kW | power flow into EV at time t |
| P^{B}[t] | kW | power flow into storage battery at time t |
| P^{G}[t] | kW | power draw from grid at time t |
| \hat{P}^{H}[t] | kW | estimated power flow into home at time t |
| \hat{P}^{S}[t] | kW | estimated power generated by solar at time t |
| ${P}_{min}^{V} , {P}_{max}^{V}$ | kW | bounds on P^{V}[t] (for all t) |
| ${P}_{min}^{B} , {P}_{max}^{B}$ | kW | bounds on P^{B}[t] (for all t) |
| ${P}_{min}^{G} , {P}_{max}^{G}$ | kW | bounds on P^{G}[t] (for all t) |
| E^{V}[t] | kWh | energy stored in EV battery at time t |
| ${E}_{min}^{V} , {E}_{max}^{V}$ | kWh | bounds on E^{V}[t] (for all t) |
| ${E}_{T , min}^{V} , {E}_{T , max}^{V}$ | kWh | bounds on E^{V}[T] |
| E^{B}[t] | kWh | energy stored in storage battery at time t |
| ${E}_{min}^{B} , {E}_{max}^{B}$ | kWh | bounds on E^{B}[t] (for all t) |
| ${E}_{T , min}^{B} , {E}_{T , max}^{B}$ | kWh | bounds on E^{B}[T] |

Example System Configuration #2 with Associated Algorithm #1

FIG. 4B shows another example system and corresponding algorithm (also per Equation Sets 12A and 12B) configured to control power flow to the electric vehicle charger unit in an on/off manner, using a relay as described in relation to FIGS. 1A, 1B, and 1C. In FIG. 4B, the data exchange between the smart charging system and the electric vehicle charger unit is implemented using a power line communication interface. The PLC interface can reduce the need and cost for third-party wireless communication and associated subscription services. Vehicle manufacturers may allow for the vehicle to be interrogated via PLC for this scheme to be realized. The SAE J2931 standard codifies the communication protocol and message formats that may be used.

Example System Configuration #3 with Associated Algorithm #2

FIG. 4C shows another example system and corresponding algorithm (per Equation Sets 13A and 13B) configured to control power flow to the electric vehicle charger unit in a continually-variable manner, using an electric vehicle interface, e.g., as described in relation to FIG. 1C. In FIG. 4C, the data exchange between the smart charging system and the electric vehicle charger unit is implemented using a charging cable compliant with the SAE J1772 standard. The interface or system (or a separate microcontroller (MCU)) may generate (e.g., spoof) the control pilot signal (see SAE J1772) in which the control pilot signal informs the electric vehicle charger unit of the maximum charging power available to it (at any given time). The exemplary system may set the signal to a constant value (determined by physical limits, e.g., circuit breaker ratings), or it may vary the signal between zero and an upper bound to achieve finer control of the power flow into the electric vehicle charger unit.

In the example, the system includes a PLC interface that can reduce the need and cost for third-party wireless communication and associated subscription services as described in relation to FIG. 4B. In other examples, a wireless communication channel may be implemented, e.g., as described in relation to FIG. 4A.

$$( Eq . Set 13 A )$$

$${minimize}_{{P}^{V}} {\sum }_{i = 1}^{4} {w}_{i} {J}_{i} ( {P}^{V} ) , where \{ \begin{matrix}{P}^{V} = {[ \begin{matrix}{P}^{V} [ {t}_{0} ] & ⋯ & {P}^{V} [ T - 1 ]\end{matrix} ]}^{′} \\ {J}_{1} ( {P}^{V} ) = Δ {\sum }_{t = {t}_{0}}^{T - 1} π [ t ] {P}^{G} [ t ] \\ {J}_{2} ( {P}^{V} ) = Δ {\sum }_{t = {t}_{0}}^{T - 1} ( 1 - m [ t ] ) {P}^{G} [ t ] \\ {J}_{3} ( {P}^{V} ) = {\sum }_{t = {t}_{0}}^{T - 1} t {P}^{V} [ t ] \\ {J}_{4} ( {P}^{V} ) = {\sum }_{t = {t}_{0}}^{T - 1} {( {P}^{V} [ t ] )}^{2}\end{matrix}$$

$$subject to \text{:} \{ \begin{matrix}{P}^{G} [ t ] = {P}^{V} [ t ] + {\hat{P}}^{H} [ t ] \\ {P}_{min}^{G} \leq {P}^{G} [ t ] \leq {P}_{max}^{G} \\ {P}^{V} [ t ] ∈ {𝒫}_{t} \\ {E}^{V} [ t + 1 ] = {E}^{V} [ t ] + Δ {P}^{V} [ t ] \\ {E}_{min}^{V} \leq {E}^{V} [ t ] \leq {E}_{max}^{V} \\ {E}_{T , min}^{V} \leq {E}^{V} [ T ] \leq {E}_{T , max}^{V} \\ {E}^{V} [ t ] measured\end{matrix} , where \{ \begin{matrix}{𝒫}_{t} = [ {P}_{lb}^{V} [ t ] , {P}_{ub}^{V} [ t ] ] ( an interval ) \\ {P}_{lb}^{V} [ t ] = \{ \begin{matrix}0 , & if EV not plugged in \\ {P}_{min}^{V} , & if EV plugged in\end{matrix} \\ {P}_{ub}^{V} [ t ] = \{ \begin{matrix}0 , & if EV not plugged in \\ {P}_{max}^{V} , & if EV plugged in\end{matrix}\end{matrix} \qquad ( Eq . Set 13 B )$$

In Equation Set 13A, the objective function is similar to Equation Set 2A and further includes an objective function J₄ to model the reduce battery degradation by charging at lower power levels, for longer durations (and is thus incompatible with relay-based hardware which only allows for two power levels). In addition, constraints for [symbol] ₜ,

$${P}_{lb}^{V} [ t ] , {P}_{ub}^{V} [ t ]$$

is formulated for a continually varying operation.
Example System Configuration #4 with Associated Algorithm #2

FIG. 4D shows another example system and corresponding algorithm (also per Equation Sets 13A and 13B) configured to control power flow to the electric vehicle charger unit in a continually-variable manner, using an electric vehicle interface, e.g., as described in relation to FIG. 1C.

In FIG. 4D, the example system includes sensors configured to monitor current and voltage at the power source (wall outlet) to reduce or eliminate the need for data exchange with the vehicle. The source monitoring can provide information on power/energy flow into the vehicle or charger at a fine time resolution and finer than measurements, e.g., from third-party APIs to communicate with the vehicle.

In FIG. 4D, the data exchange between the smart charging system and the electric vehicle charger unit is implemented using a charging cable compliant with the SAE J1772 standard. The PLC interface can reduce the need and cost for third-party wireless communication and associated subscription services.

Example System Configuration #5 with Associated Algorithm #3

FIG. 4E shows another example system and corresponding algorithm (also per Equation Sets 14A and 14B) configured to control power flow to the electric vehicle charger unit in an “on/off” manner, using a relay as described in relation to FIGS. 1A, 1B, and 1C. The algorithm per Equation Sets 14A and 14B can account for an optimizer for local power generation, e.g., via rooftop solar, and/or local energy storage, e.g., via storage battery.

In the example shown in FIG. 4E, the example system may include sensors configured to monitor current and voltage at the power source (wall outlet) to reduce or eliminate the need for data exchange with the vehicle. The source monitoring can provide information on power/energy flow into the vehicle or charger at a fine time resolution and finer than measurements, e.g., from third-party APIs to communicate with the vehicle.

In FIG. 4E, the data exchange between the smart charging system and the electric vehicle charger unit is implemented using a charging cable compliant with the SAE J1772 standard. The PLC interface can reduce the need and cost for third-party wireless communication and associated subscription services. In other embodiments, a wireless communication channel may be employed.

In addition to interacting with the electric vehicle charger unit, the exemplary system (shown as “GT Hardware” and “GT Software”) is configured to interface with (i) a household energy meter to estimate \hat{P}^{H}[t], (ii) an energy meter at the solar panel output to estimate \hat{P}^{S}[t], and (iii) a power converter attached to the storage battery to control P^{B}[t] and measure E^{B}[t].

$$( Eq . Set 14 A )$$

$${minimize}_{{P}^{V} , {P}^{B}} {\sum }_{i = 1}^{4} {w}_{i} {J}_{i} ( {P}^{V} , {P}^{B} ) , where \{ \begin{matrix}{P}^{V} = {[ \begin{matrix}{P}^{V} [ {t}_{0} ] & ⋯ & {P}^{V} [ T - 1 ]\end{matrix} ]}^{′} \\ {P}^{B} = {[ \begin{matrix}{P}^{B} [ {t}_{0} ] & ⋯ & {P}^{B} [ T - 1 ]\end{matrix} ]}^{′} \\ {J}_{1} ( {P}^{V} , {P}^{B} ) = Δ {\sum }_{t = {t}_{0}}^{T - 1} π [ t ] {P}^{G} [ t ] \\ {J}_{2} ( {P}^{V} , {P}^{B} ) = Δ {\sum }_{t = {t}_{0}}^{T - 1} ( 1 - m [ t ] ) {P}^{G} [ t ] \\ {J}_{3} ( {P}^{V} , {P}^{B} ) = {\sum }_{t = {t}_{0}}^{T - 1} t {P}^{V} [ t ] \\ {J}_{4} ( {P}^{V} , {P}^{B} ) = {\sum }_{t = {t}_{0}}^{T - 1} {( {P}^{V} [ t ] )}^{2} + {( {P}^{B} [ t ] )}^{2}\end{matrix}$$

$$subject to \text{:} \{ \begin{matrix}\begin{matrix}{P}^{G} [ t ] + {\hat{P}}^{S} [ t ] = {P}^{V} [ t ] + {P}^{B} [ t ] + {\hat{P}}^{H} [ t ] \\ {P}_{min}^{G} \leq {P}^{G} [ t ] \leq {P}_{max}^{G} \\ {P}^{V} [ t ] ∈ {𝒫}_{t} \\ {E}^{V} [ t + 1 ] = {E}^{V} [ t ] + Δ {P}^{V} [ t ] \\ {E}_{min}^{V} \leq {E}^{V} [ t ] \leq {E}_{max}^{V} \\ {E}_{T , min}^{V} \leq {E}^{V} [ T ] \leq {E}_{T , max}^{V} \\ {E}^{V} [ t ] measured\end{matrix} \\ \begin{matrix}{P}_{min}^{B} \leq {P}^{B} [ t ] \leq {P}_{max}^{B} \\ {E}^{B} [ t + 1 ] = {E}^{B} [ t ] + Δ {P}^{B} [ t ] \\ {E}_{min}^{B} \leq {E}^{B} [ t ] \leq {E}_{max}^{B} \\ {E}_{T , min}^{V} \leq {E}^{B} [ T ] \leq {E}_{T , max}^{B} \\ {E}^{B} [ t ] measured\end{matrix}\end{matrix} , \qquad ( Eq . Set 14 B )$$

$$where :$$

$${𝒫}_{t} = \{ \begin{matrix}[ 0 , {P}_{ub}^{V} [ t ] \} ( a finite set ) , \\ if on / off charging control \\ [ {P}_{lb}^{V} [ t ] , {P}_{ub}^{V} [ t ] ] ( an interval ) , \\ if variable power charging control\end{matrix}$$

$${P}_{lb}^{V} [ t ] = \{ \begin{matrix}0 , & if EV not plugged in \\ {P}_{min}^{V} , & if EV plugged in\end{matrix}$$

$${P}_{ub}^{V} [ t ] = \{ \begin{matrix}0 , & if EV not plugged in \\ {P}_{max}^{V} , & if EV plugged in\end{matrix}$$

It can be observed that the additional set of decision variables and constraints are due to the presence of the storage battery. Solar panels would influence the power balance equation.

$${P}^{G} [ t ] + {\hat{P}}^{S} [ t ] = {P}^{V} [ t ] + {P}^{B} [ t ] + {\hat{P}}^{H} [ t ] .$$

### EXPERIMENTAL RESULTS AND ADDITIONAL EXAMPLES

Several studies were conducted that developed a smart charging system of the exemplary system described herein for a plug-in electric vehicle (EV).

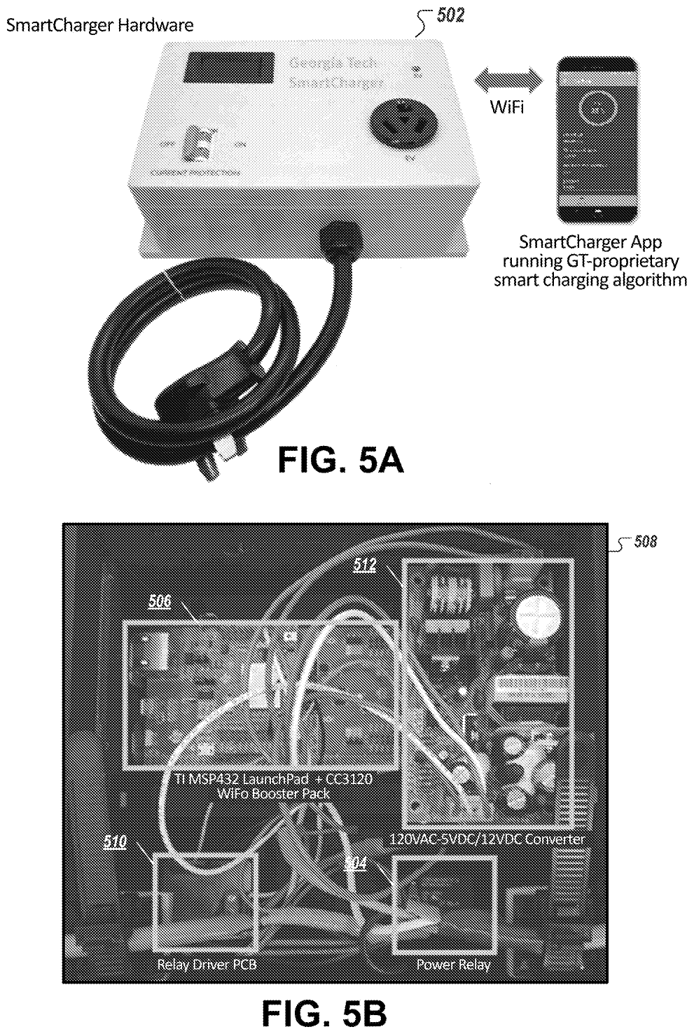

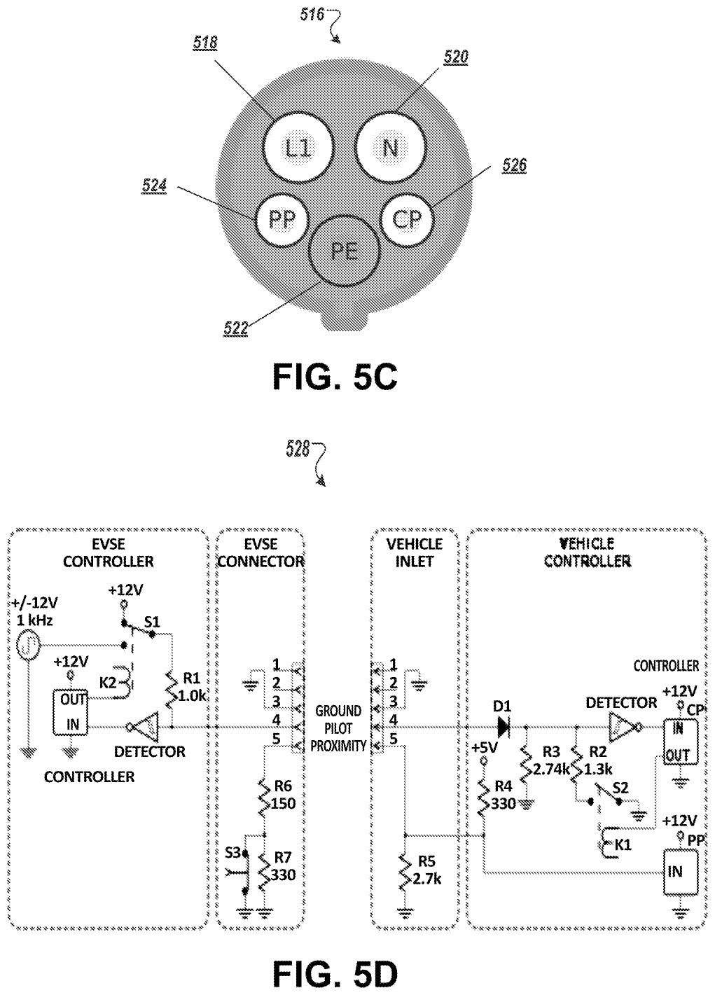

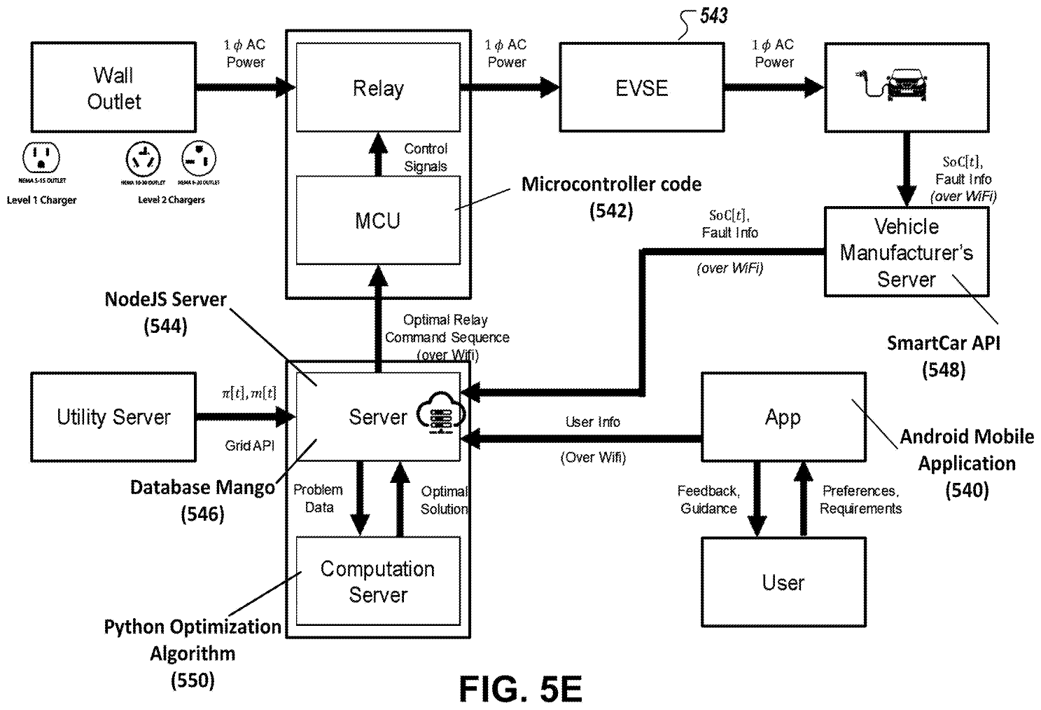

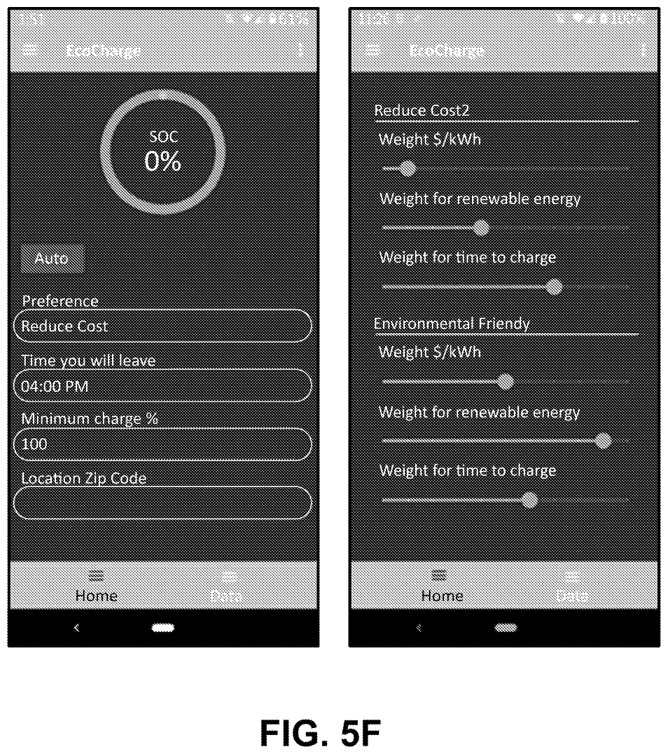

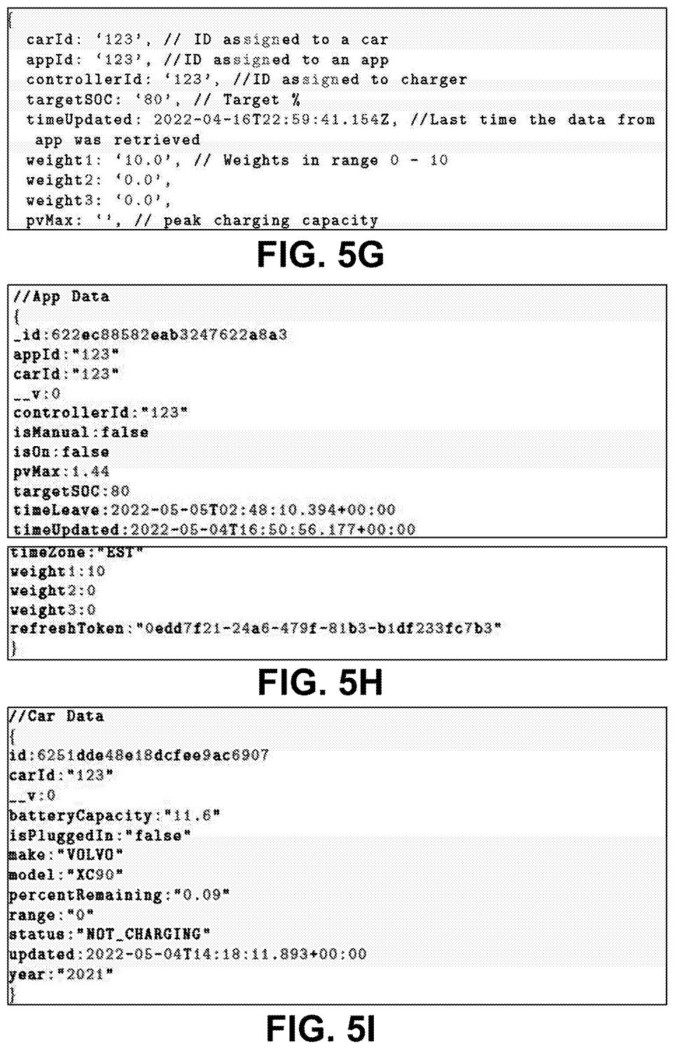

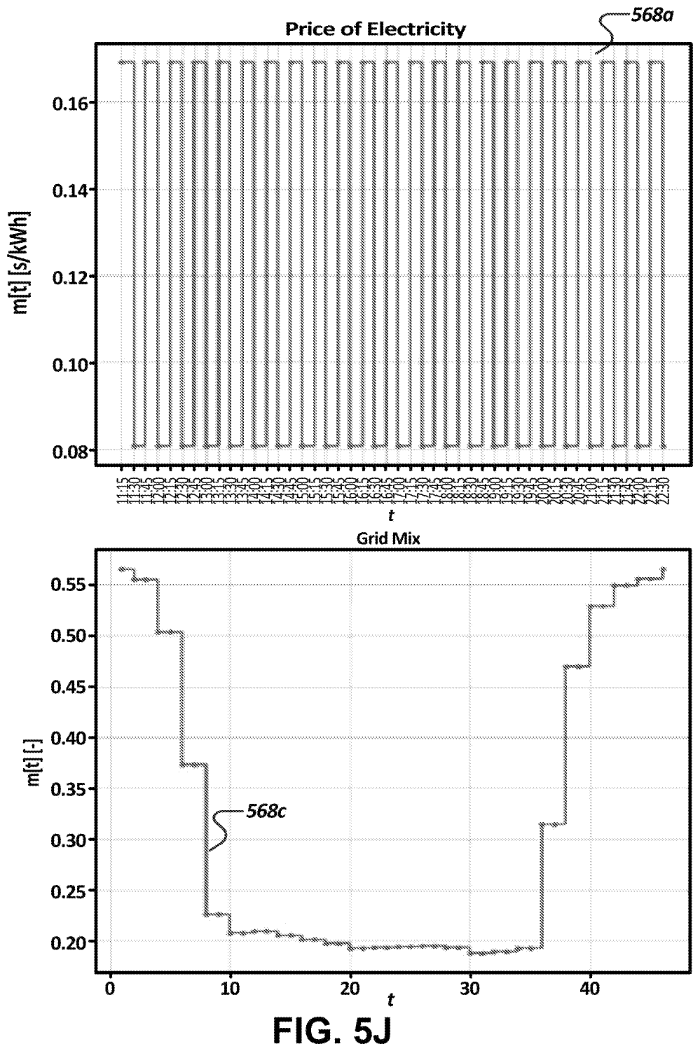

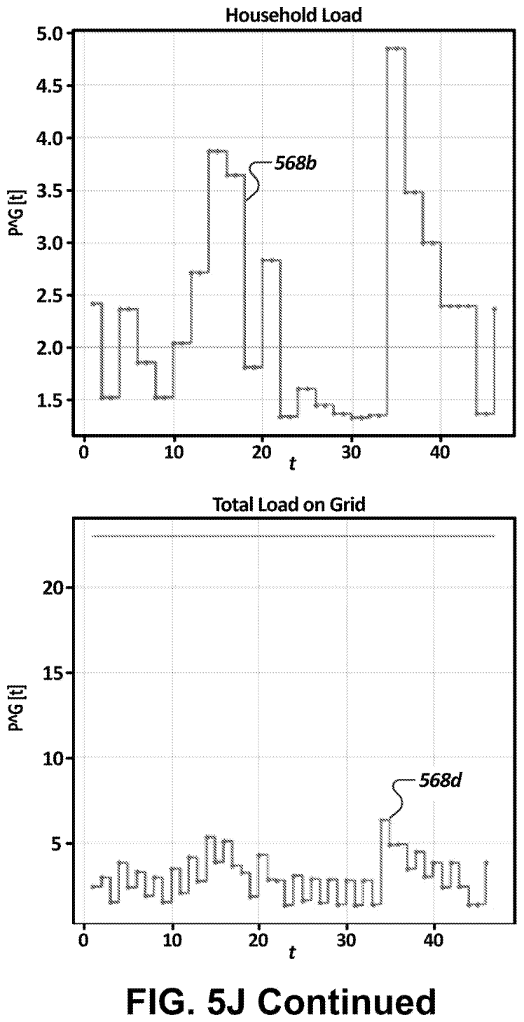

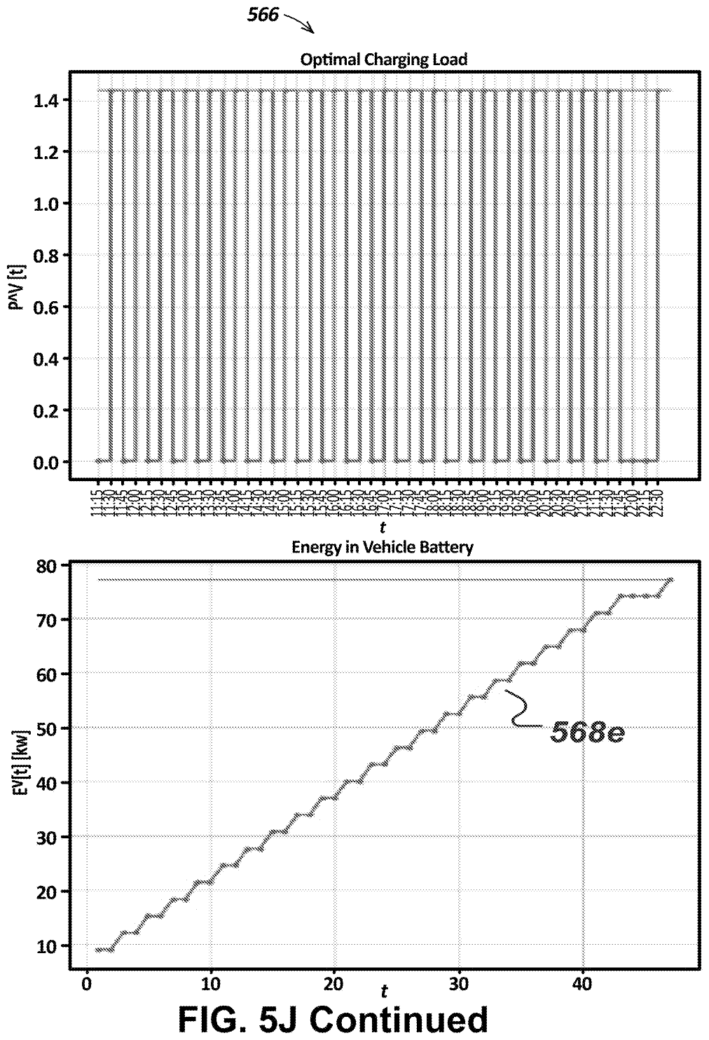

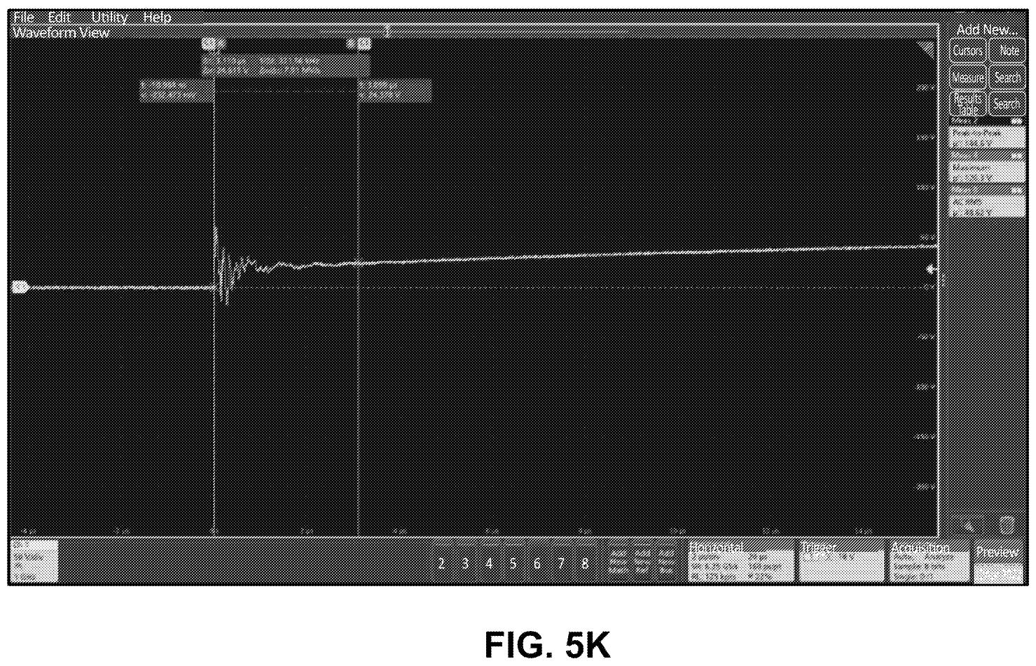

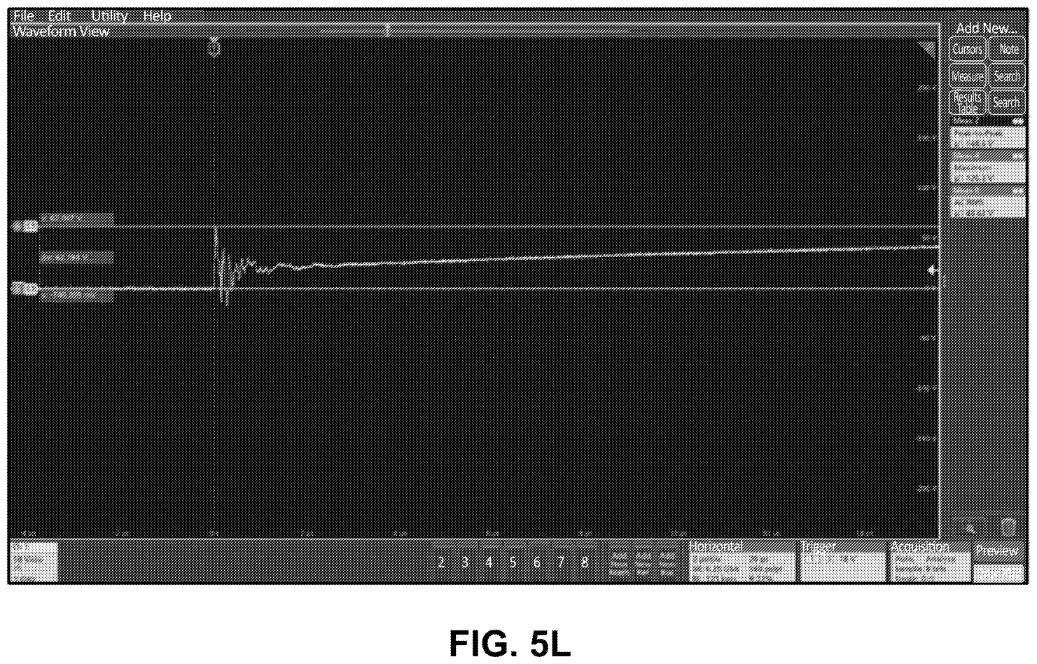

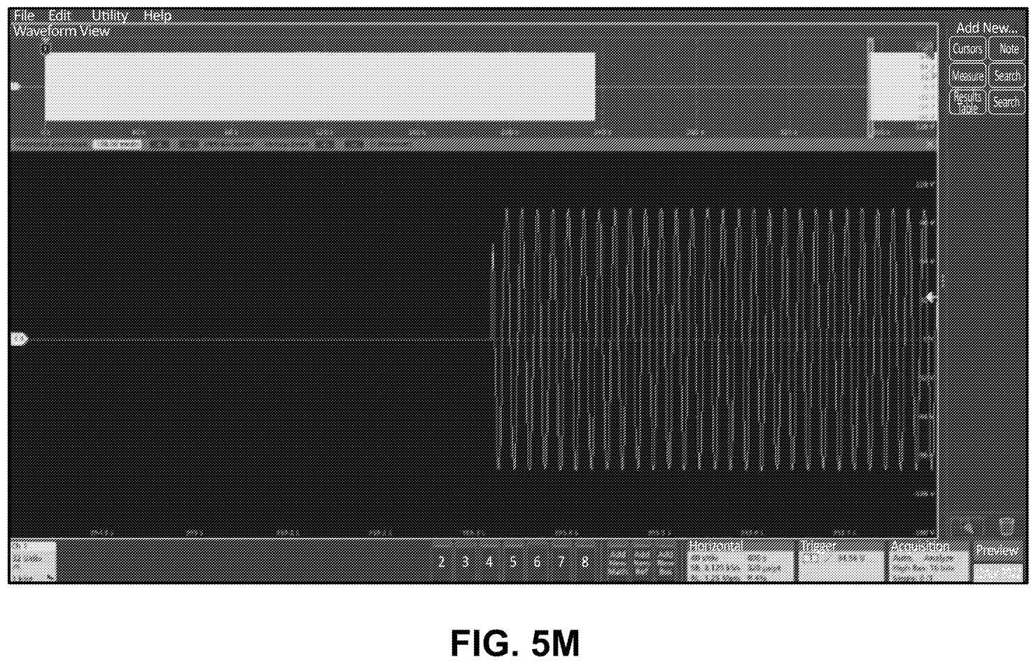

Prototype System. FIGS. 5A and 5B show a prototype of the smart charging system (e.g., 102) (shown as 502). FIG. 5B shows an example configuration of the hardware and software components of the study. In FIG. 5B, the relay 114 (shown as “Power Relay” 504) has an input connector to a 1-phase AC power wall outlet and an output connector to the 1-phase AC power that couples to an electric vehicle charger unit (e.g., 112) and electric vehicle (e.g., 136).

In FIG. 5B, the prototyped system employed a TI MSP432 microcontroller board 506 that is coupled to the high current relay 504 in a 3D printed enclosure 508. The microcontroller board 506 interfaces with a relay driver board 510 to actuate the power relay 504. The relay 504 and control boards 506, 510 are powered by an AC-DC converter 512 (shown as a 120 VAC to 5 VDC/12 VDC converter).

The microcontroller 506 was configured with an Android application developed in the study to control the charging, set the parameters for the algorithm, and get charge status. The decisions for the charging is obtained by solving a quadratic problem on a NodeJS server (e.g., 314) hosted on Azure cloud service. The charger currently supports Level 1 charging.

The networked relay device was configured to minimize or ameliorate the effects of aggregated plug-in Electric Vehicle (PEV) charging loads that can impact utilities by seriously stressing or overloading the electric network, diminishing power quality, creating mismatches in supply-demand, and lowering the overall dependability of the network's distribution systems. The networked relay device was configured to (1) provide a mechanism to control the charging of the Electric Vehicle, (2) ensure that the delay introduced in the system is negligible to the working of the system, (3) shut down in non-destructive fault scenarios, (4) ensure minimal power dissipation on the main power path, (5) provide reliable isolation between control and power segments of the circuit, and (6) guarantee the safety of the load (the Plug-in Electric Vehicle) and the components used in the system (e.g., SAE J1772 Standard).

The smart charging algorithm, as employed in the networked relay device of the study can: (i) maximize the usage of renewable resources and minimize energy costs, (ii) close the gap between grid capacity and consumer demand, and (iii) reduce the additional stress and reliability issues uncoordinated PEV charging is expected to have on the power grid.

The smart charging system of the study does not require direct access to the battery terminals nor any communication capability in connection with the battery charger. The smart charging system of the study thus differs from the charge-scheduling solutions described in [12]-[26] and various manufacturers, including those noted in Table 3. The controllable power converters in [12]-[18], [21]-[26] require direct access to battery terminals. Although the other electric vehicle charger units could be used to modulate EV charging power as commanded by a smart charging algorithm, implementation would require either an agreement with the on-board hardware of the specific vehicle manufacturers or customized dedicated charging connectors with pins for DC charging in EV's charging port. In the latter case, SAE J1172 standard does not require dedicated charging connectors and pins [27] and thus are not implemented by many manufacturers. Additionally, at present, convention dictates that EV chargers that perform off-board AC/DC conversion operate at high power levels that are unsuitable for home charging.

TABLE 3

| EVSE Makes/Models | EV Makes |
|---|---|
| AMPROAD iFlow P9, Emporia Smart, Grizzel-E, | Audi Ford Jeep |
| Ocular IQ, Anderson A2, Enel-x JuiceBox, | Cadillac GMC Toyota |
| Lectron, Smappee, BougeRV Portable, | Chevrolet Honda Tesla |
| EO Mini PRO-2, Mustart, Splitvolt, Wallbox, | Chrysler Hyundai |
| ChargePoint Home Flex, Fimer Flexa AC, | Volvo |
| Myenergi Zappi V2 | |

Unlike [12]-[18], [21]-[26], the exemplary smart charging system can control the flow of AC power to the EV via a relay placed between the EV and the mains connection that is suitable for residential use (where most EV charging occurs) by not requiring direct access to the battery's terminals. Furthermore, the exemplary smart charging system can be operatable for a number of EV models and manufacturers; the study evaluated 99 EV models across 25 makes. The exemplary system can employ third-party telematics API used presently for implementation [28].

In addition, the smart charging system of the study employs an optimization-based feedback control algorithm that can determine EV charging times to perform price-minimal charging under a wider class of TOU price signals (e.g., real-time price signals issued to manage grid impact) as well as support other objectives like maximization of renewable energy consumption. The exemplary optimization-based feedback control algorithm can be modified to reduce the grid impacts of EV charging in other ways, for instance, by charging such that the total demand profile of a grid-connected home with an EV is maximally flat.

Charging Level Operation. The networked relay device was configured to operate in multiple AC charging levels per Tables 4A and 4B according to SAE standard J1772.

TABLE 4A

| | |
|---|---|
| AC Level 1 charging | Allows an EV to be connected to the most |
| | common grounded electrical receptacle (NEMA |
| | 5-15R). The vehicle shall be fitted with an |
| | on-board charger capable of accepting energy |
| | from the existing alternating current (A.C.) |
| | supply network. The maximum power supply for |
| | AC Level 1 charging may conform to the values |
| | in Table 4B. |
| AC Level 2 charging | Utilizes dedicated A.C. EV supply equipment in |
| | either private or public locations. The vehicle |
| | shall be fitted with an onboard charger capable of |
| | accepting energy from alternating current electric |
| | vehicle supply equipment. The maximum power |
| | supply for AC Level 2 charging shall conform to |
| | the values in Table 4B. |
| DC charging | Utilizes dedicated direct current (D.C.) EV supply |
| | equipment to provide energy from an appropriate |
| | off-board charger to the EV in either private or |
| | public locations. The range of charger ratings |
| | encompassed shall conform to the values shown |
| | in Table 4B. |

TABLE 4B

| | | | Branch Circuit |
|---|---|---|---|
| Charge | Nominal Supply | Maximum Current | Breaker rating |
| Method | Voltage (Volts) | (Amps-continuous) | (Amps) |
| AC Level 1 | 120 vac, 1-phase | 12 A | 15 A (minimum) |
| AC Level 2 | 208 to 240 vac, | 32 A | 40 A |
| | 1-phase | | |
| DC Charging | 600 vdc | 400 A maximum | As required |
| | maximum | | |

For the power path, the cables were configured to carry at a minimum 10A (Level 1 Charging) and a maximum of 20 A (Level 2 Charging).

SAE J-1772 Connector. FIG. 5C shows a schematic of an example SAE J-1772 connector 616. Table 4C provides a description of the pin configurations.

TABLE 4C

| Pin | Description |
|---|---|
| L1 (pin 1 (618)) | AC Line 1 |
| N (pin 2 (620)) | AC Neutral for 120 V Level 1 charging or AC Line 2 |
| | for 208-240 V Level 2 charging |
| PE (pin 3 (622)) | Ground line (“Protective Earth” (PE)) |
| PP (pin 4 (624)) | The “Proximity Pilot” pin (“plug present”): provides a |
| | signal to the vehicle's control system so it can prevent |
| | movement while connected to the electric vehicle |
| | supply equipment (EVSE, i.e., the electric vehicle |
| | charging system or station), and signals the latch |
| | release button to the vehicle. |
| CP (pin 5 (626)) | “Control Pilot” pin is employed for a communication |
| | line used to signal the charging level between the car |
| | and the electric vehicle charging system and can be |
| | manipulated by the vehicle to initiate charging as well |
| | as other information. The signal is a 1 kHz square |
| | wave at ±12 volts generated by the EVSE to detect |
| | the presence of the vehicle, communicate the |
| | maximum allowable charging current and control |
| | charging begin/end. |

In FIG. 5C pins “1” and “2” (518, 520) at the top are spaced 6.8 millimeters (mm) (0.27 inches (in)) above the centerline of the connector, and the pins are spaced 15.7 mm (0.62 in) apart about the centerline. Pin “3” (522) at the bottom is spaced 10.6 mm (0.42 in) below the centerline of the connector. Pins “4” and “5” (524, 526) in the middle row are spaced 5.6 mm (0.22 in) below the centerline of the connector, and the pins are spaced 21.3 mm (0.84 in) apart about the centerline.

Control Pilot Pin (22). Pin “3” 522 was implemented, in one embodiment, to provide a J1772 Pilot signal having a 1 khz+12V to −12V square wave in which the voltage defines the state. The control signal is provided to the electric vehicle charging system, which can pass the signal to the electric vehicle controller. The electric vehicle controller can adjust the resistance at its terminal to vary the control voltage as well as read the voltage and change state accordingly. FIG. 5D shows a schematic of an example interface 528 between an electric vehicle charging system and the vehicle controller. Table 4D shows example control states and signals employed between the electric vehicle charging system and the vehicle controller that may be controlled via pin 522.

TABLE 4D

| | Pilot | | Pilot | | | | EV | |
|---|---|---|---|---|---|---|---|---|
| State | High | | Low | | Frequency | | Resistance(Ω) | Operation |
| A | +12 | V | N/A | | DC | | N/A | Not |
| | | | | | | | | Connected |
| B | +9 | V | −12 | V | 1000 | hz | 2.74k | EV |
| | | | | | | | | Connected |
| C | +6 | V | −12 | V | 1000 | hz | 882 | EV Charge |
| D | +3 | V | −12 | V | 1000 | hz | 246 | EV Charge |
| | | | | | | | | (Vent. |
| | | | | | | | | Reqd.) |

| | | | | | | | |
|---|---|---|---|---|---|---|---|
| E | 0 | V | 0 | V | N/A | N/A | Error |

| | | | | | | |
|---|---|---|---|---|---|---|
| F | N/A | −12 | V | N/A | N/A | Unknown/ |
| | | | | | | Error |

It can be readily observed that modifying the internal design of the electric vehicle charging system to incorporate the algorithm's output and to modify the various connectors and pins can be complex and costly while introducing safety concerns. In contrast, by employing the networked relayed device described herein, the device can be readily and safely integrated with an existing electric vehicle charging system without SAE J1772 recommendations or adjustments. The networked relay device only affects power to the electric vehicle charging system and does not require additional control signals.

Relay and Relay Driver Board (510). The board 510 operatively connects to the relay 504 to control the connection/disconnection of a circuit based on a voltage/current input. Both electromechanical relays and solid state relays were considered for the power relay 504, and a solid-state relay was selected (part no. aJ115F31AH12VDCS61.5U relay). Table 4E provides details of the power relay 504.

TABLE 4E

| Mounting Type | Chassis Mount | |
|---|---|---|
| Coil Voltage | 12 | VDC |
| Contact Form | SPST-NO (1 Form A) | |
| Contact Rating (Current) | 50 | A |
| Switching Voltage | 277 VAC, 110 VDC - Max | |
| Coil Current | 125 | mA |
| Coil Type | Non-Latching | |
| Termination Style | Quick Connect - 0.187″/0.250″ | |
| Seal Rating | Sealed - Fully | |
| Must Operate Voltage | 9 | VDC |
| Must Release Voltage | 1.2 | VDC |
| Operate/release Time | 15/10 | ms |
| Operating Temperature | −55° C.~125° C. | |
| Coil Resistance | 96 | Ohms |

The relay board 510 was configured to drive the relay 504 with a 125 mA output using a buffer circuit positioned between the digital output pin of the microcontroller and the relay. In the prototype, a ULN2003AN Darlington transistor pair was employed as the relay driver that could provide up to 500 mA at 12 VDC. The relay board 510 was designed and fabricated as a 2-layer board with power and signal lines along with the components assembled on the TOP layer, and the BOTTOM layer includes the GND layer.

Microcontroller board 506. The microcontroller board 506 includes a microcontroller unit configured to receive communication over the internet (through Wi-Fi) and control the relay through its output port. The prototype hardware employed MSP432 MCU.

Relayed Network Device Software. FIG. 5E shows the main components of the software architecture for the system. The architecture includes an Android Mobile Application 540 (also referred to as “EcoCharge” app), real-time Microcontroller code 542, NodeJS server 544, Database Mongo 546, SmartCar API 548, and Python algorithm 550.

Android Mobile Application (App) 540 is configured to receive inputs from the user for the algorithms. In the prototyped system, the user can put the charger in manual mode (forcing the charger “ON” or “OFF”) or in auto mode executing the outputs from the optimization algorithm (550). The user can also set the time to leave and the required range in the app. Additionally, the user can set the weights for the cost, renewable energy, or time to charge weights.

FIG. 5F shows user interfaces for the system, e.g., as described in relation to FIG. 3B. In the user interface, the home screen of the EcoCharge app can receive the user's input for a preference (e.g., reduce cost, environmentally friendly, etc.) and corresponding input for the optimization, including time the user is not present at home, the desired minimum charge, and the charger's location. The user interface includes inputs for weights of the reduced cost parameters and environmentally friendly parameters employed in the algorithm, including for cost ($/kWh), weight for usage of renewable energy, and weight for time to charge.

The user interface also presents the vehicle state of charge information that can be acquired through the smart car service. The interface includes an “auto” button to invoke an update. In an initial setup, the user can log in to a smart car service using car manufacturer-provided credentials. The app can periodically ping the NodeJS server with the configuration set. The NodeJS server can return the car data to show on the app. FIG. 5G shows the message structure to call the postdata endpoint on the NodeJS server 544.

Microcontroller software (542): The prototyped employed an ARM-based microcontroller from Texas Instruments (Simplelink, part no. MSP-EXP432E401Y); the microcontroller includes MSP432 microcontroller and CC3120 network controller (for Wi-Fi support). The microcontroller receives commands through the CC3120 network controller over Wi-Fi. Each microcontroller has a unique ID controllerId. The microcontroller sends a GET request with the controllerId to the server, and the server then responds with a “ON” or “OFF” message corresponding to the relay ON or OFF.

Node JS Server (544). The server 544 was hosted on Microsoft Azure virtual machine, employing a javascript based web server NodeJS. The server 444 took in data from the Mobile App 540 and communicated with the “SmartCar” car data provider through the API 548 to get the current car status like battery %, battery capacity. Server 544 also ran the smart charging algorithm 550 when a charger requests a charge command and returns a ChargerON or ChargerOFF command to the charger (shown as “EVSE” 543).

Mongo DB server (546). MongoDB 546 was used to store data, including app configuration, car data, and car-controller-app relation. FIGS. 5H and 5I show example tables maintained in the server 546 for the app configuration and car data.

SmartCar API (548). The prototyped system can interface with a third party service (SmartCar) that interacts with vehicles from different manufactures and allows a single API to get data from them. It directly connects to the car manufacturer's connected car services. To interface to the third part service, the Client ID and Redirect URI can be m inserted at the (i) Android App: in strings.xml file (after :// in Redirect URI forms the ‘hostname’ in the strings.xml; in this case it is ‘exchange’) and (ii) NodeJS server: in SERVER.env file.

Python algorithm: The optimization algorithm was implemented in Python and was configured to report charging times for any two slots (start time and end time) given an initial state of charge (SOC), final SOC, and weights for grid pricing, grid mix, and time to charge. FIG. 5J shows example outputs 566 of the algorithm for a given price of electricity data 568a, expected household load 568b, estimated grid mix 568c, the total load on the grid 568d, and measured energy in vehicle battery 568e.

Functional Validation Test. The study performed a set of validation test of the hardware, including a hot-plug relay contact settling test, a full function test, and a live test.

FIGS. 5K and 5L show measured results for the hot-plug relay contact settling test that was performed to confirm the relay could reliably toggle the circuit in presence of AC power. Specifically, FIG. 5K shows the contact settling time (around 3.11 us), and FIG. 5L shows the corresponding voltage oscillation.

FIG. 5M shows the measured results for a full function test that was performed to confirm the charging algorithm could reliably compute and communicate with the MCU and that power transfer occurs in a controlled manner. FIG. 5M shows the AC output from the networked relay device. A live test was performed to verify the system operation under nominal conditions using a user-controlled input to the system. In the test, a networked relay device was connected to an AC outlet; wifi-connection was confirmed to be established. The test confirmed that a test vehicle was charging based on the input provided via the app.

### Grid-Favorable Algorithm Impact Study

The study evaluated the grid impact of the grid-favorable smart charging operation for a set of radially-connected neighborhoods of N=20 homes, each configured to independently solve its own instance of Equation 3. The study evaluated the aggregate load of all 20 homes to assess the power flow through a high-capacity underground distribution transformer. The aggregate power drawn from the grid by the collection of N homes is defined per Equation 15a.

$${P}_{agg}^{G} [ t ] = {\sum }_{n = 1}^{N} {P}_{n}^{G} [ t ] \qquad ( Eq . 15 a )$$

In Equation 15a.

$${P}_{agg}^{G} [ t ]$$

was compared against the (uncontrollable) aggregate household power demand defined by Equation 15b.

$${\hat{P}}_{agg}^{H} [ t ] = {\sum }_{n = 1}^{N} {\hat{P}}_{n}^{H} [ t ] \qquad ( Eq . 15 b )$$

In Equation 15b,

$${\hat{P}}_{n}^{H} [ t ]$$

denotes the estimated household power demand of home n of N. R is the ratio between the peak values of

$${P}_{agg}^{G} [ t ] and {\hat{P}}_{agg}^{H} [ t ]$$

and is defined by Equation 15c.

$$R \text{:} = \frac{{max}_{t} {P}_{agg}^{G} [ t ]}{{max}_{t} {\hat{P}}_{agg}^{H} [ t ]} \qquad ( Eq . 15 c )$$

In Equation 15c, R captures the increase in peak demand seen by the grid (at the neighborhood level) due to battery charging activity.

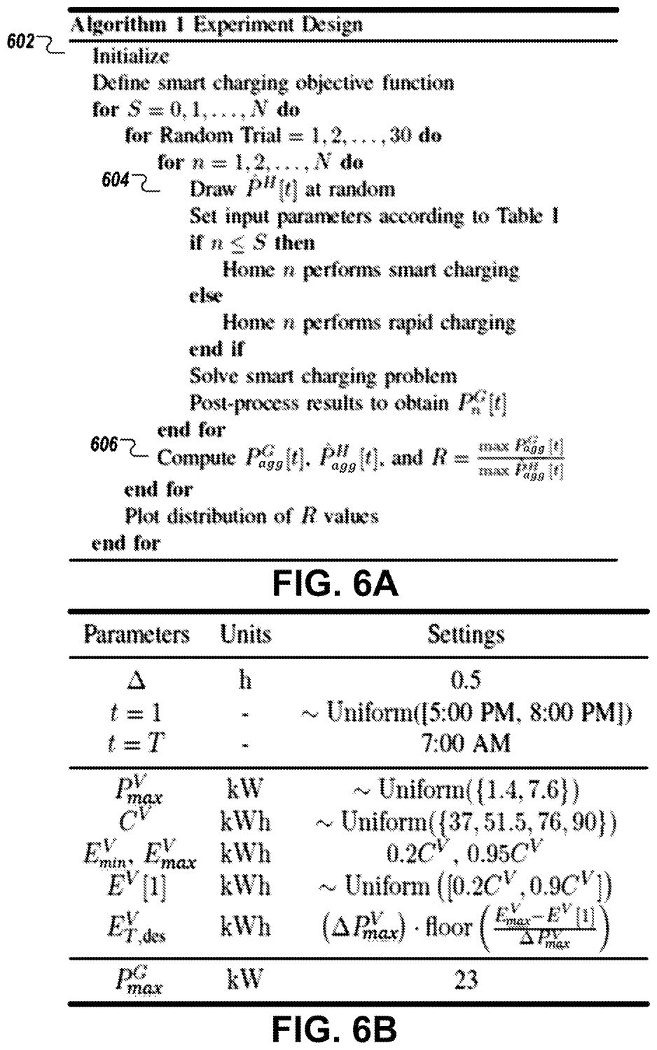

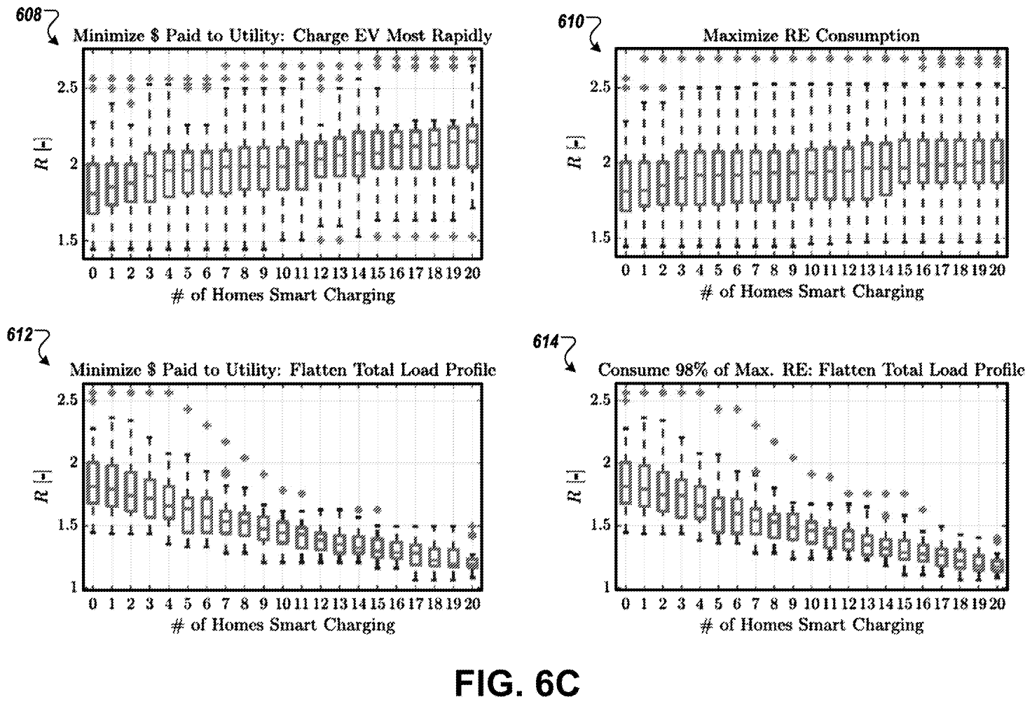

The study used uniform distributions to provide for the greatest variability in randomly-generated values. To simplify the study, a definition of smart charging was imposed (i.e., price minimization or renewable energy maximization), and each home was given the option to either participate in smart charging or perform conventional, rapid charging. The effect of participation in SC (within the neighborhood) on R, subject to the sources of randomness, is examined in FIG. 6B.

The design of the random experiment is given in Algorithm 1 shown in FIG. 6A and is compared to established designs for uncoordinated charging [4″]. In FIG. 6A, the algorithm initialize (602) using π[t] and m[t] from a published source. Each home is simulated to draw a random aggregated power demand, \hat{P}^{H}[t]. The parameters are then employed (506) to calculate the smart charging profiles of Equations 15a-15c.

Each home in the neighborhood receives the same pricing and grid mix information from the utility but is free to either perform smart charging or not. Additionally, each home has different smart charging input parameters. The input parameters were randomly assigned for each home in the simulation per the range provided in FIG. 6B.

In each of the four panels of 5C, a distribution of R values is plotted against the number of homes participating in SC, where each entry in the distribution corresponds to a random trial with different settings of the input parameters Table I. In FIG. 6C, the results (608, 610, 612, 614)) are shown for four runs of the randomized grid impact study. The plots show the distribution of R values versus the participation in the smart charging operation for four runs of the random experiment. The plots also show the distributions in box plots in which the horizontal lines represent the median value, boxes represent the interquartile range (IQR), “-” lines mark the maxima and minima that are not outliers, and + signs mark outliers. Data points are deemed to be outliers based on the IQR, using decision rules. The distributions associated with 0 homes performing smart charging are identical in all four panels and correspond to all 20 homes performing conventional, rapid charging.

FIG. 6C shows, in plot 608 and 612, each home that participates in SC seek to minimize J₁ (J₂) alone. In plot 508, each participating home chooses the optimal solution which charges its EV the fastest (strictly minimizes J₂). As more homes participate in these forms of smart charging, the charging activity tends to concentrate in time, resulting in an upward trend in the median value of R, along with consistently high variability in R. In plot 612, each participating home chooses the optimal solution which maximally flattens its grid-demand profile. In plot 614, each participating home nearly minimized. J₂ by choosing ε=0.02 (i.e., each home is willing to forgo up to 2% of its renewable energy consumption). As more homes participate in these forms of smart charging, the charging activity tends to distribute in time, resulting in downward trends in the median value and variability of R.

Plot 608 shows that TOU pricing alone may not be an effective way to reduce peak demand in a neighborhood. Plot 610 shows that if many consumers are interested in maximizing renewable energy consumption, peaks in the neighborhood load profile can be expected. Furthermore, the peaks can be expected to be comparable to, if not more severe than, a conventional charging scenario. However, by slightly altering the smart charging algorithm, peak demand may be effectively reduced (as shown in plots 612 and 614) and infrastructure upgrades can potentially be deferred or avoided.

### Decentralized Smart Charging of Electric Vehicles in Residential Settings: Algorithms and Predicted Grid Impact Study

The study also evaluated the smart charging algorithm for single electric vehicles (EVs) located in a single-family home and its role in enabling higher EV penetration levels. The algorithm in the study enables (i) EV owners to obtain a multitude of benefits by performing smart charging and (ii) the power utility to simultaneously obtain benefits that may serve to enable higher EV penetration levels without infrastructure upgrades. Conclusions are supported by a high-fidelity, physics-based assessment of the grid impact of EV charging in a residential area (where most EV charging occurs).

The study evaluated a two-stage smart charging (SC) algorithm for single electric vehicles (EVs) located in single-family residences. In the first stage, an SC optimization problem was posed, considering only the EV owner's interests. In the second stage, the study leveraged non-uniqueness in the set of optimal (near-optimal) solutions to this optimization problem to reduce the grid impact of EV charging at no (negligible) cost to the EV owner. The study then considered a residential area comprised of single-family homes and studied the grid impact of EV adoption under both existing and new SC strategies, where all EVs are controlled in a decentralized manner (i.e., independently of one another). Grid impact was studied using Monte-Carlo simulation and a physics-based distribution feeder model-voltage drop and transformer overloading were the chosen measures of grid impact. The scope of the simulation study was limited to variations on the price-minimization SC problem. The two-stage SC algorithm of the study was used to simulate the behavior of existing commercially-available SC products, as well as new control strategies. It was shown that (i) if existing SC strategies are employed, then SC can have the same undesirable effects as uncoordinated, rapid charging, and (ii) if our proposed SC strategies are employed, then SC can significantly lower the grid impact of EV adoption (at no additional cost to the EV owner).

The results of the study are significant because they indicate that neither (i) large-scale (i.e., involving many EVs) coordinated SC schemes nor (ii) capital investments in infrastructure updates may be required in order to support increasing EV adoption. Such control schemes certainly have benefits, as documented in the literature, but inherently require (i) the solution of large optimization problems and detailed grid modeling and (ii) high participation levels (without clear incentives) from EV owners in order to work well in residential areas, where most EV charging activity presently occurs. In contrast, the instant approach can be implemented requiring only the solution of comparatively (much) smaller optimization problems, no detailed grid modeling, and provides direct benefits to EV owners and, therefore, clear incentives for participation.

It is contemplated that as more data becomes available on EV charging behavior (e.g., arrival times, energy use between charging sessions), the generic simulator can be used with updated parameters to provide more refined grid impact analyses. Furthermore, distributed generation (e.g., solar panels) and energy storage (both grid-connected and in-home) can be incorporated. Finally, household power consumption may be made to be controllable. is viewed as uncontrollable in this work, but the control of high-power household appliances (e.g., heat pumps, electric water heaters) is also an active area of research. Our SC problem can be readily augmented to account for multiple controllable loads (e.g., appliances or even multiple EVs).

Introduction. Market penetration of electric vehicles (EVs) is rising due to increasing environmental awareness, decreasing vehicle costs, regulatory pressures, and tax incentives. A corresponding increase in uncontrolled EV charging is expected to exacerbate the evening surge in power demand, degrade power quality, and overload transformers in distribution networks. This concern has spurred the development of smart charging (SC) strategies, which optimally distribute EV charging over time so as to realize benefits for the grid operator and/or the EV owner (based on the chosen optimality criterion). According to a 2021 analysis by BloombergNEF, EV owners across the U.S., U.K., and Europe perform over 80% of their charging overnight, at home, where most EVs remain plugged in throughout the night. However, most EVs will not be charging for this entire time, so an opportunity exists to distribute charging activity over time. Thus, in this paper, we (i) propose SC strategies for individual EVs in a residential area and (ii) evaluate the grid impact of the proposed SC strategies in the common case of overnight charging.

Academic studies on SC largely emphasize the mitigation of the aforementioned grid-level issues. The dominant approach is to pose SC problems (involving multiple EVs) where grid constraints (e.g., bounds on power flows and/or voltage fluctuations) are enforced, and the objective function favors the grid operator (e.g., minimize operating cost or distribution circuit losses, flatten aggregate load profile, maximize a measure of power quality). Alternatively, the studies used objective functions that favor EV owners (e.g., minimize average charging cost or maximize a measure of fairness) while still enforcing grid constraints. In contrast to the literature, consumer products focus on providing benefits to EV owners without any consideration of grid-level issues. For example, many in-home charging stations and EVs allow for delayed or scheduled charging to take advantage of time-of-use (TOU) electricity pricing. In the inventor's work (“Electric vehicle smart charging to maximize renewable energy usage in a single residence,” IECON 2021) and (Grid-favorable, consumer-centric, on/off smart charging of electric vehicles in a neighborhood,” IEEE Vehicle Power and Propulsion Conference) comprehensively treats SC from the EV owner's perspective, with secondary consideration of grid-level issues.

In many reported papers, charging profiles for all EVs are jointly determined by an aggregator. However, a crucial and largely-unaddressed question is whether or not an aggregator should have the authority to determine how each EV charges. Several studies take place in commercial settings, such as EV parking lots where EV owners pay a lot operator (the aggregator) per consumed. Here, the aggregator's authority to control EV charging (e.g., to maximize their profit, or to provide grid services) would likely not be objected to. However, the same control authority appears to be the grid operator. Here, EV owners would need to explicitly provide authority (e.g., by participating in a demand response program), but the incentives for doing so are not obvious. Furthermore, the effectiveness of any smart charging strategy in residential settings depends strongly on participation levels.

Reporting and evaluation of grid impact vary greatly across the SC literature. Some studies employ physics-based distribution feeder models to assess grid impact using voltage drop or transformer overloading as metrics, while others do not, instead using aggregate load as a measure of grid impact. For any grid impact metric, computed values will be sensitive to the settings of key parameters, such as EV plug-in time and EV state of charge. Since these quantities are linked to human behavior, it is typical to draw them from assumed distributions. However, in all but one of these studies, key parameter values are randomly drawn one time, and nominal values of grid impact metrics are reported. In one instance, there appears to be an exception in which the key parameter values are randomly drawn multiple times, and distributions of grid impact metrics are reported. Distributions reveal typical values of a grid impact metric, as well as sensitivity to variations in key parameter values, and therefore present a more complete assessment of grid impact. This style of analysis is dominant and well-documented in the literature on uncoordinated, conventional charging (not SC).

The instant study differs from the above in that no aggregator with control authority is employed. Instead, the instant study emphasized SC problems for individual EVs wherein all EVs are controlled in a decentralized manner (i.e., independently of one another). Consequently, our method requires less computation (information exchange) than centralized (distributed) SC algorithms for jointly controlling multiple EVs.

The instant study employed a two-stage SC algorithm that accounts for the interests of both EV owners and the grid operator. In the approach of the study, EV owners are the primary beneficiaries of SC, and the grid operator receives secondary benefits. The instant study leveraged multiple optimal (near-optimal) solutions to the SC problem to provide benefits to both parties such that the EV owner experiences no (little) degradation in their chosen performance measure. Consequently, the SC algorithm of the instant study has two advantages over methods in the literature: (i) the method of the study requires neither grid modeling nor enforcement of classical grid constraints (at remote locations in the feeder), yet the case study results indicate that the method of the study may result in the grid's operating limits being met (performance claim is subject to simulation assumptions); and (ii) incentives for EV owners to opt-in to the operation scheme of the study are clear, since EV owners are the primary beneficiaries of SC.

The instant study also differs from the above in that the analysis of grid impact relies on established methods but is more comprehensive than in reviewed works. Most importantly, our results are presented as a function of participation or SC adoption, which is a critical and often-discounted parameter impacting the effectiveness of SC strategies in residential settings. Additionally, our analysis considers additional randomly-drawn key parameters with respect to related works, namely EV battery capacity and EV charging power. The instant study differs from the above in that both the SC algorithm and grid impact analysis in this study differ significantly from other work.

Two-Stage Smart Charging Algorithm. The instant study employs an SC algorithm that determines charging behavior for a single EV in a grid-connected home.

The SC algorithm determines P^{V}[t], the power flow into the EV battery at each of T−1 sampling instants: t=1, . . . , T−1. Thus, the set of decision variables can be collected into P^{V}:=[P^{V}[1] . . . P^{V}[T−1]]′∈ [symbol] ^{[T-1]}.

This choice of decision variables is motivated by the capability of commercial battery power converters to accept time-varying (dis)charging power commands. These power converters also hold power flows constant (for Δ units of time) between successive sampling instants. An SC session can begin at time t=1 or later but ends at time t=T.

Implementation Vision and Data Requirements. The study assumed that the power utility broadcasts a time-of-use (TOU) price signal, π[t], to disincentivize EV charging at times of high load. Several utilities in the United States currently broadcast two-level TOU price signals of the form:

$$π [ t ] = \{ \begin{matrix}{π}_{1} , & if t is a peak time \\ {π}_{2} , & if t is an off - peak time\end{matrix}$$

where π₁>π₂. TOU price signals are also predominantly flat and usually contain only two changes in value (to designate evening hours as peak times and other times as off-peak times). Three-level and four-level TOU price signals also exist. TOU price signals are usually published by the utility once every few months (e.g., once in summer, once in winter).

The study also assumed that the electric power utility broadcasts a grid mix signal, m[t], in order to encourage EV charging when renewable energy resources are producing energy. TUtilities track the power output from each generator in their portfolio over time. Using this data, the fraction of power generated from renewable sources (at a given time) can be computed—the study defined this as the grid mix:

$$m [ t ] \text{:} = \frac{Power from renewable sources at time t}{Power from all sources at time t} ∈ [ 0 , 1 ] .$$

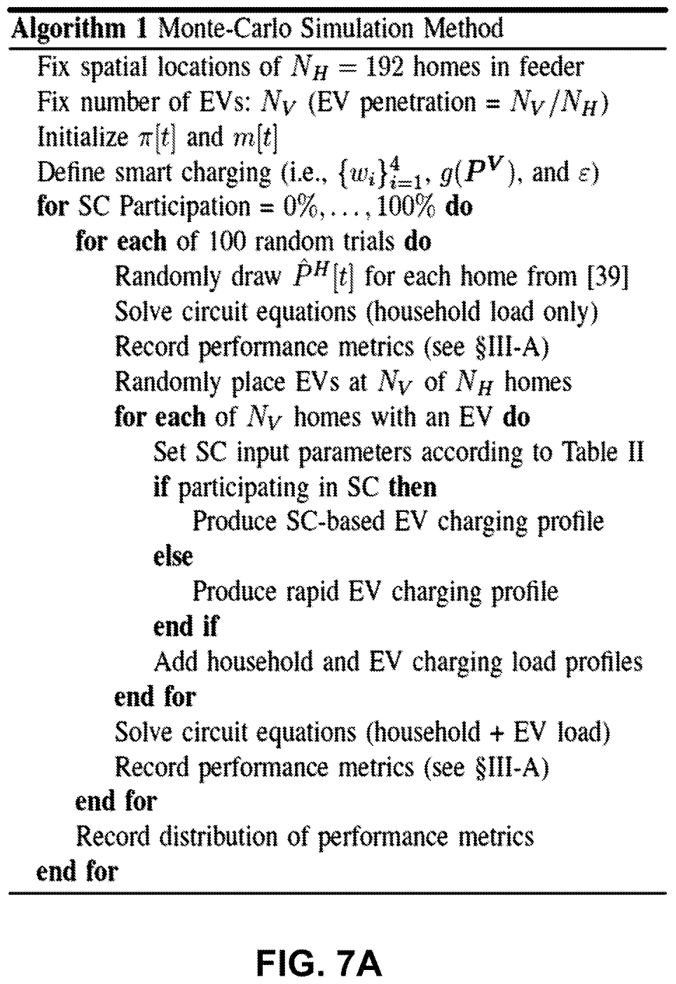

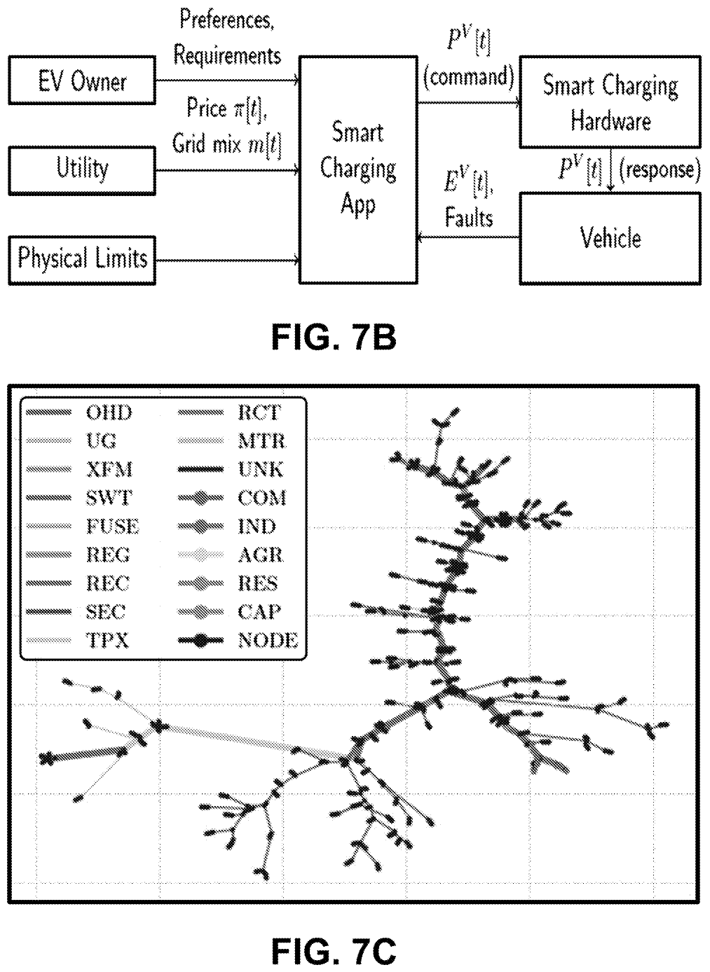

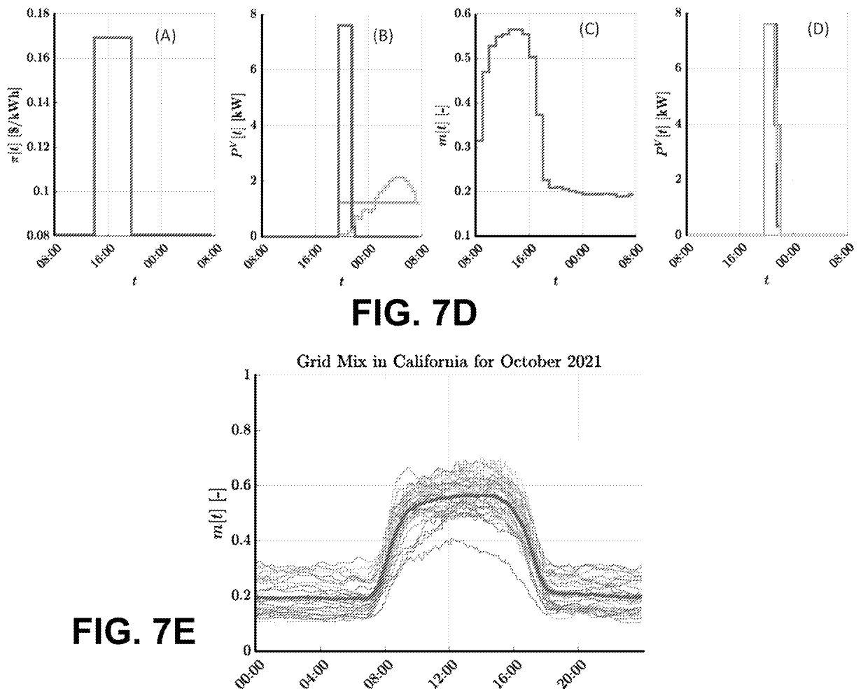

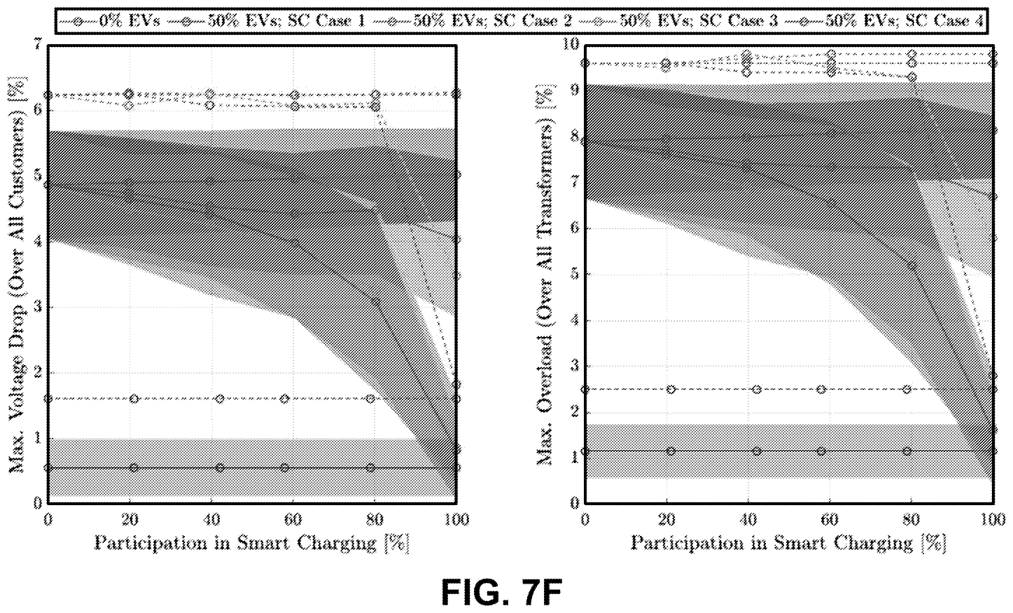

Generator output data for the State of California was publicly available and was processed to generate FIG. 7E, which shows California's grid mix signal for each day in October 2021. Specifically, FIG. 7E shows (in thin lines) an example Grid mix (fraction of power generated from renewable sources) in California for each day in October 2021. Thick blue line: average grid mix for October 2021. It can be observed that the peak around mid-day is attributable to California's significant investment in solar generation. The utility might prefer to broadcast an averaged grid mix signal once every few months instead of broadcasting a new future projection every day. Both TOU price and grid mix signals can be broadcast using the same communication infrastructure.

In addition to receiving π[t] and m[t] from the utility, the study anticipated that an SC implementation could obtain an EV owner's (i) preferences, encoded by weights

$${\{ {w}_{i} \}}_{i = 1}^{4}$$

(e.g., as described herein); (ii) charging requirements captured by scalars

$${E}_{T , min}^{V} and {E}_{T , max}^{V}$$

(subscript T refers to terminal time t=T); and (iii) arrival/departure times. The weights may be obtained by interaction with the EV owner via a user interface, while charging requirements and arrival/departure time may be set in a (partially) automatic manner. Furthermore, the SC implementation may interact with the electric vehicle to obtain the current battery state, E^{V}[t], and would be informed by an estimate of the estimated power flow into the home \hat{P}^{H}[t], as well as all relevant physical limits on power flows and energy levels (from datasheets, labels, etc.). FIG. 7B shows an example SC implementation in block diagram form developed for the study.

Stage 1: Consumer-Centric Optimization. The first stage of the SC algorithm can determine an optimal EV charging profile from the EV owner's perspective. The

$${\{ {J}_{i} \}}_{i = 1}^{4}$$

are a collection of performance functionals representing various (potentially competing) interests of an EV owner, and user-defined weights {wᵢ}ᵢ₌₁⁴ that encode the relative importance of the

$${\{ {J}_{i} \}}_{i = 1}^{4} .$$

J₁ has units of dollars and represents the contribution of EV charging to the EV owner's electricity bill. J₂ has units of, and represents the amount of non-renewable energy consumed in EV charging. J₃ (J₄) encourages rapid (slow) charging but does not have physically meaningful units. Both J₃ and J₄ are provided to modify the rate of charging, since w₃=0 (w₄=0) does not necessarily result in slow (fast) charging.

The optimization problem solved in Stage 1 is:

$${minimize}_{{P}^{V}} {\sum }_{i = 1}^{4} {w}_{i} {J}_{i} ( {P}^{V} ) \qquad ( Eq . 16 )$$

subject to equality constraints, inequality constraints, and boundary conditions where

$${J}_{1} ( {P}^{V} ) = Δ {\sum }_{t = 1}^{T - 1} π [ t ] {P}^{V} [ t ] , {J}_{2} ( {P}^{V} ) = Δ {\sum }_{t = 1}^{T - 1} ( 1 - m [ t ] ) {P}^{V} [ t ] ,$$

$${J}_{3} ( {P}^{V} ) = {\sum }_{t = 1}^{T - 1} {tP}^{V} [ t ] , and {J}_{4} ( {P}^{V} ) = {\sum }_{t = 1}^{T - 1} {( {P}^{V} [ t ] )}^{2} .$$

The equality constraints enforced at t=1, . . . , T−1 may include (i) P^{G}[t]=P^{V}[t]+\hat{P}^{H}[t] and (ii) E^{V}[t+1]=E^{V}[t]+ΔP^{V}[t]. The inequality constraints enforced at t=1, . . . , T−1 may include

$${P}_{min}^{G} \leq {P}^{G} [ t ] \leq {P}_{max}^{G} , \qquad ( i )$$

$${P}_{lb}^{V} [ t ] \leq {P}^{V} [ t ] \leq {P}_{ub}^{V} [ t ] , and \qquad ( ii )$$

$${E}_{min}^{V} \leq {E}^{V} [ t ] \leq {E}_{max}^{V} , \qquad ( iii )$$

where, using the definition [symbol] :={t:EV plugged in},

$${P}_{l b}^{V} [ t ] := \{ \begin{matrix}{P}_{min}^{V} , & t ∈ 𝒫 \\ 0 , & t ∉ 𝒫\end{matrix} , {P}_{ub}^{V} [ t ] := \{ \begin{matrix}{P}_{max}^{V} , & t ∈ 𝒫 \\ 0 , & t ∉ 𝒫\end{matrix} .$$

The boundary conditions at t=1 and t=T include (i) E^{V}[1] is known/measured, and

$${E}_{T , min}^{V} \leq {E}^{V} [ T ] \leq {E}_{T , max}^{V} .$$

Finally, to ensure feasibility,

$$0 \leq {E}_{min}^{V} \leq {E}_{T , min}^{V} \leq {E}_{T , max}^{V} \leq {E}_{max}^{V} , and {E}_{T , min}^{V} - {E}^{V} [ 1 ] \leq Δ \vert 𝒫 \vert {P}_{max}^{V} .$$

In general, the optimization problem (Eq. 16) solved in Stage 1 is a quadratic program (QP), which can be expressed in the following standard form:

$${minimize}_{{P}^{V}} {w}_{4} {‖ 2 ‖}_{[} ] {P}^{{V}^{2}} + {f}^{′} {P}^{V} subject to {AP}^{V} \leq b ,$$

where f, A, and b depend on the weights and input data, and ′ denotes the matrix transpose operation. If w₄>0, then (1) is a strictly convex QP, and therefore has a unique solution. If w₄=0, then (1) is a linear program (LP) and potentially admits multiple optimal solutions, depending on the nature of f. Furthermore, if multiple optimal solutions exist, then they are infinite in number. Specifically, suppose that the optimization problem (Eq. 16) is an LP (w₄=0), and that P_{*}^{V} is a global minimizer, i.e. P_{*}^{V}=argmin_{P}_{^{v}}f′P^{V} subject to AP^{V}≤b. Let J_{*}=f′P_{*}^{V}. If there exists any y∈null(f′) such that A(P_{*}^{V}+y)≤b, then for any α∈[0,1], P_{*}^{V}+αy is also an optimal solution to the SC problem since f′(P_{*}^{V}+αy)=J_{*}.

Cases where the optimization problem (Eq. 16) is an LP with infinitely many solutions can be distinguished by the ‘richness’ of the set of optimal solutions [symbol] ={P^{V}:f′P^{V}=J_{*}}. Conceptually, [symbol] becomes richer as the number of unique entries in f decreases (equivalently, as the number of time slots of equal cost increases). This is illustrated in FIG. 7D by comparing (i) the case where the optimization problem (Eq. 16) reduces to price minimization (w₁>0, w₂=w₃=w₄=0), wherein [symbol] is rich because the entries of f are given by π[t]; and (ii) the case where the optimization problem (Eq. 16) reduces to renewable energy maximization (w₂>0, w₁=w₃=w₄=0), wherein [symbol] is not rich because the entries of f are given by m[t]. Note that while the EV is plugged in (7:00 PM-8:00 AM) in FIG. 7D, both π[t] and m[t] appear flat. However, π[t] takes on precisely one value, resulting in multiple time slots of equal cost, whereas m[t] takes on multiple distinct (but similar) values, resulting in very few time slots of equal cost.

In FIG. 7D, Left to right shows in (subpane A) TOU price signal π[t], (subpane B) multiple optimal solutions to (Eq. 16) when w₁>0 and w₂=w₃=w₄=0, (subpane C) grid mix signal m[t], and (subpane D) multiple optimal solutions to (1) when w₂>0 and w₁=w₃=w₄=0. Flatness in π[t] gives rise to a diverse set of optimal solutions in (ii); lack of flatness in m[t] gives rise to a set of similar optimal solutions in subpane D. All scenarios shown use the same EV plug-in time (7:00 PM), EV departure time (8:00 AM), EV charging requirements, etc.

Stage 2: Solution Refinement. When (Eq. 16) admits multiple optimal solutions, the solution produced by an iterative solver in Stage 1 may depend on the initial guess provided. Rather than accepting this solution, the system of the study is devised to explicitly choose one of many optimal solutions. When (Eq. 17) has a unique solution, or a set of optimal solutions that is not rich, it can be advantageous to sacrifice some optimality, and choose from a set of near-optimal solutions. Both of these problems are special cases of the Stage 2 optimization problem:

$${minimize}_{{P}^{V}} g ( {P}^{V} ) subject to \{ \begin{matrix}{AP}^{V} \leq b \\ {w}_{4} {‖ {P}^{V} ‖}_{2}^{2} + {f}^{′} {P}^{V} \leq ( 1 + ε ) {J}_{*}\end{matrix} , \qquad ( Eq . 17 )$$

where

$${J}_{*} = {w}_{4} {‖ {P}^{V} ‖}_{2}^{2} + {f}^{′} {P}^{V} subject to {AP}^{V} \leq b$$

is the minimum objective value from Stage 1, ε is a relaxation parameter (with 0≤ε<<1), and g: [symbol] ^{[T-1]}]→ [symbol] is a selection criterion. For any P^{V} satisfying AP^{V}≤b, it is always true that

$${w}_{4} {‖ {P}^{V} ‖}_{2}^{2} + {f}^{′} {P}^{V} \geq {J}_{*} .$$

Thus, ε bounds the level of suboptimality accepted in Stage 2, if any; ε is the maximum allowable increase in the objective from Stage 1.

Selection criterion g may be chosen in many ways. Some choices may benefit the EV owner, others may benefit the utility (and others may benefit neither). Four possible options are presented for g, of which one option favors EV owners, and three options favor the utility. Since only the perspective of EV owners was considered in Stage 1, the utility's perspective is emphasized in Stage 2 with the goal of producing SC strategies that benefit EV owners while also reducing the need for capital investments in infrastructure updates.

Two of our four options for g are of the form:

$$g ( {P}^{V} ) = {\sum }_{t = 1}^{T - 1} c [ t ] {P}^{V} [ t ] ,$$

and are distinguished by the choice of c[t] as follows:

$$c [ t ] = \{ \begin{matrix}t , & Case 1 \\ mod ( t + d , T - 1 ) , & Case 2\end{matrix} .$$

In Cases “1” and “2,” the (unique) solution to (Eq. 17) can be found by (i) considering time slots one at a time, in increasing order of c[t] (i.e., argminₜ{c[t]} first, argmaxₜ{c[t]} last), and (ii) setting P^{V}[t] as large as the constraints permit (which is zero if the EV is not plugged in or if the battery is full). In Case “1”, c[t] is a monotonically increasing sequence. This choice can encourage charging at the maximum-available power, beginning as soon as the EV plugs in. In Case “2”, c[t] is obtained by circularly shifting a monotonically increasing sequence; parameter d determines the shift direction and amount. This choice also encourages charging at the maximum-available power, but now beginning at a time after plug-in, if d is set such that the minimum value of c[t] occurs after the plug-in time. Case “1” would favor the EV owner but tends to concentrate charging activity in residential settings, even though each home solves its own instance of the SC problem, giving rise to undesirable spikes in power demand. Case “2” is more grid-favorable and provides a simple way to distribute charging activity over time. However, this effect is only achieved when the set of (near) optimal solutions to (Eq. 16) is rich. Therefore, Case “2” is not generally applicable, unlike Cases “1,” “3,” and “4.” Nonetheless, Case “2” represents the capabilities of several commercially-available SC products which minimize charging costs given a TOU price signal. As shown in FIG. 7D, this problem has a rich set of optimal solutions due to the flat nature of today's TOU price signals.

The remaining two options for g are of the form:

$$g ( {P}^{V} ) = {\sum }_{t = 1}^{T - 1} {( {P}^{V} [ t ] - {P}_{ref} [ t ] )}^{2} ,$$

wherein a reference profile shape P_{ref}[t] is introduced. The quadratic form encourages P^{V}[t] to take on the same temporal shape as P_{ref}[t] (i.e., it evenly distributes errors over time). P_{ref}[t] may be chosen to favor the EV owner or the utility. However, we restrict our attention to

$${P}_{ref} [ t ] = \{ \begin{matrix}random number , & Case 3 \\ - {\hat{P}}^{H} [ t ] , & Case 4\end{matrix} .$$

Case “3” represents a simple way to avoid the high-power pulses produced in Cases “1” and “2.” Furthermore, in a residential setting (where each home solves its own instance of the SC problem), the peaks and valleys in each EV charging profile are randomly determined, so it can be expected that the aggregate EV charging profile is approximately flat in time. Case “4” also avoids high-power pulses and explicitly flattens each home's total power demand profile (P^{G}[t]=P^{V}[t]+\hat{P}^{H}[t]). Therefore, in a residential setting, it can be expected that aggregate demand profile (homes+EVs) is approximately flat in time.

The choices of g(P^{V}) in Case “3” and Case “4” are grid-favorable while also benefiting the EV owner when the utility levies demand charges. For example, for the current policies in the state of Georgia, the demand charge is proportional to the maximum amount of energy (in) consumed by a home over any one-hour period in a month. It may not be immediately obvious that a flattening objective actually reduces the peak demand. However, when a net energy transfer requirement is imposed, this is indeed true.

Finally, for Cases “1”-“4”, the solution to (Eq. 17) is always unique. For Cases “1” and “2,” uniqueness comes from the fact that if P_{*}^{V} is an optimal solution, [symbol] y∈null([c[1] . . . c[T−1]]) such that A(P_{*}^{V}+y)≤b, so there cannot exist a second optimal solution to (Eq. 17). For Cases “3” and “4,” uniqueness comes from the fact that g(P^{V}) is a strictly convex function, and the constraint set of (Eq. 17) is also convex (even for w₄>0).

Grid Impact Analysis—Distribution Feeder Model and Performance Metrics. The basic requirements for grid impact analysis are (i) a physics-based model of a power distribution circuit, called a feeder; and (ii) a numerical method to solve the circuit equations governing feeder behavior. Ideally, a model of a real feeder would be used. However, models of synthetically generated feeders called ‘test feeders’, are typically used in public-facing research, as disclosing actual feeder details can pose a significant security risk. Test feeder models have been made available by multiple institutions, including IEEE, Pacific Northwest National Lab (PNNL), and others. For this study, test feeder R2-12.47-2 (produced by PNNL) was selected. Furthermore, an updated set of circuit parameter values (produced by Battelle) were used.

Feeder R2-12.47-2 is a three-phase, unbalanced system that is representative of a moderately populated suburban area composed mainly of single-family homes. The feeder model is depicted in FIG. 7C and includes several elements, including overhead (OHD) and underground (UG) transmission lines, transformers (XFM), switches (SWT), fuses (FUSE), voltage regulators (REG), and capacitors (CAP). Power is transmitted at 12.47 kV and stepped-down by one of 161 residential transformers before entering homes. The feeder contains 192 nodes (NODE) at which loads may be connected to any of three phases (thus, there are 576 possible connection points for single-phase loads).

Multiple tools exist for solving the circuit equations associated with a feeder; OpenDSS was used in this study. At each time t=1 to T−1, the active power draw of each load in the feeder is supplied to OpenDSS, which then solves the circuit equations. During the solution process, OpenDSS also accounts for automatic control actions occurring in the feeder. Our feeder contains voltage regulators (REG) at pre-specified locations, which are implemented using tap-changing transformers, where the transformer turns ratio is automatically modulated (within physical limits) with the goal of keeping voltage levels to within +5% of their nominal values. The feeder also contains capacitors (CAP) at pre-specified locations, which get connected at a node if the current flow in adjacent transmission lines exceeds a pre-specified threshold value (for a pre-specified amount of time). The solution produced by OpenDSS includes: (i) power flows through each transmission line, (ii) power flows through each transformer, and (iii) voltage magnitudes at each node (for all three phases).

Comparing these quantities with the respective physical limits yields the performance metrics used for grid impact analysis: “Metric 1” Worst-case voltage drop seen by a customer and “Metric 2” Worst-case overloading of any transformer.

Monte-Carlo Simulation Method. A Monte-Carlo simulation was conducted to reveal the grid impact of uncoordinated EV charging and of the SC strategies of the study in a residential setting where each EV's charging behavior is determined independently from all others. The design of the simulation is given in Algorithm (FIG. 7A) and is based on established designs from the literature on uncoordinated charging.

Spatial locations of household loads: The feeder has 576 possible connection points for single-phase loads, of which we randomly select 192 to place homes (without replacement).

EV penetration level: For the study, an EV penetration level of 50% was employed to evaluate both (i) issues associated with large EV penetrations and (ii) the benefits of the instant SC strategies.

TOU price and grid mix signals: Tt [t] and m[t] were set and broadcast to all homes.

Definition of smart charging: To limit the scope of this study, we impose a single definition of SC by setting

$${\{ {w}_{i} \}}_{i = 1}^{4} , g ( {P}^{V} ) ,$$

and ε the same for all homes that perform SC. Each home with an EV independently chooses whether or not to perform SC, but all homes that opt to perform SC use the following definition in Table 5A.

TABLE 5A

| | |
|---|---|
| Stage 1 | Perform price minimization (w₁ > 0, w₂ = w₃ = w₄ = 0) |
| Stage 2 | Choose among the many optimal solutions in Stage 1 |
| | (i.e., ε = 0) |

The simulation in Algorithm (FIG. 7A) was run four times, each time using a different setting for g(P^{V}) (still common to all homes that perform SC), corresponding to Cases “1”-“4” discussed above. Price minimization is the most common SC objective considered across literature and consumer products.

Settings of human-influenced parameters. It can be observed that grid impact results were sensitive to the choices of several parameters, which, in turn, was influenced by human decision-making. To try to generalize conclusions beyond particular choices of these human-influenced parameters, the study conducted several random trials, randomly setting these parameters each time, as stated below. The goal of the simulation was to evaluate the influence of participation in SC on the two grid impact performance metrics. Thus, at each participation level (i.e., number of EVs that opt for SC over rapid charging), the study conducted 100 random trials, wherein, on each trial: (i) PH [t] is drawn at random for all 192 homes, (ii) an EV was placed at a random subset of the homes (the number of EVs placed is dictated by the fixed penetration level), and (iii) for each EV, parameters that dictate its charging behavior are set according to Table 5B.

TABLE 5B

| Parameters | Units | Settings |
|---|---|---|
| C^{V} | kWh | ~ Uniform({37, 51.5, 76, 90}) |
| ${E}_{min}^{V} , {E}_{max}^{V}$ | kWh | 0.2C^{V}, 0.95C^{V} |
| E^{V}[1] | kWh | ~ Uniform ([0.2C^{V}, 0.9C^{V}]) |
| ${E}_{T , min}^{V} , {E}_{T , max}^{V}$ | kWh | $0.9 {C}^{V †} \cdot {E}_{max}^{V}$ |
| Δ | h | 0.5 |
| tₐᵣᵣᵢᵥₐₗ | — | ~ Uniform([5:00, 8:00] PM) |
| E^{V} plugged in | — | tₐᵣᵣᵢᵥₐₗ to 7:00 AM |
| ${P}_{min}^{V} , {P}_{max}^{V}$ | kW | 0, ~ Uniform({1.44, 7.68}) |
| ${P}_{min}^{G} , {P}_{max}^{G}$ | kW | 0, 23 |

In the study, E^{V}[1] and tₐᵣᵣᵢᵥₐₗ were drawn from uniform distributions to allow for the greatest variability in randomly-generated values. Several alternative distributions appear in the literature, but no consensus appears to exist. C^{V} is the rated capacity of the EV battery, and the four values in Table 5B correspond to four popular EVs sold in the United States: Nissan Leaf, Audi Q4 e-tron, Tesla Model 3, and Tesla Model S.

$${E}_{min}^{V} and {E}_{max}^{V}$$

are set to avoid fully depleting or charging the EV battery pack. E^{V}[1],

$${E}_{T , min}^{V} , and {E}_{T , max}^{V}$$

are set to reflect the fact that some EV owners like to ‘top-off’ a mostly-full battery, while others may charge only after substantial battery depletion. EV arrival and departure times are intended to represent overnight charging, perhaps on a weekday and in a residential area where most EV owners commute to/from work.

$${P}_{min}^{V}$$

is set to zero to prevent discharging of the vehicle battery, and

$${P}_{min}^{G}$$

is set to zero to prevent power flow into the grid. Possible values for Pₘₐₓ^{V} correspond to the maximum charging power provided by in-home, SAE J1772-compliant, Level 1 (120V, 12 A) and Level 2 (240V, 32 A) chargers. Pₘₐₓ^{G} represents 95% of the power limit of a 100 A-circuit breaker in a home with a 240V supply.

Results. Results for four runs of the simulation in the Algorithm of FIG. 6A are presented in FIG. 7F. Each run corresponds to a different setting of g(P^{V}) (still common to all homes that perform SC), corresponding to Cases “1”-Case “4”. To reveal the influence of participation in SC on the two grid impact performance metrics, the study conducted 100 random trials with human-influenced parameters set randomly and recorded the resulting distributions in both performance metrics. A base case with no EVs in the feeder is provided for comparison; all variability, in this case, is attributable to the random assignment of household load profiles to homes in each random trial.

The results for 0% participation were observed to be identical in all four runs—this scenario corresponds to all EVs performing rapid charging. FIG. 7F shows that SC under Case “1” is comparable to rapid charging. This was expected, as Case “1” tends to concentrate EV charging activity in time. Case “2” results in slight reductions (under 1%) in voltage drop and transformer overloading with respect to Case “1” as SC participation increases. However, even at 100% participation, the voltage drop and transformer overloading are unacceptably large. This was also expected since EV charging profiles under Case “2” still contain high-power pulses, as in Case “1.” Cases “1” and “2” represent existing SC strategies found in commercially-available products today.

Results for Cases “3” and “4” appear to be comparable. In both cases, as SC participation increases, the voltage drop and transformer overload distributions approach those of the baseline case. This significant reduction in grid impact is expected, as under Cases “3” and “4,” EVs charge more gradually than under Cases “1” and “2.” Cases “3” and “4” represent new SC strategies that are not included in commercially-available products today. At 100% SC participation, the worst-case voltage drop and transformer overload observed under SC Case “3” was nearly 2× worse than under SC Case “4.” This can be attributed to the randomness inherent to Case “3.” Although not shown, SC Case “4” resulted in a lower peak power draw for each home with an EV and for the residential area as a whole when compared to SC Case “3.” Nonetheless, simulation results suggest that, at least when consumers are interested in price minimization, the SC strategies in Cases “3” and “4” can significantly reduce the grid impact of EV adoption, thereby potentially reducing the need for capital investments in infrastructure updates.

### Study to Maximize Renewable Energy Usage in a Single Residence

The study also evaluated a smart charging problem for a single residence equipped with an electric vehicle (EV), energy storage, and solar panels. The smart charging problem was cast as a quadratic program to exploit existing solution algorithms and to efficiently detect problem feasibility. The objective function consisted of a weighted sum of four performance metrics: cost of electricity from the utility, usage of renewable energy, charging urgency and battery degradation. Of these, the renewable energy metric was introduced (as described above) and considers both local and remote sources of renewable energy.

The study designed a suite of convex cost functionals to capture various smart charging objectives, including maximization of renewable energy usage from both local and remote RESs. A flexible smart charging objective function was then constructed as a linear combination of the cost functionals, supported by a multi-objective optimization formulation of the smart charging problem. It was shown through an example that EV owners may be able to overcome unexpected variations in input data needed for smart charging through repeated computation of optimal charging plans. It was also shown that tradeoffs between competing desires of the EV owner could be revealed by solving a series of convex optimization problems and that tradeoff information could be made more interpretable through a post-processing method. The computational cost of these results is minimal due to our insistence on a convex problem formulation, which contrasts with many non-convex formulations in the literature.

The benefits of the instant smart charging strategy to the EV owner are multiple: charging costs can be minimized in a price-uncertain environment, renewable energy usage can be maximized, and battery life can be extended. These benefits are obtained with minimal computational effort due to a convex problem formulation. They also position the instant smart charging algorithm for both embedded implementation and large-scale simulation studies, in contrast to many non-convex formulations existing in the literature.

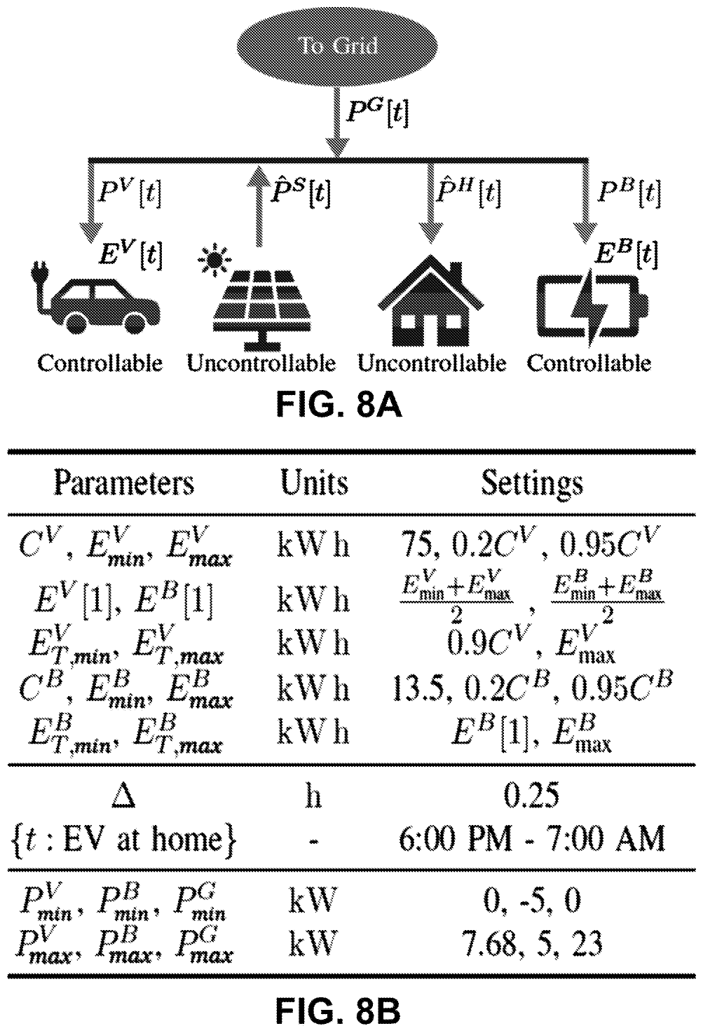

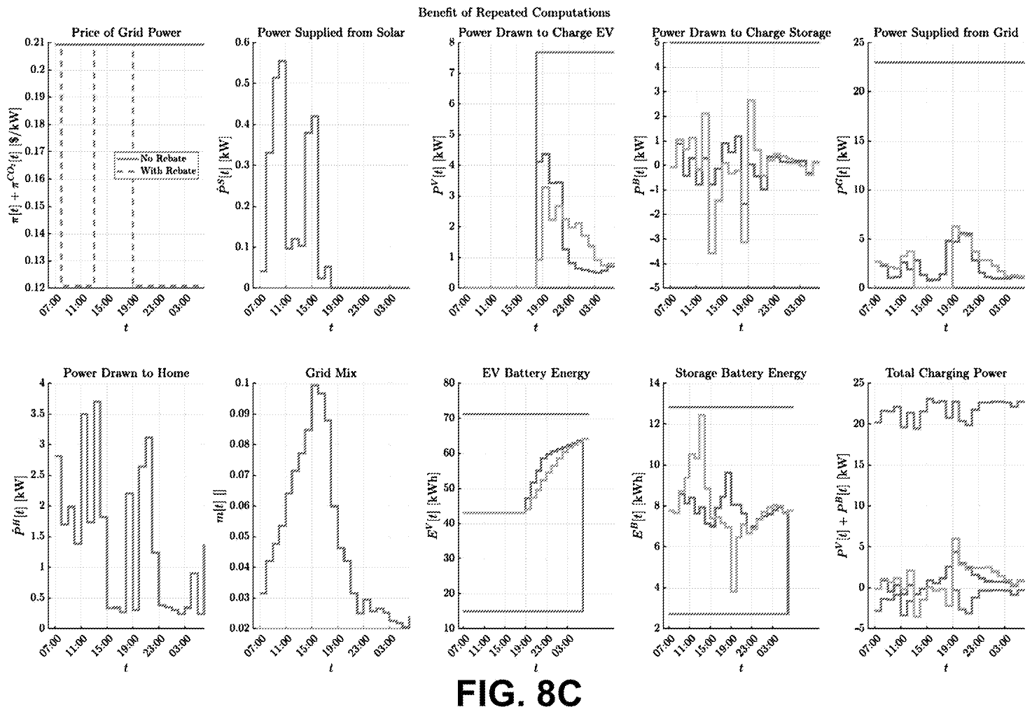

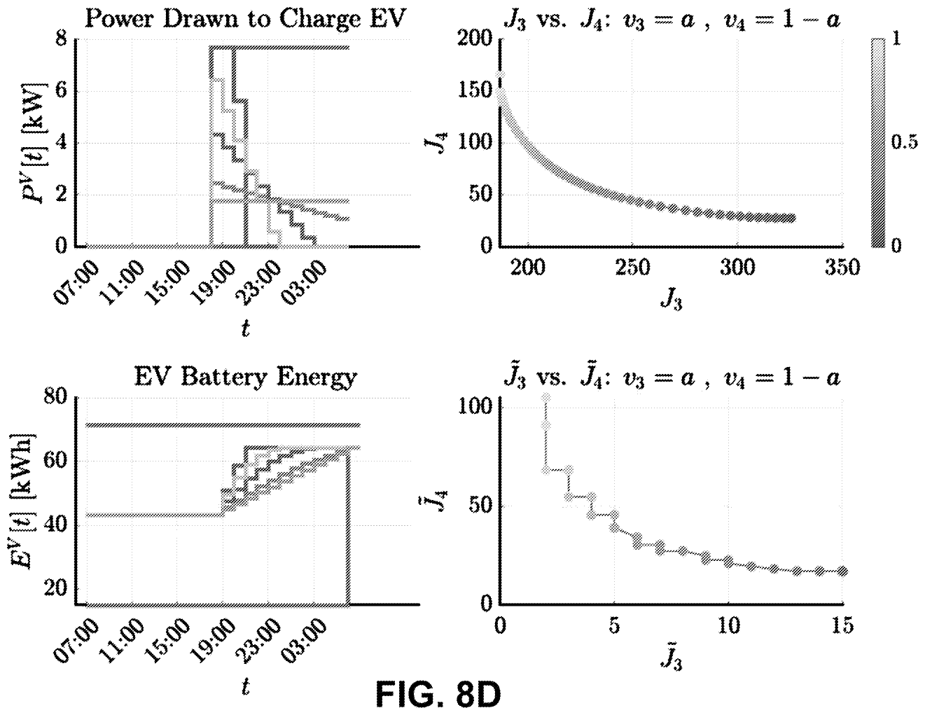

Problem Formulation. The study considered a smart charging problem in the context of the home shown in FIG. 8A. For each sampling instant t=1, 2, . . . , T−1, a smart charger determines P^{V}[t], the power flow into the EV battery, and P^{B}[t], the power flow into the storage battery. Power flows determined at sampling instant t persist for Δ units of time, until sampling instant t+1. Thus, the smart charger's decision variables are: P^{V}:=[P^{V}[1] . . . P^{V}[T−1]]′∈ [symbol] [T−1] and P^{B}:=[P^{B}[1] . . . P^{B}[T−1]]′∈ [symbol] [T−1].

This choice of decision variables allows for the capability of commercial battery power converters to accept time-varying (dis)charging power commands from a microcontroller. FIG. 8A also introduces other key variables. E^{V}[t] and E^{B}[t] represent the energy stored in the EV and storage batteries, respectively. \hat{P}^{H}[t] and \hat{P}^{S}[t] are forecasts of the home's power demand and local solar generation, respectively.

P^{G}[t], the power drawn from the grid, is determined from:

$${P}^{G} [ t ] + {\hat{P}}^{S} [ t ] = {P}^{V} [ t ] + {P}^{B} [ t ] + {\hat{P}}^{H} [ t ] , \qquad ( Eq . 18 )$$

which must be satisfied for t=1, . . . T−1. The power balance implicitly assumes that interconnecting lines in FIG. 8A are lossless and that the battery power converters perfectly source or sink the power that they are commanded to.

Data Requirements. FIG. 8B shows the data required to pose the SC problem. The study assumed that the electric power utility broadcasts π[t], the electricity price; π^{CO}^{₂}[t], an emissions tariff; and m[t], a ‘grid mix’ signal indicating the fraction of power generated from RESs at a given time at the utility level. Electric utilities presently broadcast price signals like π[t] and π^{CO}^{₂}[t], and have the information and communication infrastructure necessary to broadcast m[t]. The EV owner (indirectly through an anticipated user interface) provides weights,

$${\{ {w}_{i} \}}_{i = 1}^{4} ,$$

which capture user preferences; up to four scalars,

$${E}_{T , min}^{V} ( required ) , {E}_{T , max}^{V} , {E}_{T , min}^{B} , and {E}_{T , max}^{B} ,$$

which specifies charging needs and times when the EV is at home. E^{V}[t] and E^{B}[t] are measured. An estimator forecasts \hat{P}^{H}[t] (e.g., 216a) and \hat{P}^{S}[t] (216e). Physical limits on power flows and energy levels are obtained from datasheets.

Problem Statement, Objective Function Details. The study employed four cost terms,

$${\{ {J}_{i} \}}_{i = 1}^{4} ,$$

to capture various SC preferences. Owner-specified weights,

$${\{ {w}_{i} \}}_{i = 1}^{4} ,$$

capture the relative importance of each term. The SC problem is to:

$$\begin{matrix}{minimize}_{{P}^{V} , {P}^{B}} {\sum }_{i = 1}^{4} {w}_{i} {J}_{i} ( {P}^{V} , {P}^{B} ) \\ subject to : Eq . 18 and constraints ( i ) - ( v ) .\end{matrix} \qquad ( Eq . 19 )$$

In Equation 19, the user can minimize their payments to the power utility, as measured by

$${J}_{1} ( {P}^{V} , {P}^{B} ) = {\sum }_{t = 1}^{T - 1} ( π [ t ] + {π}^{{CO}_{2}} [ t ] ) {P}^{G} [ t ] .$$

Environmentally conscious users may desire to maximize their use of renewable energy. Term J₂ captures this desire.

$${J}_{2} ( {P}^{V} , {P}^{B} ) = {\sum }_{t = 1}^{T - 1} {( ( m [ t ] - 1 ) {P}^{G} [ t ] )}^{2} .$$

From Eq. 18, the summand of (Eq. 19) can be re-written as:

$${[ ( m [ t ] {P}^{G} [ t ] + {\hat{P}}^{S} [ t ] ) - ( {\hat{P}}^{H} [ t ] + {P}^{V} [ t ] + {P}^{B} [ t ] ) ]}^{2} .$$

J₂ encourages the total demand profile, \hat{P}^{H}[t]+P^{V}[t]+P^{B}[t], to match the shape of the renewable energy supply profile, m[t]P^{G}[t]+\hat{P}^{S}[t]. To charge aggressively, users can minimize

$${J}_{3} ( {P}^{V} , {P}^{B} ) = {\sum }_{t = 1}^{T - 1} b [ t ] {P}^{V} [ t ] ,$$

where b[t] is a function that monotonically increases with time (e.g. b[t]=t). J₃ is linear in the decision variables. This term tends to shift charging activity towards t=1.

(Dis)charging batteries aggressively can be detrimental. Given that the battery is the most critical component of an EV, users may seek to minimize battery degradation, as measured by

$${J}_{4} ( {P}^{V} , {P}^{B} ) = {\sum }_{t = 1}^{T - 1} {( {P}^{V} [ t ] )}^{2} + {( {P}^{B} [ t ] )}^{2} .$$

J₄ is quadratic in the decision variables, and encourages P^{V}[t] and P^{B}[t] to be low in amplitude and temporally flat.

Constraints. Let V and R be the open-circuit voltage and internal resistance parameters of the EV battery. From the Thevenin model of the battery, the continuous-time can be obtained in which

$$ODE \frac{d}{d τ} {E}^{V} ( τ ) = f ( {P}^{V} ( τ ) ) := - V ( \frac{V - \sqrt{{V}^{2} + 4 {RP}^{V} ( τ )}}{2 R} ) .$$

Due to the Thevenin resistance, power necessarily satisfies P^{V}(τ)≥−V²/(4R). Assuming a small internal resistance R, we simplify the ODE using lim_{R→0}f(P^{V}(τ))=P^{V}(τ). Zero-order-hold discretization (with time step Δ) then yields E^{V}[t+1]=E^{V}[t]+Δ·P^{V}[t], where for any signal s, s[t]:=s(t·Δ). We also assume that the storage battery has a small internal resistance, and thus E^{B}[t+1]=E^{B}[t]+Δ·P^{B}[t]. Initial conditions are obtained from battery sensors. That is E^{V}[1] and E^{B}[1] are measured.

For t=1, . . . T−1, the algorithm requires that (dis)charging powers, energy levels, and power drawn from the grid obey the constraints:

$$3 {P}_{min}^{G} \leq {P}^{G} [ t ] \leq {P}_{max}^{G} , \qquad ( i )$$

$${P}_{lb}^{V} [ t ] \leq {P}^{V} [ t ] \leq {P}_{ub}^{V} [ t ] , \qquad ( ii )$$

$${P}_{min}^{B} \leq {P}^{B} [ t ] \leq {P}_{max}^{B} , \qquad ( iii )$$

$${E}_{min}^{V} \leq {E}^{V} [ t ] \leq {E}_{max}^{V} , and \qquad ( iv )$$

$${E}_{min}^{B} \leq {E}^{B} [ t ] \leq {E}_{max}^{B} , \qquad ( v )$$

where, using the shorthand [symbol] :={t: EV at home},

$${P}_{lb}^{V} [ t ] := \{ \begin{matrix}{P}_{min}^{V} , & t ∈ ℋ \\ 0 , & t ∉ ℋ\end{matrix} , {P}_{ub}^{V} [ t ] := \{ \begin{matrix}{P}_{max}^{V} , & t ∈ ℋ \\ 0 , & t ∉ ℋ\end{matrix} , and where {P}_{max}^{G} > 0 , {P}_{max}^{V} > 0 , and {P}_{max}^{B} > 0.$$

If power can (cannot) be supplied to the grid, then

$${P}_{min}^{G} < 0 ( {P}_{min}^{G} = 0 ) .$$

If power can (cannot) be drawn from the EV battery, then

$${P}_{min}^{V} < 0 ( {P}_{min}^{V} = 0 ) .$$

If power can (cannot) be drawn from the storage battery, then

$${P}_{min}^{B} < 0 ( {P}_{min}^{B} = 0 ) .$$

### Settings for

$${P}_{min}^{V} and {P}_{min}^{B}$$

depend on the EV owner's preferences. Also, the energy storage device need not be inside the home. If the home is connected to communal storage, bounds on P^{B}[t] and E^{B}[t] can be obtained by considering a virtual partitioning. Finally, charging needs are enforced at t=T through

$${E}_{T , min}^{V} \leq {E}^{V} [ T ] \leq {E}_{T , max}^{V} , and \qquad ( i )$$

$${E}_{T , min}^{B} \leq {E}^{B} [ T ] \leq {E}_{T , max}^{B} . \qquad ( ii )$$

Energy is a nonnegative quantity and the following also applies:

$$0 \leq {E}_{min}^{V} \leq {E}_{T , min}^{V} \leq {E}_{T , max}^{V} \leq {E}_{max}^{V} , and 0 \leq {E}_{min}^{B} \leq {E}_{T , min}^{B} \leq {E}_{T , max}^{B} \leq {E}_{max}^{B} .$$

E_{T,min}^{V} represents the EV owner's vehicle charging needs. If left unspecified by the EV owner, default values of

$${E}_{T , max}^{V} = {E}_{max}^{V} and {E}_{T , max}^{B} = {E}_{max}^{B}$$

are selected. If SC is performed daily over a 24 h time horizon, then a default setting of

$${E}_{T , min}^{B} = {E}^{B} [ 1 ]$$

promotes a sell-sustaining daily operation.

Solution Considerations. Terms J₁, J₂, J₃, and J₄ are either linear or quadratic in the decision variables, and all constraints in (Eq. 19) are affine in the decision variables. Thus, (Eq. 19) is a quadratic program (QP), and can be expressed in the following standard form:

$${minimize}_{x} {x}^{′} Hx + {f}^{′} x$$

subject to: Ax≤b, where x=[P^{V′}P^{B′}]′ and H, f, A, and b depend on the weights and input data. Mature, efficient algorithms, such as MATLAB's linprog and quadprog, exist for numerically solving LPs and QPs. This cannot generally be said of the non-convex problems found in the SC literature. Understanding the influence of weights on the SC problem allows for the informed selection of a numerical solver. In determined J₁, J₂, J₃, and J₄, it follows that if w₄>0, then (Eq. 19) is a QP with a unique solution. If w₄=0 and w₂>0, then (Eq. 19) is a QP, potentially with multiple solutions. Finally, if w₄=0 and w₂=0, then (Eq. 19) is an LP, potentially with multiple solutions. Also, the feasibility of (Eq. 19) can be assessed by solving the LP:

$${minimize}_{x} {0}^{′} x$$

subject to: Ax≤b.

It can be advantageous to solve the following rescaled version of (Eq. 19) with a numerical solver, as convergence-related parameters can then be set without considering physical units:

$${minimize}_{{P}^{V} , {P}^{B}} {\sum }_{i = 1}^{4} {v}_{i} ( \frac{{J}_{i} ( {P}^{V} , {P}^{B} ) - {J}_{i , min}}{{J}_{i , max} - {J}_{i , min}} ) \qquad ( Eq . 20 )$$

$$subject to Eq . 18 and constraints ( i ) - ( v ) .$$

Here, for i=1, 2, 3, 4, vᵢ:=wᵢ(J_{i,max}−J_{i,min}):

$$( {P}_{i}^{V ★} , {P}_{i}^{B ★} ) := {arg min}_{{P}^{V} , {P}^{B}} {J}_{i} ( {P}^{V} , {P}^{B} ) ,$$

subject to Eq. 18 and constraints (i)-(v); and

$${J}_{i , min} := {J}_{i} ( {P}_{i}^{V ★} , {P}_{i}^{B ★} ) and {J}_{i , max} := {max}_{j \neq i} \{ {J}_{i} ( {P}_{j}^{V ★} , {P}_{j}^{B ★} ) \} .$$

Clearly, (Eq. 19) and (Eq. 20) are equivalent. Given the tradeoffs between the

$${\{ {J}_{i} \}}_{i = 1}^{4} ,$$

it follows that the

$${\{ {J}_{i} ( {P}_{j}^{V ★} , {P}_{j}^{B ★} ) \}}_{j \neq i}$$

are large values tor Jᵢ. Thus, J_{i,max} shows how large Jᵢ could get. In the case where the tradeoff between two cost functionals is examined, J_{i,max} is a tight upper bound on Jᵢ, but we do not claim this in the general case. Nonetheless, the four bracketed terms in (Eq. 20) are numerically comparable as the effects of units are removed. Assigning equal scaled weights

$$( {\{ {v}_{i} \}}_{i = 1}^{4} )$$

to two or more brackered terms in (Eq. 20) can be interpreted as ‘caring equally’ about the associated performance metrics—this cannot be said of weights in (Eq. 19).

Main Results-Uncertainty Handling. Eq. 19 can be solved in a certain way to overcome unexpected variations in the required input data by viewing Eq. 19 as a finite time horizon optimal control problem with both state and input constraints. Bellman's principle of optimality can be applied to Eq. 19 to solve it as a sequence of QPs, where successive QPs involve fewer decision variables but retain the same structure. For each t₀=1, . . . , T−2, the algorithm can solve a problem similar to (Eq. 19) where t=t₀ plays the role of t=1 and the decision variables are

$${\{ {P}^{V} [ t ] \}}_{t = {t}_{0}}^{T - 1} and {\{ {P}^{B} [ t ] \}}_{t = {t}_{0}}^{T - 1} .$$

Only the first step of the computed charging plan is issued before re-computing.

The sequence of QPs is feasible if and only if the problem is feasible at t₀=1, i.e. if and only if (Eq. 19) is feasible (proof by induction). The solution returned by this recomputation-based method is identical to the solution of (Eq. 19) if the solution of (Eq. 19) is unique. Otherwise, in general, a different (global) minimizer of (Eq. 19) will be returned. The computational cost can decrease with time since two decision variables are dropped after each step, so online computation will remain tractable. Furthermore, feedback on battery energy measurements at each time step may improve robustness to modeling imperfections.

FIG. 8C shows this recomputation-based method overcoming an unexpected change in the electricity price. In this case, the storage battery is leveraged to power the home and EV during times of high prices, thereby saving the EV owner's money. To generate FIG. 8C, π[t] is values taken from published government sites. π^{CO}^{₂}[t]=0 for all t. \hat{P}^{H}[t] and \hat{P}^{S}[t] are drawn at random from the databases, respectively. Additional parameters are listed in FIG. 8B

In FIG. 8B, C^{V} and C^{B} are rated capacities of the EV and storage batteries, respectively. Values for C^{V},

$${P}_{min}^{V} , {P}_{max}^{V} , {C}^{B} , {P}_{min}^{B} , and {P}_{max}^{B}$$

were obtained from Tesla Model 3 and Tesla PowerWall 2 documentation.

$${P}_{max}^{G}$$

is calculated using a supply voltage of 230 V and a main breaker rating of 100 A in the home.

In the simulation, if the perturbed problem is infeasible (can detect), it may be possible to switch into a limp-home mode by dropping the lower bound on E^{V}[T] (and/or E^{B}[T]) and charging such that E^{V}[T] (and/or E^{B}[T]) is maximized. If this problem is also infeasible, the smart charger should shut down.

The EV owner may wish to minimize their payments to the utility, so only w₁>0. As of 7:00 AM, the price of electricity is given by the solid red price signal, and thus the charging plans shown in blue are initially computed. At 8:00 AM, the utility decides to issue a time-varying rebate (effective immediately) to reduce demand during peak hours, resulting in the dashed red price signal. The recomputation-based method adapts, yielding the charging plans shown in green. Under the updated pricing scheme, the blue charging plan costs the homeowner $7.12, while the green charging plan costs $6.06.

Revealing Inherent Tradeoffs. A naïve EV owner may hope to jointly minimize

$${\{ {J}_{i} \}}_{i = 1}^{4}$$

by the function:

$${{minimize}_{{P}^{V} , {P}^{B}} [ \begin{matrix}{J}_{1} & {J}_{2} & {J}_{3} & {J}_{4}\end{matrix} ]}^{′} , \\ subject to : Eq . 18 and constraints ( i ) - ( v ) \qquad ( Eq . 21 )$$

In general, the solution to (Eq. 21) can be determined via a family of Pareto optimal solutions, which can also show that trade-offs exist between

$${\{ {J}_{i} \}}_{i = 1}^{4} .$$

For any choice or non-negative weights, solving (Eq. 19) can yield Pareto optimal solution to (Eq. 21). Therefore, revealing the Pareto frontier amounts to solving several instances of (Eq. 19) with different choices of weights. Due to our convex problem formulation, Pareto frontiers can be efficiently generated.

Given a family of various objectives to choose from, it is natural to consider the case of balancing two objectives; reasoning about balancing more than two objectives is presumably hard for a human. Consider a user who seeks to balance charging urgency and battery degradation. Such a user will want to set w₃>0 and w₄>0, but choosing specific values of w₃ and w₄ is a non-trivial task. FIG. 8D shows examples of these tradeoffs, e.g., between charging urgency and battery degradation.

FIG. 8D was generated by considering 50 linearly spaced values of a parameter a E [0,1]. For each a, the weights v₁=v₂=0, v₃=a, and v₄=1−a were set, and an instance of (17) was solved using the same input data from FIG. 8C (with the exception of weights). The EV charging plans from five of the 50 cases considered are plotted in the two left panels. As a increases, the charging behavior becomes more aggressive, as intended. The Pareto front in the top right panel of FIG. 2 was obtained by evaluating J₃ and J₄ at the minimizer of each instance of (Eq. 20) considered. A clear tradeoff is revealed by this Pareto frontier, but it may not be obvious how to choose v₃ and v₄ (equivalently, w₃ and w₄, or a) in a principled manner, as the units of J₃ and J₄ (and J₂) can be difficult to reason about.

J₂, J₃ and J₄ were designed to be convex and adequately model certain desires of EV owners, not to have easily interpretable units. To aid weight selection, the study introduced proxy functionals J₂(P^{V}, P^{B}), J₃(P^{V}, P^{B}) and J₄(P^{V}, P^{B}). J₂ returns the home's renewable energy usage as a percentage of the home's total energy usage:

$${\tilde{J}}_{2} = 100 \cdot \frac{Δ {\sum }_{t = 1}^{T - 1} m [ t ] {P}^{G} [ t ] + {\hat{P}}^{S} [ t ]}{Δ {\sum }_{t = 1}^{T - 1} {\hat{P}}^{H} [ t ] + {P}^{V} [ t ] + {P}^{B} [ t ]} .$$

\tilde{J}₃ returns the time taken to fully charge the EV battery: \tilde{J}₃=Δ·t*, where

$${t}^{★} := min \{ t : {E}^{V} [ t ] \geq {E}_{T , min}^{V} \} .$$

\tilde{J}₄ is the sum of two similar terms, each of which returns the average (dis)charging power of a battery as a percentage of its maximum rated (dis)charging power. \tilde{J}₄ is defined as:

$${\tilde{J}}_{4} = \frac{100}{{N}_{V} {P}_{max}^{V}} {\sum }_{t = 1}^{T - 1} \vert {P}^{V} [ t ] \vert + \frac{100}{{N}_{B} {P}_{max}^{B}} {\sum }_{t = 1}^{T - 1} \vert {P}^{B} [ t ] \vert , \\ where {N}_{V} := \# \{ t : \vert {P}^{V} [ t ] \vert > 0 \} ,$$

$${N}_{B} := \# \{ t : \vert {P}^{B} [ t ] \vert > 0 \} ,$$

and #S returns the cardinality of any set S.

In FIG. 8C, the lower right plot was generated by evaluating \tilde{J}₃ and \tilde{J}₄ at the minimizer of each instance of (17) considered. From such a plot, it is possible to reason about the tradeoffs using meaningful units by examining the local slope and provide automated guidance for weight selection to a human.

### DISCUSSION

Across the U.S., U.K. and Europe, the majority of electric vehicle (EV) charging occurs overnight, in residential areas [1]. As the market penetration of electric vehicles (EVs) rises, the associated increase in power demand is expected to exacerbate the evening demand surge, degrade power quality, and overload transformers, especially in residential distribution networks [2], [3]. This concern has spurred the development of smart charging) strategies, which optimally distribute EV charging over time, so as to benefit grid operators and/or EV owners. Grid operators can mitigate the aforementioned issues by intelligently controlling the charging of multiple EVs. For further information (and references) on smart charging algorithms of this nature, see [4]. However, to enable the grid operator to control charging, the EV owner must either utilize a utility-affiliated public charger, or opt-in to a demand response program [5]-[7]. Since EV charging predominantly happens in residential settings, grid operators also issue time-of-use (TOU) pricing to influence the decision-making of EV owners [8], [9]. TOU pricing is one motivation to consider smart charging problems from the EV owner's perspective, as in this work. In addition to minimizing the cost of charging, EV owners can have other interests, such as maximizing renewable energy consumption, and/or minimizing charging time or battery degradation. For further information (and references) on smart charging algorithms of this nature, see [4], [10], [11]. The EV owner's perspective is comprehensively treated using multi-objective optimization in [10], [11], and this work.

While substantial academic research has been conducted on the design and analysis of smart charging algorithms (see [4], [10], and references therein), few studies discuss implementation or measure performance experimentally. A search for experimentally-oriented studies on EV charging produced two groups of studies: (i) [12]-[20], on the design of on-board chargers; and (ii) [21]-[26], on the design of off-board or vehicle-external chargers. All reviewed studies assumed access to battery terminals, and emphasized the design of power electronic circuits for AC/DC power conversion with desirable properties (e.g., high efficiency, low ripple, bidirectional power conversion). A subset of the reviewed studies designed power converters that accept power or current commands, and a smaller subset utilized these to regulate voltage magnitude or frequency at the grid connection point. Several EV and electric vehicle supply equipment (EVSE) manufacturers tout ‘smart charging’ features of their products. However, based on a review of the products in Table I, it appears that these products do not rely on optimization methods, but rather on heuristic methods to determine EV charging times. All reviewed products allow users to delay charging, or to limit when charging can occur (e.g. based on two-level TOU signals).

### Additional Discussion: Grid-Favorable, Consumer-Centric, on Off Smart Charging of Electric Vehicles

According to a 2021 analysis by BloombergNEF, EV owners across the U.S., U.K. and Europe perform more than 80% of their charging overnight, at home. Furthermore, most of the EVs remain plugged-in throughout the night [3″], even though most EVs will not be actively charging for this entire time. Therefore, there exists a significant opportunity to distribute charging activity over time in residential settings.

SC for collections of EVs has been widely studied. Studies can be distinguished by their selection of optimality criteria, and by the problem setting considered (e.g., public parking lot vs. residential neighborhood). However, nearly all reviewed studies appear to assume that a decision making agent has the authority to control the charging of multiple EVs. In some settings, such as public parking lot, this assumption seems to be valid. However, it seems inappropriate to make the same assumption in a neighborhood setting, where EV owners may want to opt-in to (or opt-out of) such a centralized control scheme.

Furthermore, all reviewed SC studies appear to consider ‘variable-power’ EV charging, wherein the instantaneous power flow into (or out of) an EV can take on any real value in a bounded interval. In contrast, several commercially available SC systems are only capable of performing ‘on/off’ EV charging, wherein the instantaneous power flow into an EV can either be set to zero (off), or a pre-defined, immutable value (on).

Air conditioning and water heating systems are high-power residential loads with on/off controls, and several studies have focused on optimally controlling these loads. Though this body of work does not directly relate to EV charging, a brief review of this work was conducted to understand if any existing methods could simply be applied to control EVs instead of AC units or water heaters. However, like the studies on SC for collections of EVs, several of the studies in this area pose centralized optimization problems that benefit the power utility, which may require consent from homeowners in order to be realized. Other studies in this area focus on single-home energy management systems, but these studies tend to consider only financially-motivated homeowners.

Grid impact assessment methods are well-documented in the literature on uncontrolled EV charging. In general, Monte-Carlo-style simulations are conducted to reveal the impact of EV charging behavior on one or more chosen performance metrics. Some studies consider high-fidelity models of distribution feeders, but not all studies do.

Additional discussion. The convergence of electrified transportation with the power grid presents new challenges for utilities. EV charging loads are expected to impact utilities with significant network stresses and overloads, diminished power quality, further mismatches in supply demand, and an overall lowered dependability of their distribution systems. For example, EV owners will likely charge primarily when they arrive home from work, precisely when grid loads are already high.

The exemplary systems provide SC systems, methods, and apparatuses (e.g., a smart charger prototype implementing SC algorithms) that are able to mitigate power grid stress and overloads due to large scale EV adoption, increase utilization of renewable energy resources, and enable various participants (e.g., consumers, grid operators, and policymakers) to lower costs and improve grid integrity.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used.

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications, as listed below and throughout this document, are hereby incorporated by reference in their entirety herein.
[1] BloombergNEF, “Ev drivers save big when they charge smart,” 2021. [Online]. Available: about.bnef.com/blog/ev-drivers-save-bigwhen-they-charge-smart/[2] R. Jarvis and P. Moses, “Smart grid congestion caused by plug-in electric vehicle charging,” in 2019 IEEE Texas Power and Energy Conference (TPEC), 2019, pp. 1-5.
[3] M. Muratori, “Impact of uncoordinated plug-in electric vehicle charging on residential power demand,” Nature Energy, vol. 3, no. 3, p. 193-201, 2018.
[4] P. Kong and G. K. Karagiannidis, “Charging schemes for plug-in hybrid electric vehicles in smart grid: A survey,” IEEE Access, vol. 4, pp. 6846-6875, 2016.
[5] Honda, “SmartCharge.” [Online]. Available: https://hondasmartcharge.com/
[6] BMW, “ChargeForward.” [Online]. Available: https://www.bmwchargeforward.com/
[7] Chevrolet, “Smart Charging.” [Online]. Available: https://smartcharging.chevrolet.com/#
[8] Georgia Power, “Time of use-energy only tariff.” [Online]. Available: www.georgiapower.com/content/dam/georgia-power/pdfs/businesspdfs/rates-schedules/small-business/MKT Time of use Rates brochure.pdf
[9] Southern California Edison, “Time-of-use residential rate plans.” [Online]. Available: www.sce.com/residential/rates/Time-Of-Use-Residential-Rate-Plans
[10] K. V. Sastry, T. F. Fuller, S. Grijalva, D. G. Taylor, and M. J. Leamy, “Electric vehicle smart charging to maximize renewable energy usage in a single residence,” in IECON 2021-47th Annual Conference of the IEEE Industrial Electronics Society, 2021, pp. 1-6.
[11]______, “Grid-favorable, consumer-centric, on/off smart charging of electric vehicles in a neighborhood,” in VPPC 2022-2022 IEEE Vehicle Power and Propulsion Conference, 2022, pp. 1-6.

[12] M. Restrepo, J. Morris, M. Kazerani, and C. A. Ca nizares, “Modeling and testing of a bidirectional smart charger for distribution system ev integration,” IEEE Trans. Smart Grid, vol. 9, no. 1, pp. 152-162, 2018.
[13] S.-H. Liao, J.-H. Teng, and C.-K. Wen, “Developing a smart charger for evs' charging impact mitigation,” in 2015 IEEE 2nd International Future Energy Electronics Conference (IFEEC), 2015, pp. 1-6.
[14] R. J. Ferreira, L. M. Miranda, R. E. Ara'ujo, and J. P. Lopes, “A new bi-directional charger for vehicle-to-grid integration,” in 2011 2nd IEEE PES International Conference and Exhibition on Innovative Smart Grid Technologies, 2011, pp. 1-5.
[15] M. C. Kisacikoglu, “A modular single-phase bidirectional ev charger with current sharing optimization,” in 2018 IEEE Transportation Electrification Conference and Expo (ITEC), 2018, pp. 366-371.
[16] M. C. Kisacikoglu, M. Kesler, and L. M. Tolbert, “Single-phase on-board bidirectional pev charger for v2g reactive power operation,” IEEE Trans. Smart Grid, vol. 6, no. 2, pp. 767-775, 2015.
[17] T. Tanaka, T. Sekiya, H. Tanaka, E. Hiraki, and M. Okamoto, “Smart charger for electric vehicles with power quality compensator on single-phase three-wire distribution feeders,” in 2012 IEEE Energy Conversion Congress and Exposition (ECCE), 2012, pp. 3075-3081.
[18] P. P. Nachankar, H. M. Suryawanshi, P. Chaturvedi, D. Atkar, C. L. Narayana, and D. Govind, “Design of electric vehicle battery charger with reduced switching frequency variation,” IEEE Trans. Ind. Appl., vol. 58, no. 6, pp. 7432-7444, 2022.
[19] F. Musavi, M. Edington, W. Eberle, and W. Dunford, “A cost effective high-performance smart battery charger for off-road and neighborhood evs,” in 2012 IEEE Transportation Electrification Conference and Expo (ITEC), 2012, pp. 1-6.
[20] D. Patil and V. Agarwal, “Compact onboard single-phase ev battery charger with novel low-frequency ripple compensator and optimum filter design,” IEEE Trans. Veh. Technol., vol. 65, no. 4, pp. 1948-1956, 2016.
[21] V. Monteiro, T. J. Sousa, C. Couto, J. S. Martins, A. A. N. Melendez, and J. L. Afonso, “A novel multi-objective off-board ev charging station for smart homes,” in IECON 2018-44th Annual Conference of the IEEE Industrial Electronics Society, 2018, pp. 1983-1988.
[22] Z. Zhang, H. Xu, L. Shi, D. Li, and Y. Han, “Application research of an electric vehicle dc fast charger in smart grids,” in 2012 IEEE 6th International Conference on Information and Automation for Sustainability, 2012, pp. 258-261.
[23] Y. Ota, H. Taniguchi, H. Suzuki, T. Nakajima, J. Baba, and A. Yokoyama, “Implementation of grid-friendly charging scheme to electric vehicle off-board charger for v2g,” in 2012 3rd IEEE PES Innovative Smart Grid Technologies Europe (ISGT Europe), 2012, pp. 1-6.
[24] P. P. Nachankar, H. M. Suryawanshi, P. Chaturvedi, D. D. Atkar, C. L. Narayana, and D. Govind, “Universal off-board battery charger for light and heavy electric vehicles,” in 2020 IEEE International Conference on Power Electronics, Drives and Energy Systems (PEDES), 2020, pp. 1-6.
[25] P. Papamanolis, F. Krismer, and J. W. Kolar, “22 kw ev battery charger allowing full power delivery in 3-phase as well as 1-phase operation,” in 2019 10th International Conference on Power Electronics and ECCE Asia (ICPE 2019-ECCE Asia), 2019, pp. 1-8.
[26] J. Y. Yong, V. K. Ramachandaramurthy, K. M. Tan, and J. Selvaraj, “Experimental validation of a three-phase off-board electric vehicle charger with new power grid voltage control,” IEEE Trans. Smart Grid, vol. 9, no. 4, pp. 2703-2713, 2018.
[27] “SAE J1172: Electric Vehicle and Plug in Hybrid Electric Vehicle Conductive Charge Coupler,” SAE International, Standard, October 2017.
[28] Smartcar, “Smartcar for EVs.” [Online]. Available: https://smartcar.com/product/electric-vehicle-api/

1. A system comprising:
a networked relay device comprising:
a relay having (i) an input connection to a power source and (ii) an output connection to an electric vehicle charger unit;
a first terminal to couple to the power source;
a second terminal to couple to the electric vehicle charger unit; and
a controller having a processor and a memory having instructions stored thereon, wherein execution of the instructions by the processor causes the processor to:
direct the relay to disengage an electrical connection between the input connection and the output connection based on an optimized profile to provide power flow to the electric vehicle charger unit to charge an electric vehicle, wherein the optimized profile is determined from (i) one or more user-controllable inputs, (ii) price of electricity data, and (iii) electric vehicle state of charge.

2. The system of claim 1, wherein the networked relay device has no direct communication interface to communicate with the electric vehicle charger unit, and wherein the electric vehicle charger unit is configured to operate charging operation without any control signal from the networked relay device.

3. The system of claim 2, wherein execution of the instructions by the processor, further causes the processor of the networked relay device to:
execute an optimization engine to determine the optimized profile.

4. The system of claim 3, wherein the networked relay device further includes:
a web-service interface configured to communicate to external cloud infrastructure through a third-party API to receive the electric vehicle state of charge; and
a power-line communication (PLC) module configured to receive, via PLC communication, the electric vehicle state of charge from at least one of the electric vehicle or electric vehicle charger unit.

5. (canceled)

6. The system of claim 4, wherein the optimization engine of the networked relay device is configured to determine estimated power flow, as the optimized profile, to the charger unit using (i) the one or more user-controllable inputs, (ii) the price of electricity data, and (iii) the electric vehicle state of charge, wherein the determined power flow to the electric vehicle charger unit is employed in determining the optimized profile.

7. The system of claim 6, wherein the optimization engine of the networked relay device is configured to determine estimated power flow, as the optimized profile, to local battery storage operatively connected to the networked relay device using (i) the one or more user-controllable inputs, (ii) the price of electricity data, and (iii) the electric vehicle state of charge, wherein the estimated power flow to the local battery storage is employed in determining the optimized profile.

8. The system of claim 7, wherein the optimization engine of the networked relay device is configured to determine an estimated power flow generated by a local power generation system operatively connected to the networked relay device using (i) the one or more user-controllable inputs, (ii) the price of electricity data, and (iii) the electric vehicle state of charge, wherein the estimated power flow generated by the local power generation system is employed in determining the optimized profile.

9. The system of claim 8, wherein the optimization engine of the networked relay device is configured to determine estimated power flow from the input connection using (i) the one or more user-controllable inputs, (ii) the price of electricity data, and (iii) the electric vehicle state of charge, wherein the estimated power flow from the input connection is employed in determining the optimized profile.

10. The system of claim 2, further comprising:
a cloud infrastructure configured to execute a cloud optimization engine to determine the optimized profile, the cloud infrastructure including:
a first interface configured to transmit the optimized profile of the networked relay device;
a second interface configured to communicate to an external cloud infrastructure through a third-party API to receive the electric vehicle state of charge, wherein the external cloud infrastructure is operatively connected to at least one of the electric vehicle charger unit to receive the electric vehicle state of charge; and
a web hosting module configured to generate, via a user portal at a user device, a graphical user interface to receive one or more user inputs.

11. (canceled)

12. The system of claim 10, wherein the cloud infrastructure is configured to receive the electric vehicle state of charge from the networked relay device through the first interface, wherein the networked relay device includes a power-line communication (PLC) module configured to receive, via PLC communication, the electric vehicle state of charge from the electric vehicle charger unit.

13. The system of claim 12, wherein the cloud optimization engine is configured to determine estimated power flow, as the optimized profile, to the electric vehicle charger unit using (i) the one or more user-controllable inputs, (ii) the price of electricity data, and (iii) the electric vehicle state of charge, wherein the determined power flow to the electric vehicle charger unit is employed in determining the optimized profile.

14. The system of claim 13, wherein the cloud optimization engine is configured to determine estimated power flow, as the optimized profile, to local battery storage operatively connected to the networked relay device using (i) the one or more user-controllable inputs, (ii) the price of electricity data, and (iii) the electric vehicle state of charge, wherein the estimated power flow to the local battery storage is employed in determining the optimized profile.

15. The system of claim 14, wherein the cloud optimization engine is configured to determine an estimated power flow generated by a local power generation system operatively connected to the networked relay device using (i) the one or more user-controllable inputs, (ii) the price of electricity data, and (iii) the electric vehicle state of charge, wherein the estimated power flow generated by the local power generation system is employed in determining the optimized profile.

16. The system of claim 15, wherein the cloud optimization engine is configured to determine estimated power flow from the input connection using (i) the one or more user-controllable inputs, (ii) the price of electricity data, and (iii) the electric vehicle state of charge, wherein the estimated power flow from the input connection is employed in determining the optimized profile.

17. The system of claim 16, wherein the one or more user inputs include at least one:
input to receive parameter associated with user's preference to minimize payment selection for the charging operation;
input to receive parameter associated with user's preference to minimize use of grid-derived non-renewable energy
input to receive parameter associated with user's preference to charge aggressively; or
input to receive parameter associated with user's preference to a combination thereof.

18. (canceled)

19. The system of claim 1, wherein the networked relay device further includes:
one or more sensors configured to, at least, measure power flow at the input connection;
a first communication interface configured to a communication interface configured to (i) connect to a power converter of a photovoltaic system or local battery storage system and (ii) receive at least one of measurement data or messages from the power converter, wherein the at least one of measurement data or messages are employed to determine the optimized profile; and
a second communication interface configured to (i) connect to a utility meter and (ii) receive at least one of utility usage data or messages from the utility meter, wherein the at least one of the utility usage data or messages are employed to determine the optimized profile;
a third terminal to couple to the power converter of the photovoltaic system of the photovoltaic system;
a fourth terminal to couple to the power converter of the photovoltaic system of the local battery storage system; and
a network interface or a wireless network interface.

20-60. (canceled)

61. A method comprising:
directing, based on an optimized profile determination, a relay of a networked relay device to disengage electrical connection to an electric vehicle charger unit to control power flow to the electric vehicle charger unit, wherein the optimized profile is determined from (i) one or more user-controllable inputs, (ii) price of electricity data, and (iii) electric vehicle state of charge.

62. The method of claim 61, wherein the networked relay device has no direct communication interface to communicate with the electric vehicle charger unit, and wherein the electric vehicle charger unit is configured to operate charging operation without any control signal from the networked relay device.

63-72. (canceled)

73. A non-transitory computer-readable medium having instructions stored thereon, wherein execution of the instructions by a processor causes the processor to:
direct, based on an optimized profile, a relay of a networked relay device to disengage electrical connection to an electric vehicle charger unit to control power flow to the electric vehicle charger unit, wherein the optimized profile is determined from (i) one or more user-controllable inputs, (ii) price of electricity data, and (iii) electric vehicle state of charge.

74. The non-transitory computer-readable medium of claim 73, wherein the networked relay device has no direct communication interface to communicate with the electric vehicle charger unit, and wherein the electric vehicle charger unit is configured to operate charging operation without any control signal from the networked relay device.

75-83. (canceled)
